(19) United States
(12) Patent Application Publication
(10) Pub. No.: US 2024/0223756 A1
(43) Pub. Date: Jul. 4, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Na ZHANG, Beijing (CN); Kai ZHANG, Los Angeles, CA (US); Li Zhang, Los Angeles, CA (US)

(21) Appl. No.: 18/607,244

(22) Filed: Mar. 15, 2024

Related U.S. Application Data
(63) Continuation of application No. PCT/CN2022/119053, filed on Sep. 15, 2022.

(30) Foreign Application Priority Data
Sep. 15, 2021 (WO) PCT/CN2021/118625

(51) Int. Cl. H04N 19/11; H04N 19/105; H04N 19/107; H04N 19/119; H04N 19/139; H04N 19/159; H04N 19/176; H04N 19/52; H04N 19/533; H04N 19/593

(52) U.S. Cl. CPC H04N 19/11; H04N 19/105; H04N 19/107; H04N 19/119; H04N 19/139; H04N 19/159; H04N 19/176; H04N 19/52; H04N 19/533; H04N 19/593

(57) ABSTRACT

Embodiments of the present disclosure provide a solution for video processing. A method for video processing is proposed. The method comprises: determining, during a conversion between a target video block of a video and a bitstream of the video, an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; and performing the conversion based on the IBC-based mode.

This application is a continuation of International Application No. PCT/CN2022/119053, filed on Sep. 15, 2022, which claims the benefit of International Application No. PCT/CN2021/118625 filed on Sep. 15, 2021. The entire contents of these applications are hereby incorporated by reference in their entireties.

### FIELD

Embodiments of the present disclosure relates generally to video coding techniques, and more particularly, to intra block copy (IBC) extension.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), and an IBC merge mode based on TM; and performing the conversion based on the IBC mode. The method in accordance with the first aspect of the present disclosure provides improvement for IBC. More IBC based modes can be supported to improve the coding efficiency of IBC-based mode.

In a second aspect, an apparatus for processing video data is proposed. The apparatus for processing video data comprising a processor and a non-transitory memory with instructions thereon, wherein the instructions upon execution by the processor, cause the processor to perform a method in accordance with the first aspect.

In a third aspect, an apparatus for processing video data is proposed. The non-transitory computer-readable storage medium storing instructions that cause a processor to perform a method in accordance with the first aspect.

In a fourth aspect, a non-transitory computer-readable recording medium is proposed. The non-transitory computer-readable recording medium storing a bitstream of a video which is generated by a method performed by a video processing apparatus, wherein the method comprises: determining an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; and generating the bitstream based on the IBC-based mode.

In a fifth aspect, another method for video processing is proposed. The method for storing a bitstream of a video, comprising: determining an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; generating the bitstream based on the IBC-based mode; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing example positions of spatial merge candidate;

FIG. 5 illustrates an example diagram showing candidate pairs considered for redundancy check of spatial merge candidates;

FIG. 6 illustrates an example diagram showing an example motion vector scaling for temporal merge candidate;

FIG. 7 illustrates an example diagram showing candidate positions for temporal merge candidate, C0 and C1;

FIG. 8 illustrates an example diagram showing VVC spatial neighboring blocks of the current block;

FIG. 9 illustrates an example diagram showing the relationship between the virtual block and the current block;

FIG. 10 illustrates an example diagram showing spatial neighboring blocks used to derive the spatial merge candidates;

FIG. 11A and FIG. 11B illustrate the SbTMVP process in VVC;

FIGS. 12A-12D illustrate current CTU processing order and available samples in current and left CTU;

FIG. 13 illustrates example neighboring samples used for calculating SAD;

FIG. 14 illustrates example neighboring samples used for calculating SAD for sub-CU level motion information;

FIG. 15 illustrates an example diagram showing a sorting process;

FIG. 16 illustrates an example diagram illustrating a reorder process in an encoder;

FIG. 17 illustrates an example diagram illustrating a reorder process in a decoder;

FIG. 18 illustrates an example diagram illustrating template matching performs on a search area around initial MV;

FIG. 19 illustrates an example diagram showing the template matching prediction;

FIG. 20 illustrates an example diagram showing intra template matching search area used;

FIG. 21 illustrates an example diagram showing template and its reference samples used in TIMD;

FIG. 22 illustrates an example diagram showing template and reference samples of the template;

FIG. 23 illustrates an example diagram showing template and reference samples of the template in reference list 0 and reference list 1;

FIG. 24 illustrates an example diagram showing template and reference samples of the template for block with sub-block motion using the motion information of the subblocks of current block;

FIG. 25 illustrates an example diagram showing template and reference samples of the template for block with sub-block motion using the motion information of each sub-template;

FIG. 26 illustrates an example diagram showing template and reference samples of the template for block with OBMC;

FIG. 27 illustrates an example diagram showing motion estimation for rectangular block with hash values for square subblocks;

FIG. 28 illustrates example luma mapping with chroma scaling architecture;

FIG. 29 illustrates an example diagram showing MMVD search point;

FIG. 30 illustrates an example diagram showing an example of triangle partition based inter prediction;

FIG. 31 illustrates an example of uni-prediction MV selection for triangle partition mode

FIG. 32 illustrates example weights used in the blending process;

FIGS. 33A-33C illustrate three MV storage areas for triangleDir equal to 0;

FIG. 34 illustrates examples of the GPM splits grouped by identical angles;

FIG. 35 illustrates an example of uni-prediction MV selection for geometric partitioning mode;

FIG. 36 illustrates an example of exemplified generation of a bending weight w_0 using geometric partitioning mode

FIG. 37 illustrates an example of top and left neighboring blocks used in CIIP weight derivation

FIGS. 38A-38B illustrates examples of candidate positions for spatial candidate and temporal candidate;

FIG. 39 illustrates an example of deriving sub-CU by motion field from the corresponding collocated sub-CUs by applying a motion shift from spatial neighbor;

FIG. 40 illustrates an example of intra template matching;

FIG. 41 illustrates an example of the adjacent spatial neighboring blocks used in accordance with some embodiments of the present disclosure;

FIG. 42 illustrates an example of top and left neighboring blocks used in CIIP_N1 and CIIP_N2 weight derivation in accordance with some embodiments of the present disclosure;

FIG. 43 illustrates an example of triangle partition based IBC prediction in accordance with some embodiments of the present disclosure;

FIGS. 44A-44B illustrate two example search patterns in accordance with some embodiments of the present disclosure;

FIG. 45 illustrates a flowchart of a method for video processing in accordance with some embodiments of the present disclosure;

FIG. 46 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Example Environment

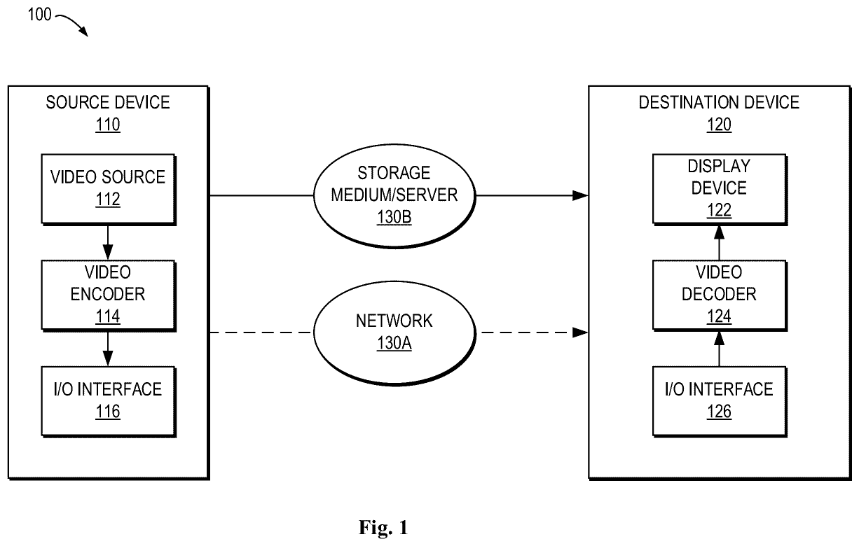

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

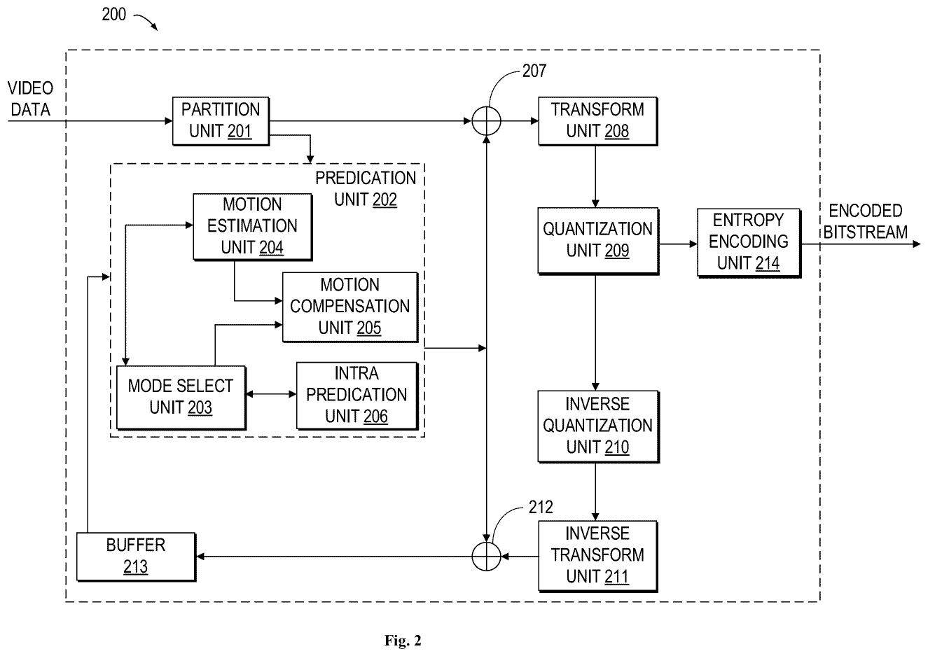

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

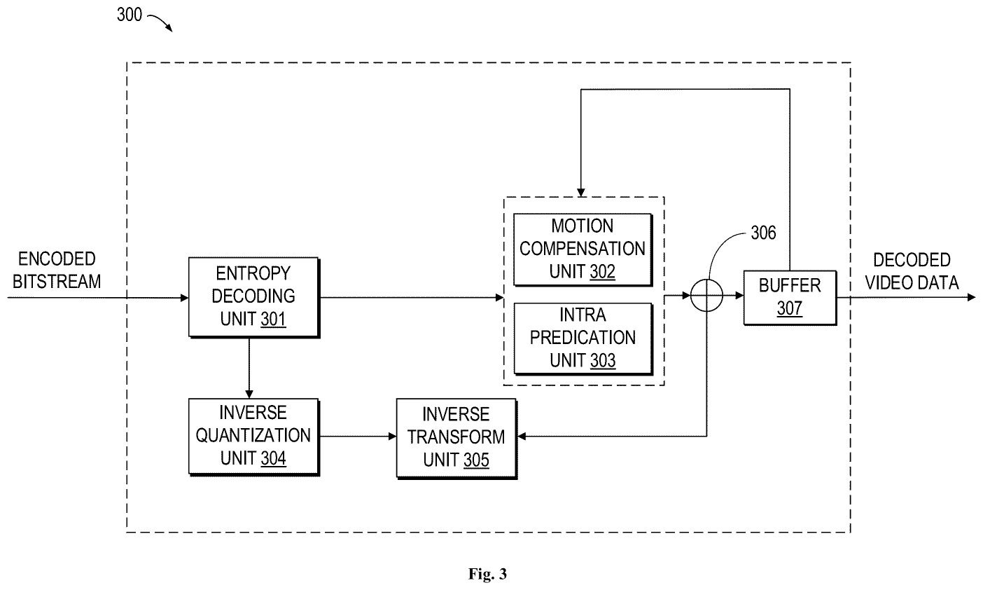

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video coding technologies. Specifically, it is about IBC prediction and related techniques in video coding. It may be applied to the existing video coding standard like HEVC, VVC, etc. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1 Spatial Candidates Derivation

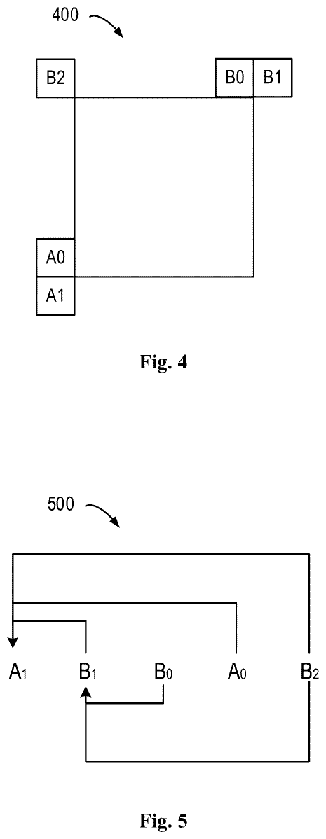

FIG. 4 illustrates an example diagram 400 illustrating example positions of spatial merge candidate. The derivation of spatial merge candidates in VVC is same to that in HEVC except the positions of first two merge candidates are swapped. A maximum of four merge candidates are selected among candidates located in the positions depicted in FIG. 4. The order of derivation is B₁, A₁ B₀, A₀, and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 5 illustrates an example diagram 500 illustrating candidate pairs considered for redundancy check of spatial merge candidates. Instead only the pairs linked with an arrow in FIG. 5 are considered and a candidate is only added to the list if the corresponding candidate used for redundancy check has not the same motion information.

### 2.1.2 Temporal Candidates Derivation

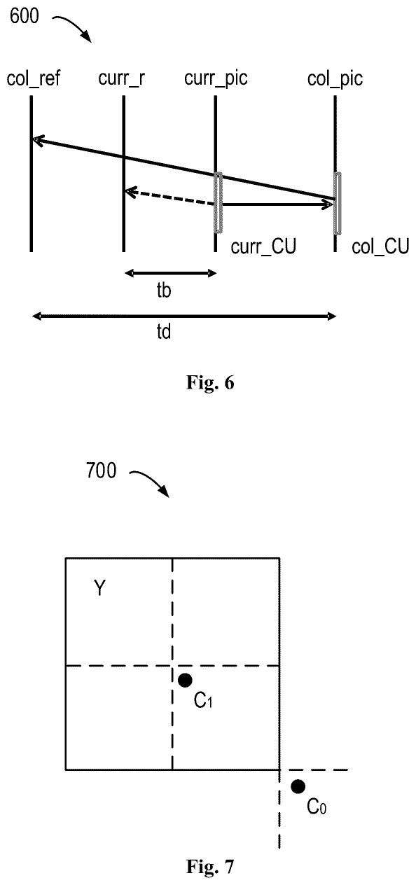

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 6 illustrates an example motion vector scaling 600 for temporal merge candidate. The scaled motion vector for temporal merge candidate is obtained as illustrated by the dotted line in FIG. 6, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

FIG. 7 illustrates an example diagram 700 illustrating candidate positions for temporal merge candidate, C₀ and C₁. The position for the temporal candidate is selected between candidates C₀ and C₁, as depicted in FIG. 7. If CU at position C₀ is not available, is intra coded, or is outside of the current row of CTUs, position C₁ is used. Otherwise, position C₀ is used in the derivation of the temporal merge candidate.

### 2.1.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4) ? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.2. New Merge Candidates

### 2.2.1 Non-Adjacent Merge Candidates Derivation

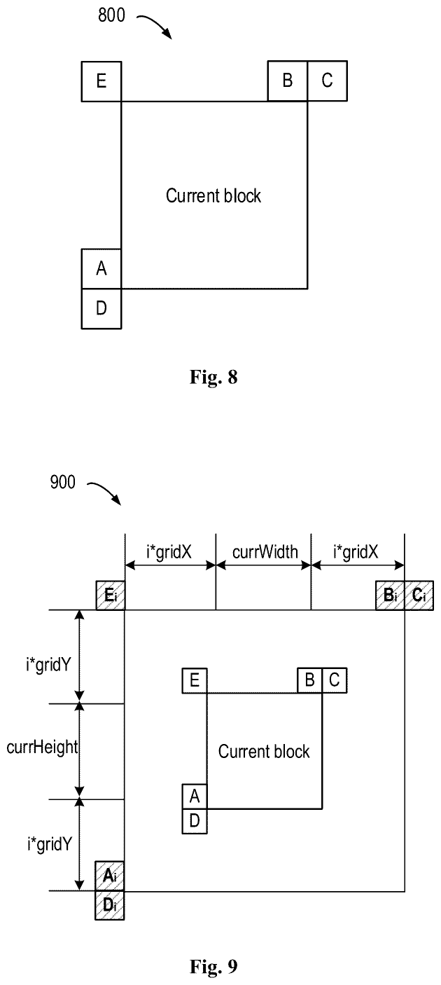

FIG. 8 illustrates an example diagram 800 illustrating VVC spatial neighboring blocks of the current block. In VVC, five spatially neighboring blocks shown in FIG. 8 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

$$Offsetx = - i \times gridX , Offsety = - i \times gridY$$

where the Offsetx and Offsety denote the offset of the top-left corner of the virtual block relative to the top-left corner of the current block, gridX and gridY are the width and height of the search grid.

Second, the width and height of the virtual block are calculated by:

$$newWidth = i \times 2 \times gridX + currWidth newHeight = i \times 2 \times gridY + currHeight .$$

where the currWidth and currHeight are the width and height of current block. The newWidth and newHeight are the width and height of new virtual block.

gridX and gridY are currently set to currWidth and currHeight, respectively.

FIG. 9 illustrates an example diagram 900 showing the relationship between the virtual block and the current block. FIG. 9 also illustrates virtual block in the ith search round.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.2.2 Non-Adjacent Spatial Candidate

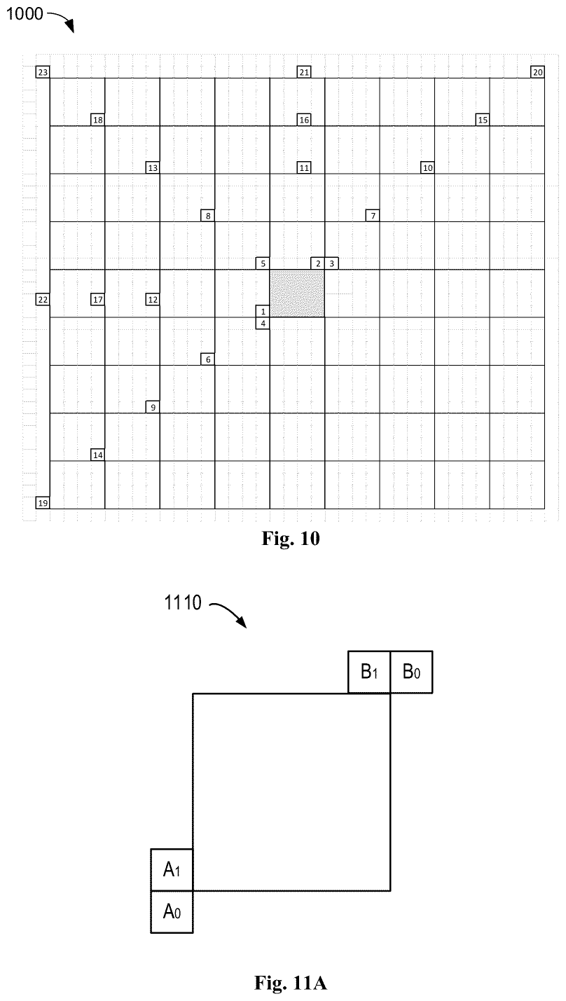

FIG. 10 illustrates an example diagram 1000 illustrating spatial neighboring blocks used to derive the spatial merge candidates. The non-adjacent spatial merge candidates are inserted after the TMVP in the regular merge candidate list. The pattern of spatial merge candidates is shown in FIG. 10. The distances between non-adjacent spatial candidates and current coding block are based on the width and height of current coding block. The line buffer restriction is not applied.

### 2.2.3 STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

$$mvLX = ( mvLX \_ F + mvLX\_ S + mvLX \_ T + mvLX \_ Col ) >> 2$$

2) If reference indices of three of the four merge candidates are valid and are equal to zero in prediction direction X (X=0 or 1),

$$mvLX = ( mvLX \_ F \times 3 + mvLX \_ S \times 3 + mvLX \_ Col \times 2 ) >> 3 or$$

$$mvLX = ( mvLX \_ F \times 3 + mvLX \_ T \times 3 + mvLX \_ Col \times 2 ) >> 3 or$$

$$mvLX = ( mvLX \_ S \times 3 + mvLX \_ T \times 3 + mvLX \_ Col \times 2 ) >> 3$$

3) If reference indices of two of the four merge candidates are valid and are equal to zero in prediction direction X (X=0 or 1),

$$mvLX = ( mvLX \_ F + mvLX \_ Col ) >> 1 or$$

$$mvLX = ( mvLX \_ S + mvLX \_ Col ) >> 1 or$$

$$mvLX = ( mvLX \_ T + mvLX \_ Col ) >> 1$$

Note: If the temporal candidate is unavailable, the STMVP mode is off.

### 2.2.4 Merge List Size

If considering both non-adjacent and STMVP merge candidates, the size of merge list is signalled in sequence parameter set header and the maximum allowed size of merge list is increased (e.g. 8).

### 2.3. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

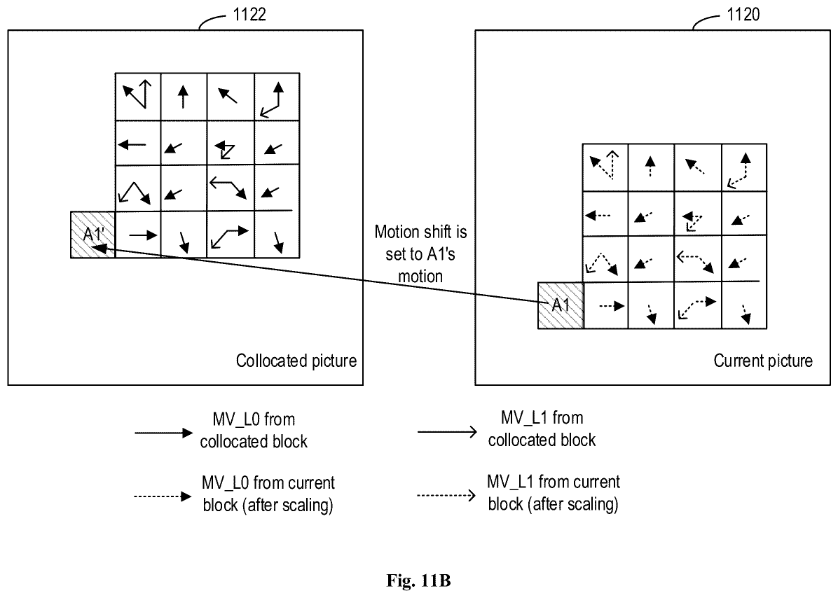

FIG. 11A and FIG. 11B illustrate the SbTMVP process in VVC. FIG. 11A illustrates an example diagram 1110 illustrating partial neighboring blocks used by SbTMVP. SbTMVP predicts the motion vectors of the sub-CUs within the current CU in two steps. In the first step, the spatial neighbor A1 in FIG. 11A is examined. If A1 has a motion vector that uses the collocated picture as its reference picture, this motion vector is selected to be the motion shift to be applied. If no such motion is identified, then the motion shift is set to (0, 0).

FIG. 11B illustrates deriving sub-CU motion field of the current picture 1120 by applying a motion shift from spatial neighbor and scaling the motion information from the corresponding collocated sub-CUs of the collocated picture 1122. In the second step, the motion shift identified in Step 1 is applied (i.e. added to the current block's coordinates) to obtain sub-CU-level motion information (motion vectors and reference indices) from the collocated picture as shown in FIG. 11B. The example in FIG. 11B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.4.1 Simplification of IBC Vector Prediction

The BV predictors for merge mode and AMVP mode in IBC will share a common predictor list, which consist of the following elements:
2 spatial neighboring positions (A0, B0 as in FIG. 4)
5 HMVP entries
Zero vectors by default

For merge mode, up to first 6 entries of this list will be used; for AMVP mode, the first 2 entries of this list will be used. And the list conforms with the shared merge list region requirement (shared the same list within the SMR).

### 2.4.2 IBC Reference Region

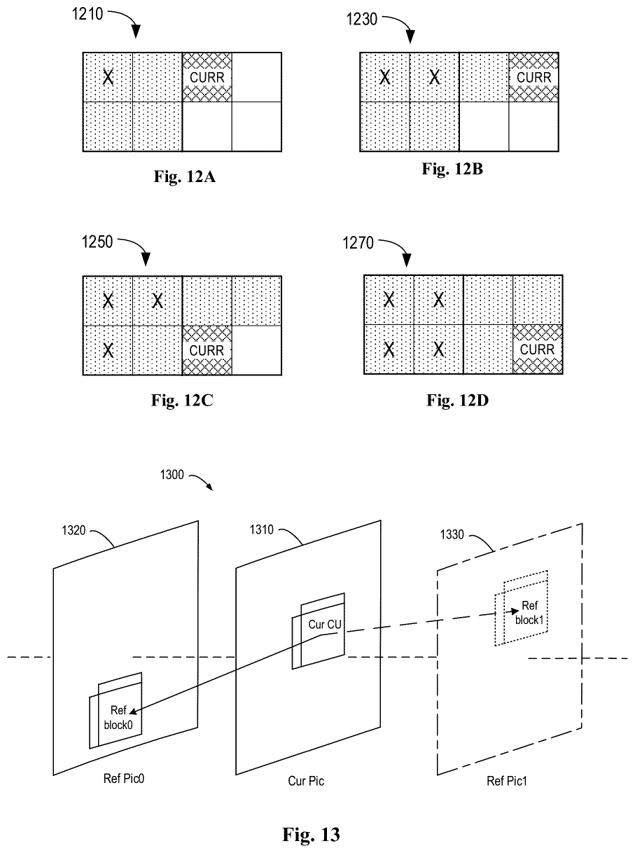

To reduce memory consumption and decoder complexity, the IBC in VVC allows only the reconstructed portion of the predefined area including the region of current CTU and some region of the left CTU. FIGS. 12A-12D illustrate example diagrams illustrating current CTU processing order and available samples in current and left CTU. As an example, FIGS. 12A-12D illustrate the reference region of IBC Mode, where each block represents 64×64 luma sample unit.

Depending on the location of the current coding CU location within the current CTU, the following applies:
As shown in the diagram 1210 of FIG. 12A, if current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
As shown in the diagram 1230 of FIG. 12B, if current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
As shown in the diagram 1250 of FIG. 12C, if current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
As shown in the diagram 1270 of FIG. 12D, if current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.4.3 IBC interaction with other coding tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitsream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU%wIbcBuf, . . . , xVPDU % wIbcBuf+Wᵥ−1; y=yVPDU%ctbSize, . . . , yVPDU%ctbSize+Wᵥ−1.
   After decoding a CU contains (x, y) relative to the top-left corner of the picture, set
ibcBuf[x % wIbcBuf] [y % ctbSize]=recSample[x] [y]

For a block covering the coordinates (x, y), if the following is true for a block vector by=(bv[0], bv[1]), then it is valid; otherwise, it is not valid:

$$ibcBuf [ ( x + bv [ 0 ] ) \% wIbcBuf ] [ ( y + bv [ 1 ] ) \% ctbSize ] shall not be equal to - 1.$$

### 2.4.4 IBC Virtual Buffer Test

A luma block vector bvL (the luma block vector in 1/16 fractional-sample accuracy) shall obey the following constraints:
CtbSizeY is greater than or equal to ((yCb+(bvL[1]>>4)) & (CtbSizeY−1))+cbHeight.
IbcVirBuf[0][(x+(bvL[0]>>4)) & (IbcBufWidthY−1)][(y+(bvL[1]>>4)) & (CtbSizeY−1)] shall not be equal to −1 for x=xCb . . . xCb+cbWidth−1 and y=yCb . . . yCb+cbHeight−1.

Otherwise, bvL is considered as an invalid by.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.5. Template Matching Based Adaptive Merge Candidate Reorder

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group.

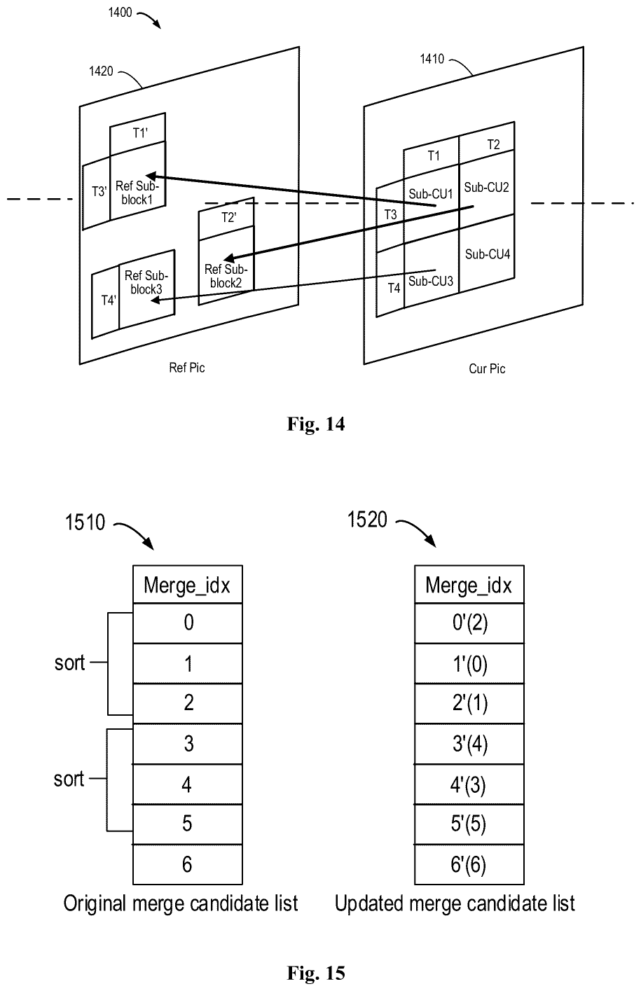

FIG. 13 illustrates an example diagram 1300 showing neighboring samples used for calculating SAD. The template matching cost is measured by the SAD (Sum of absolute differences) between the neighbouring samples of the current CU of the current picture 1310 and their corresponding reference samples. If a merge candidate includes bi-predictive motion information, the corresponding reference samples are the average of the corresponding reference samples in reference list0 1320 and the corresponding reference samples in reference list1 1330, as illustrated in FIG. 13. FIG. 14 illustrates an example diagram 1400 showing neighboring samples used for calculating SAD for sub-CU level motion information. If a merge candidate includes sub-CU level motion information of the current picture 1410, the corresponding reference samples consist of the neighbouring samples of the corresponding reference sub-blocks in the reference picture 1420, as illustrated in FIG. 14.

FIG. 15 illustrates a sorting process sorting an original merge candidate list 1510 into an updated merge candidate list 1520. The sorting process is operated in the form of sub-group, as illustrated in FIG. 15. The first three merge candidates are sorted together. The following three merge candidates are sorted together.

The template size (width of the left template or height of the above template) is 1. The sub-group size is 3.

### 2.6. Adaptive Merge Candidate List

We can assume the number of the merge candidates is 8. We take the first 5 merge candidates as a first subgroup and take the following 3 merge candidates as a second subgroup (i.e. the last subgroup).

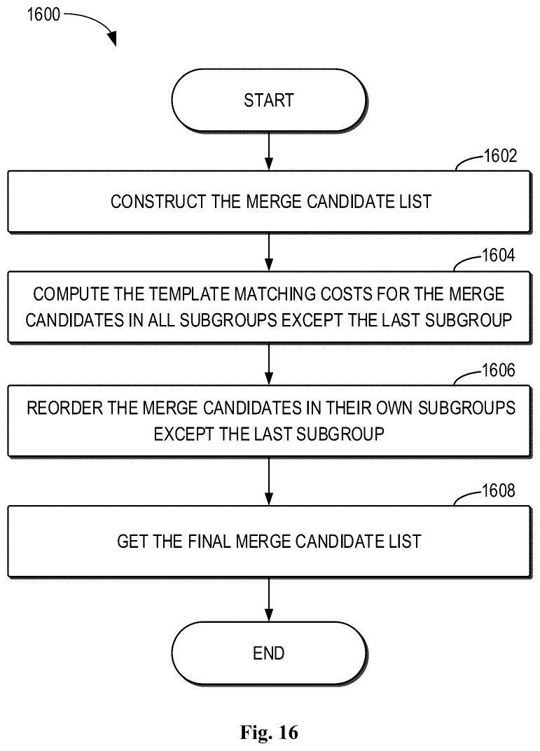

FIG. 16 illustrates an example diagram 1600 illustrating a reorder process in an encoder. For the encoder, after the merge candidate list is constructed at block 1602, some merge candidates are adaptively reordered in an ascending order of costs of merge candidates as shown in FIG. 16.

More specifically, the template matching costs for the merge candidates in all subgroups except the last subgroup are computed at block 1604; then reorder the merge candidates in their own subgroups except the last subgroup at block 1606; finally, the final merge candidate list will be got at block 1608.

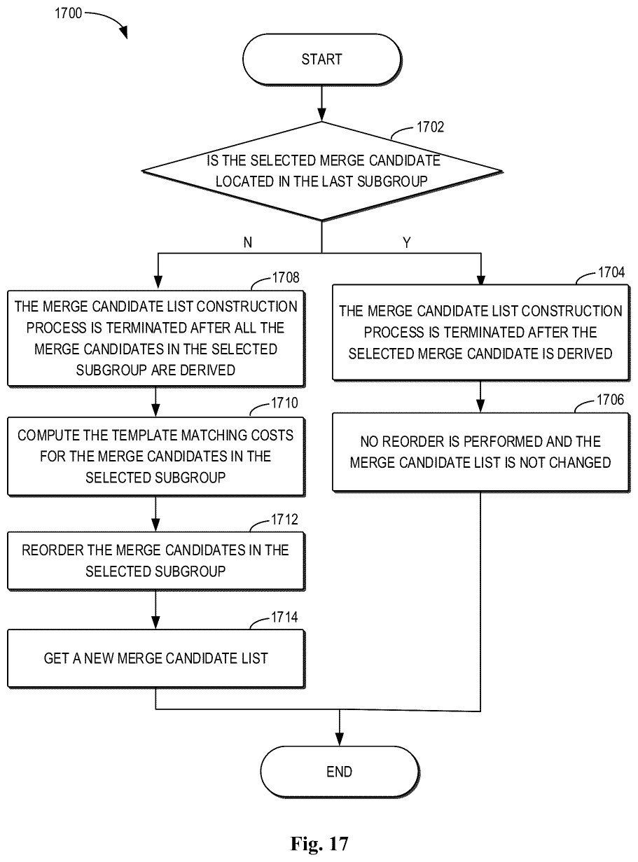

FIG. 17 illustrates an example diagram 1700 illustrating a reorder process in a decoder. For the decoder, after the merge candidate list is constructed, some/no merge candidates are adaptively reordered in ascending order of costs of merge candidates as shown in FIG. 17. In FIG. 17, the subgroup the selected (signaled) merge candidate located in is called the selected subgroup.

More specifically, if the selected merge candidate is located in the last subgroup at block 1702, the merge candidate list construction process is terminated after the selected merge candidate is derived at block 1704, no reorder is performed and the merge candidate list is not changed at block 1706; otherwise, the execution process is as follows:

The merge candidate list construction process is terminated after all the merge candidates in the selected subgroup are derived at block 1708; compute the template matching costs for the merge candidates in the selected subgroup at block 1710; reorder the merge candidates in the selected subgroup at block 1712; finally, a new merge candidate list will be got at block 1714.

For both encoder and decoder,

A template matching cost is derived as a function of T and RT, wherein T is a set of samples in the template and RT is a set of reference samples for the template.

When deriving the reference samples of the template for a merge candidate, the motion vectors of the merge candidate are rounded to the integer pixel accuracy. It can also be derived using 8 tap or 12 tap luma interpolation filter.

The reference samples of the template (RT) for bi-directional prediction are derived by weighted averaging of the reference samples of the template in reference list0 (RT₀) and the reference samples of the template in reference list1 (RT₁) as follows.

$$RT = ( ( 8 - w ) * {RT}_{0} + w * {RT}_{1} + 4 ) ≫ 3$$

where the weight of the reference template in reference list0 (8−w) and the weight of the reference template in reference list1 (w) are decided by the BCW index of the merge candidate. BCW index equal to {0,1,2,3,4} corresponds to w equal to {−2,3,4,5,10}, respectively.

If the Local Illumination Compensation (LIC) flag of the merge candidate is true, the reference samples of the template are derived with LIC method.

The template matching cost is calculated based on the sum of absolute differences (SAD) of T and RT.

The template size is 1. That means the width of the left template and/or the height of the above template is 1.

If the coding mode is MMVD, the merge candidates to derive the base merge candidates are not reordered.

If the coding mode is GPM, the merge candidates to derive the uni-prediction candidate list are not reordered.

### 2.7. Template Matching (TM)

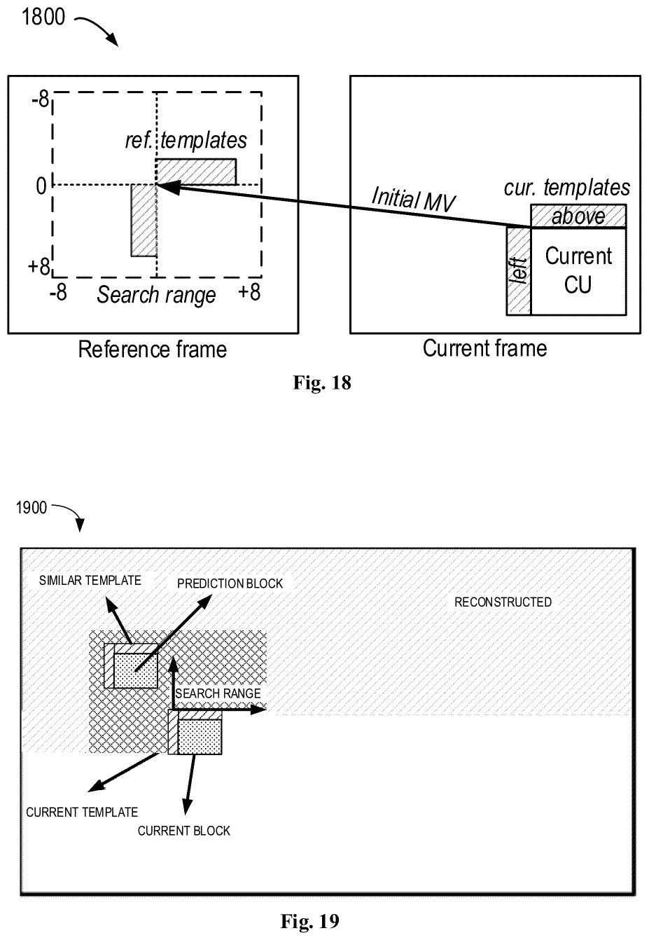

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 18 illustrates an example diagram 1800 illustrating template matching performs on a search area around initial MV. As illustrated in FIG. 18, a better MV is to be searched around the initial motion of the current CU within a [−8, +8]-pel search range. The template matching is adopted in this contribution with two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by AMVR mode after TM process.

TABLE 1
Search patterns of AMVR and merge mode with AMVR.

| | AMVR mode | | | | Merge mode | |
|---|---|---|---|---|---|---|
| | | | | Quarter- | AltIF = | AltIF = |
| Search pattern | 4-pel | Full-pel | Half-pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 1 shows, TM may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

At encoder side, TM merge mode will do MV refinement for each merge candidate.

### 2.8. Intra Template Matching for IBC (TM_IBC)

Template matching prediction (TMP) is a special intra prediction mode that copies the best prediction block from the reconstructed part of the current frame, whose L-shaped templated matches the current template. FIG. 19 illustrates an example diagram 1900 showing the template matching prediction. For a predefined search range, the encoder searches for the most similar template to the current template in the reconstructed part of the current frame, and uses the corresponding block as a prediction block. The encoder then signals the usage of this mode, and the inverse operation is made at the decoder side.

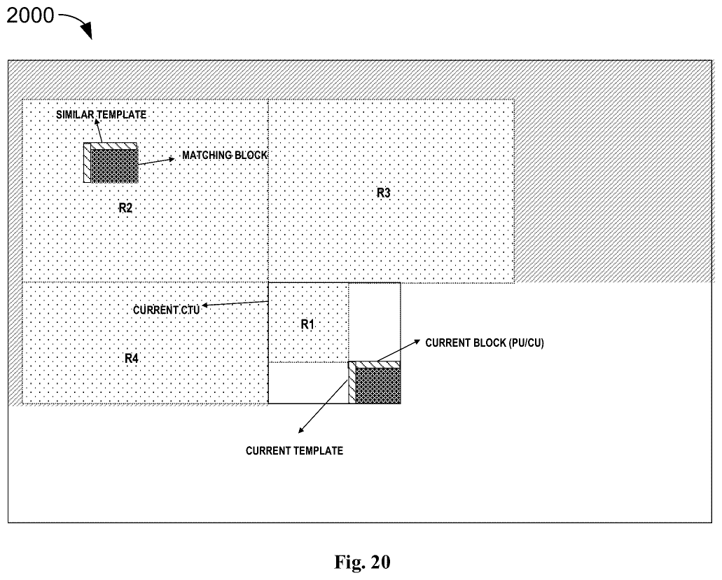

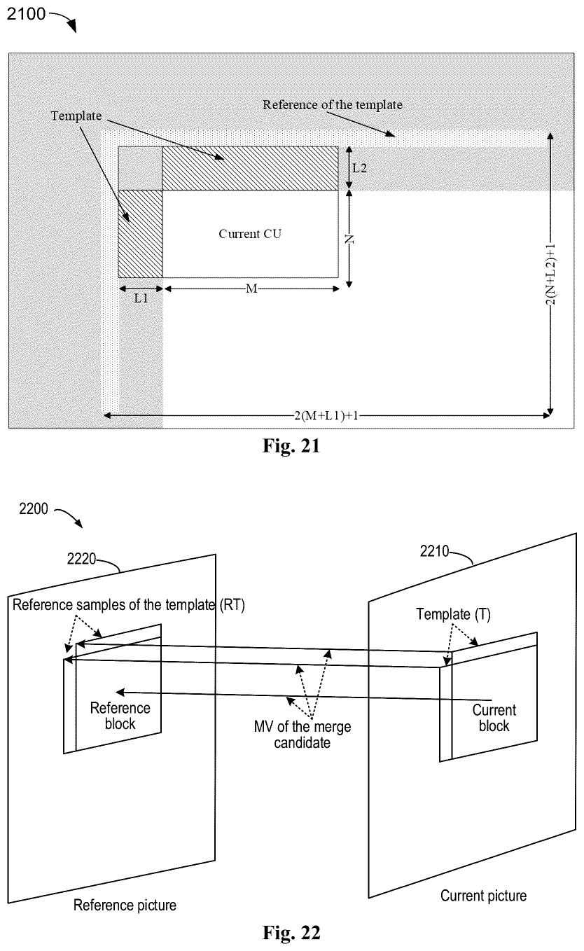

It is a coding tool that is mostly adapted for screen content coding. The prediction signal is generated at the decoder side by matching the L-shaped causal neighbor of the current block with another block in a predefined search area. This is illustrated in FIG. 20. FIG. 20 illustrates an example diagram 2000 showing intra template matching search area used. Specifically, the search range is divided into 3 regions:
R1: within the current CTU
R2: top-left outside the current CTU
R3: above the current CTU
R4: left to the current CTU

Within each region, the decoder searches for the template the has least SAD with respect to the current one and uses its corresponding block as a prediction block.

The dimensions of all regions (SearchRange_w, SearchRange_h) are set proportional to the block dimension (BlkW, BlkH) in order to have a fixed number of SAD comparisons per pixel. That is:

$$SearchRange \_ w = a * BlkW$$

$$SearchRange \_ h = a * BlkH$$

Where ‘a’ is a constant that controls the gain/complexity trade-off.

### 2.9. Template-Based Intra Mode Derivation Using MPMs

A TIMD mode is derived from MPMs using the neighbouring template. The TIMD mode is used as an additional intra prediction method for a CU. FIG. 21 illustrates an example diagram 2100 showing template and its reference samples used in TIMD. As shown in FIG. 21, the prediction samples of the template are generated using the reference samples of the template for each candidate mode. A cost is calculated as the sum of absolute transformed differences (SATD) between the prediction and the reconstruction samples of the template. The intra prediction mode with the minimum cost is selected as the TIMD mode and used for intra prediction of the CU.

### 2.9.1 TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) and gradient PDPC are supported in the derivation of the TIMD mode.

### 2.9.2 TIMD Signalling

A flag is signalled in sequence parameter set (SPS) to enable/disable TIMD. When the flag is true, a CU level flag is signalled to indicate whether TIMD is used for the CU. The TIMD flag is signalled right after the MIP flag. If the TIMD flag is equal to true, the remaining syntax elements related to luma intra prediction mode, is skipped.

2.9.3 Interaction with New Coding Tools in ECM-1.0

When DIMD flag or MIP flag is equal to true, the TIMD flag is not signalled and set equal to false.

TIMD is allowed to be combined with ISP and MRL. When TIMD is combined with ISP or MRL and the TIMD flag is equal to true, the derived TIMD mode is used as the intra prediction mode for ISP or MRL.

When the secondary MPM is enabled, both the primary MPMs and the secondary MPMs are used to derive the TIMD mode.

6-tap interpolation filter is not used in the derivation of the TIMD mode.

### 2.9.4 Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list.

### 2.10. Adaptive Merge Candidate List

Hereinafter, template is a set of reconstructed samples adjacently or non-adjacently neighboring to the current block. Reference samples of the template are derived according to the same motion information of the current block. For example, reference samples of the template are mapping of the template depend on a motion information. In this case, reference samples of the template are located by a motion vector of the motion information in a reference picture indicated by the reference index of the motion information. FIG. 22 illustrates an example diagram 2200 showing template and reference samples of the template, wherein RT represents the reference samples in a reference picture 2220 of the template T in a current picture 2210.

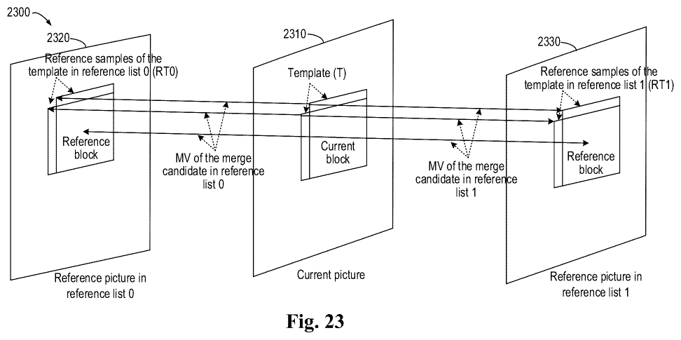

When a merge candidate utilizes bi-directional prediction, the reference samples of the template of the merge candidate are denoted by RT and RT may be generated from RT₀ which are derived from a reference picture in reference picture list 0 and RT₁ derived from a reference picture in reference picture list 1. In one example, RT₀ includes a set of reference samples on the reference picture of the current block indicated by the reference index of the merge candidate referring to a reference picture in reference list 0 with the MV of the merge candidate referring to reference list 0), In one example, RT₁ includes a set of reference samples on the reference picture of the current block indicated by the reference index of the merge candidate referring to a reference picture in reference list 1 with the MV of the merge candidate referring to reference list 1). FIG. 23 illustrates an example diagram 2300 showing template in a current picture 2310 and reference samples of the template in reference list 0 2320 and reference list 1 2330.

In one example, the reference samples of the template (RT) for bi-directional prediction are derived by equal weighted averaging of the reference samples of the template in reference list0 (RT₀) and the reference samples of the template in reference list1 (RT₁). One example is as follows:

$$RT = ( {RT}_{0} + {RT}_{1} + 1 ) ≫ 1$$

In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$RT = ( ( {2}^{N} - w ) * {RT}_{0} + w * {RT}_{1} + {2}^{N - 1} ) ≫ N ,$$

In one example, the weight of the reference template in reference list0 such as (8−w) and the weight of the reference template in reference list1 such as (w) maybe decided by the BCW index of the merge candidate.

The merge candidates can be divided to several groups according to some criterions. Each group is called a subgroup. For example, we can take adjacent spatial and temporal merge candidates as a first subgroup and take the remaining merge candidates as a second subgroup; In another example, we can also take the first N (N>2) merge candidates as a first subgroup, take the following M (M>2) merge candidates as a second subgroup, and take the remaining merge candidates as a third subgroup. Note that the proposed methods may be applied to merge candidate list construction process for inter coded blocks (e.g., translational motion), affine coded blocks; or other motion candidate list construction process (e.g., AMVP list; IBC AMVP list; IBC merge list).

W and H are the width and height of current block (e.g., luma block). Taking merge candidate list construction process as an example in the following descriptions:
1. The merge candidates can be adaptively rearranged in the final merge candidate list according to one or some criterions.
   a. In one example, partial or full process of current merge candidate list construction process is firstly invoked, followed by the reordering of candidates in the list.
      i. Alternatively, candidates in a first subgroup may be reordered and they should be added before those candidates in a second subgroup wherein the first subgroup is added before the second subgroup.
         (i) In one example, multiple merge candidates for a first category may be firstly derived and then reordered within the first category; then merge candidates from a second category may be determined according to the reordered candidates in the first category (e.g., how to apply pruning).
      ii. Alternatively, a first merge candidate in a first category may be compared to a second merge candidate in a second category, to decide the order of the first or second merge candidate in the final merge candidate list.
   b. In one example, the merge candidates may be adaptively rearranged before retrieving the merge candidates.
      i. In one example, the procedure of arranging merge candidates adaptively may be processed before the obtaining the merge candidate to be used in the motion compensation process.
   c. In one example, if the width of current block is larger than the height of current block, the above candidate is added before the left candidate.
   d. In one example, if the width of current block is smaller than the height of current block, the above candidate is added after the left candidate.
   e. Whether merge candidates are rearranged adaptively may depend on the selected merging candidate or the selected merging candidate index.
      i. In one example, if the selected merging candidate is in the last sub-group, the merge candidates are not rearranged adaptively.
   f. In one example, a merge candidate is assigned with a cost, the merge candidates are adaptively reordered in an ascending order of costs of merge candidates.
      i. In one example, the cost of a merge candidate may be a template matching cost.
      ii. In one example, template is a set of reconstructed samples adjacently or non-adjacently neighboring to the current block.
      iii. A template matching cost is derived as a function of T and RT, wherein T is a set of samples in the template and RT is a set of reference samples for the template.
         (i) How to obtain the reference samples of the template for a merge candidate may depend on the motion information of the merge candidate
         a) In one example, when deriving the reference samples of the template, the motion vectors of the merge candidate are rounded to the integer pixel accuracy, where the integer motion vector may be its nearest integer motion vector.
         b) In one example, when deriving the reference samples of the template, N-tap interpolation filtering is used to get the reference samples of the template at sub-pixel positions. For example, N may be 2, 4, 6, or 8.
         c) In one example, when deriving the reference samples of the template, the motion vectors of the merge candidates may be scaled to a given reference picture (e.g., for each reference picture list if available).
         d) For example, the reference samples of the template of a merge candidate are obtained on the reference picture of the current block indicated by the reference index of the merge candidate with the MVs or modified MVs (e.g., according to bullets a)-b)) of the merge candidate as shown in FIG. 22.
         e) For example, when a merge candidate utilizes bi-directional prediction, the reference samples of the template of the merge candidate are denoted by RT and RT may be generated from RT₀ which are derived from a reference picture in reference picture list 0 and RT₁ derived from a reference picture in reference picture list 1.
         [1] In one example, RT₀ includes a set of reference samples on the reference picture of the current block indicated by the reference index of the merge candidate referring to a reference picture in reference list 0 with the MV of the merge candidate referring to reference list 0),
         [2] In one example, RT₁ includes a set of reference samples on the reference picture of the current block indicated by the reference index of the merge candidate referring to a reference picture in reference list 1 with the MV of the merge candidate referring to reference list 1).
         [3] An example is shown in FIG. 23.
         f) In one example, the reference samples of the template (RT) for bi-directional prediction are derived by equal weighted averaging of the reference samples of the template in reference list0 (RT₀) and the reference samples of the template in reference list1 (RT₁). One example is as follows:

$$RT = ( {RT}_{0} + {RT}_{1} + 1 ) ≫ 1$$

g) In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$RT = ( ( {2}^{N} - w ) * {RT}_{0} + w * {RT}_{1} + {2}^{N - 1} ) ≫ N ,$$

for example, N=3.
h) h) In one example, the weight of the reference template in reference list0 such as (8−w) and the weight of the reference template in reference list1 such as (w) maybe decided by the BCW index of the merge candidate.
[1] In one example, BCW index is equal to 0, w is set equal to −2.
[2] In one example, BCW index is equal to 1, w is set equal to 3.
[3] In one example, BCW index is equal to 2, w is set equal to 4.
[4] In one example, BCW index is equal to 3, w is set equal to 5.
[5] In one example, BCW index is equal to 4, w is set equal to 10
i) In one example, if the Local Illumination Compensation (LIC) flag of the merge candidate is true, the reference samples of the template are derived with LIC method.
(ii) The cost may be calculated based on the sum of absolute differences (SAD) of T and RT.
a) Alternatively, the cost may be calculated based on the sum of absolute transformed differences (SATD) of T and RT.
b) Alternatively, the cost may be calculated based on the sum of squared differences (SSD) of T and RT.
c) Alternatively, the cost may be calculated based on weighted SAD/weighted SATD/weighted SSD.
(iii) The cost may consider the continuity (Boundary_SAD) between RT and reconstructed samples adjacently or non-adjacently neighboring to T in addition to the SAD calculated in (ii). For example, reconstructed samples left and/or above adjacently or non-adjacently neighboring to T are considered.
a) In one example, the cost may be calculated based on SAD and Boundary_SAD
[1] In one example, the cost may be calculated as (SAD+w*Boundary_SAD). w may be pre-defined, or signaled or derived according to decoded information.
2. Whether to and/or how to reorder the merge candidates may depend on the category of the merge candidates.
   a. In one example, only adjacent spatial and temporal merge candidates can be reordered.
   b. In one example, only adjacent spatial, STMVP, and temporal merge candidates can be reordered.
   c. In one example, only adjacent spatial, STMVP, temporal and non-adjacent spatial merge candidates can be reordered.
   d. In one example, only adjacent spatial, STMVP, temporal, non-adjacent spatial and HMVP merge candidates can be reordered.
   e. In one example, only adjacent spatial, STMVP, temporal, non-adjacent spatial, HMVP and pair-wise average merge candidates can be reordered.
   f. In one example, only adjacent spatial, temporal, HMVP and pair-wise average merge candidates can be reordered.
   g. In one example, only adjacent spatial, temporal, and HMVP merge candidates can be reordered.
   h. In one example, only adjacent spatial merge candidates can be reordered.
   i. In one example, only the first subgroup can be reordered.
   j. In one example, the last subgroup can not be reordered.
   k. In one example, only the first N merge candidates can be reordered.
      i. In one example, N is set equal to 5.
   l. In one example, for the candidates not to be reordered, they will be arranged in the merge candidate list according to the initial order.
   m. In one example, candidates not to be reordered may be put behind the candidates to be reordered.
   n. In one example, candidates not to be reordered may be put before the candidates to be reordered.
   o. In one example, a combination of some of the above items (a-k) can be reordered.
   p. Different subgroups may be reordered separately.
   q. Two candidates in different subgroups cannot be compared and/or reordered.
   r. A first candidate in a first subgroup must be put ahead of a second candidate in a second subgroup after reordering if the first subgroup is ahead of a second subgroup.
3. Whether to and/or how to reorder the merge candidates may depend on the coding mode.
   a. In one example, if the coding mode is regular merge mode, the merge candidates can be reordered.
   b. In one example, if the coding mode is MMVD, the merge candidates to derive the base merge candidates are not reordered.
      i. Alternatively, the reordering method may be different for the MMVD mode and other merge modes.
   c. In one example, if the coding mode is CIIP, the merge candidates used for combination with intra prediction are based on the reordered merge candidates.
      i. Alternatively, the reordering method may be different for the CIIP mode and other merge modes.
   d. In one example, if the coding mode is GPM, the merge candidates to derive the uni-prediction candidate list are not reordered.
      i. Alternatively, the reordering method may be different for the GPM mode and other merge modes.
   e. In one example, if the coding mode is a triangle partition mode, the merge candidates to derive the uni-prediction candidate list are not reordered.
      i. Alternatively, the reordering method may be different for the triangular mode and other merge modes.
   f. In one example, if the coding mode is a subblock based merge mode, partial or full subblock based merge candidates are reordered.
      i. Alternatively, the reordering method may be different for the subblock based merge mode and other merge modes
      ii. In one example, the uni-prediction subblock based merge candidates are not reordered.
      iii. In one example, the SbTMVP candidate is not reordered.
      iv. In one example, the constructed affine candidates are not reordered.
      v. In one example, the zero padding affine candidates are not reordered.
4. Whether to and/or how to reorder the merge candidates may depend on the available number of adjacent spatial and/or STMVP and/or temporal merge candidates
5. Whether the merge candidates need to be reordered or not may depend on decoded information (e.g., the width and/or height of the CU).
   a. In one example, if the height is larger than or equal to M, the width is larger than or equal to N, and width*height is larger than or equal to R, the merge candidates can be reordered.
      i. In one example, M, N, and R are set equal to 8, 8, and 128.
      ii. In one example, M, N, and R are set equal to 16, 16, and 512.
   b. In one example, if the height is larger than or equal to M and the width is larger than or equal to N, the merge candidates can be reordered.
      i. In one example, M and N are set equal to 8 and 8.
      ii. In one example, M and N are set equal to 16 and 16.
6. The subgroup size can be adaptive.
   a. In one example, the subgroup size is decided according to the available number of adjacent spatial and/or STMVP and/or temporal merge candidates denoted as N.
      i. In one example, if N is smaller than M and larger than Q, the subgroup size is set to N;
      ii. In one example, if N is smaller than or equal to Q, no reordering is performed;
      iii. In one example, if N is larger than or equal to M, the subgroup size is set to M.
      iv. In one example, M and Q are set equal to 5 and 1, respectively.
         (i) Alternatively, M and/or Q may be pre-defined, or signaled or derived according to decoded information.
   b. In one example, the subgroup size is decided according to the available number of adjacent spatial and temporal merge candidates denoted as N.
      i. In one example, if N is smaller than M and larger than Q, the subgroup size is set to N;
      ii. In one example, if N is smaller than or equal to Q, no reorder is performed;
      iii. In one example, if N is larger than or equal to M, the subgroup size is set to M.
      iv. In one example, M and Q are set equal to 5 and 1, respectively.
7. The template shape can be adaptive.
   a. In one example, the template may only comprise neighboring samples left to the current block.
   b. In one example, the template may only comprise neighboring samples above to the current block.
   c. In one example, the template shape is selected according to the CU shape.
   d. In one example, the width of the left template is selected according to the CU height.
      i. For example, if H<=M, then the left template size is w1×H; otherwise, the left template size is w2×H.
   e. In one example, M, w1, and w2 are set equal to 8, 1, and 2, respectively.
   f. In one example, the height of the above template is selected according to the CU width.
      i. For example, if W<=N, then the above template size is W×h1; otherwise, the above template size is W×h2.
         (i) In one example, N, h1, and h2 are set equal to 8, 1, and 2, respectively.
   g. In one example, the width of the left template is selected according to the CU width.
      i. For example, if W<=N, then the left template size is w1×H; otherwise, the left template size is w2×H.
         (i) In one example, N, w1, and w2 are set equal to 8, 1, and 2, respectively.
   h. In one example, the height of the above template is selected according to the CU height.
      i. For example, if H<=M, then the above template size is W×h1; otherwise, the above template size is W×h2.
         (i) In one example, M, h1, and h2 are set equal to 8, 1, and 2, respectively.
   i. In one example, samples of the template and the reference samples of the template samples may be subsampled or downsampled before being used to calculate the cost.
      i. Whether to and/or how to do subsampling may depend on the CU dimensions.
      ii. In one example, no subsampling is performed for the short side of the CU.
8. In above examples, the merge candidate is one candidate which is included in the final merge candidate list (e.g., after pruning)
   a. Alternatively, the merge candidate is one candidate derived from a given spatial or temporal block or HMVP table or with other ways even it may not be included in the final merge candidate list.
9. The template may comprise samples of specific color component(s).
   a. In one example, the template only comprises samples of the luma component.
10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.11. Adaptive Motion Candidate List

1. The motion candidates in a motion candidate list of a block can be adaptively rearranged to derive the reordered motion candidate list according to one or some criterions, and the block is encoded/decoded according to the reordered motion candidate list.
   a. The motion candidates in a motion candidate list of a block which is not a regular merge candidate list can be adaptively rearranged to derive the reordered motion candidate list according to one or some criterions.
   b. In one example, whether to and/or how to reorder the motion candidates may depend on the coding mode (e.g. affine merge, affine AMVP, regular merge, regular AMVP, GPM, TPM, MMVD, TM merge, CIIP, GMVD, affine MMVD).
   c. In one example, whether to and/or how to reorder the motion candidates may depend on the category (e.g., spatial, temporal, STMVP, HMVP, pair-wise, SbTMVP, constructed affine, inherited affine) of the motion candidates.
   d. In one example, the motion candidate list may be the AMVP candidate list.
   e. In one example, the motion candidate list may be the merge candidate list.
   f. In one example, the motion candidate list may be the affine merge candidate list.
   g. In one example, the motion candidate list may be the sub-block-based merge candidate list.
   h. In one example, the motion candidate list may be the GPM merge candidate list.
   i. In one example, the motion candidate list may be the TPM merge candidate list.
   j. In one example, the motion candidate list may be the TM merge candidate list.
   k. In one example, the motion candidate list may be the candidate list for MMVD coded blocks.
   l. In one example, the motion candidate list may be the candidate list for DMVR coded blocks.
2. How to adaptively rearrange motion candidates in a motion candidate list may depend on the decoded information, e.g., the category of a motion candidate, a category of a motion candidate list, a coding tool.
   a. In one example, for different motion candidate lists, different criteria may be used to rearrange the motion candidate list.
      i. In one example, the criteria may include how to select the template.
      ii. In one example, the criteria may include how to calculate the template cost.
      iii. In one example, the criteria may include how many candidates and/or how many sub-groups in a candidate list need to be reordered.
   b. In one example, the motion candidates in a motion candidate list are firstly adaptively rearranged to construct a fully rearranged candidate list or partially rearranged candidate list, and at least one motion candidate indicated by at least one index is then retrieved from the rearranged candidate list to derive the final motion information to be used by the current block.
   c. In one example, the motion candidates before refinement (e.g., using TM for TM coded blocks; adding MVD for MMVD coded blocks) are firstly adaptively rearranged to construct a fully rearranged candidate list or partially rearranged candidate list. Then at least one motion candidate indicated by at least one index is retrieved from the rearranged candidate list, and refinement (e.g., using TM for TM coded blocks; adding MVD for MMVD coded blocks) is applied to the retrieved one to derive the final motion information for the current block.
   d. In one example, refinement (e.g., using TM for TM coded blocks; adding MVD for MMVD coded blocks) is applied to at least one of the motion candidates in a motion candidate list, then they are adaptively rearranged to construct a fully rearranged candidate list or partially rearranged candidate list, and at least one motion candidate indicated by at least one index is then retrieved from the rearranged candidate list to derive final the motion information without any further refinement for the current block.
3. In one example, new MERGE/AMVP motion candidates may be generated based on the candidates reordering.
   i. For example, L0 motion and L1 motion of the candidates may be reordered separately.
   ii. For example, new bi-prediction merge candidates may be constructed by combining one from the reordered L0 motion and the other from the reordered L1 motion.
   iii. For example, new uni-prediction merge candidates may be generated by the reordered L0 or L1 motion.

### 2.12. Adaptive Motion Candidate List

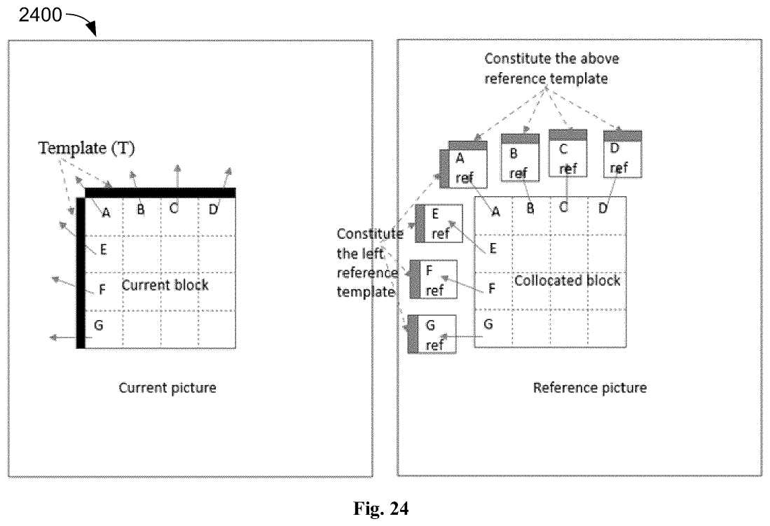

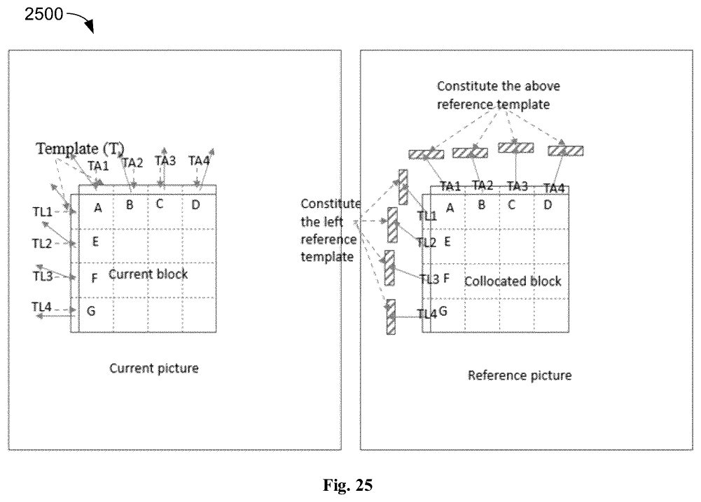

For subblock motion prediction, if the subblock size is Wsub*Hsub, the height of the above template is Ht, the width of the left template is Wt, the above template can be treated as a constitution of several sub-templates with the size of Wsub*Ht, the left template can be treated as a constitution of several sub-templates with the size of Wt*Hsub. After deriving the reference samples of each sub-template in the above similar way, the reference samples of the template are derived. Two examples are shown in FIG. 24 and FIG. 25. FIG. 24 illustrates an example diagram 2400 showing template and reference samples of the template for block with sub-block motion using the motion information of the subblocks of current block. FIG. 25 illustrates an example diagram 2500 showing template and reference samples of the template for block with sub-block motion using the motion information of each sub-template.

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).
1. In one example, if the coding mode is TM merge, partial or full TM merge candidates may be reordered.
   a. In one example, if the coding mode is TM merge, the partial or full original TM merge candidates may be reordered, before the TM refinement process.
   b. Alternatively, if the coding mode is TM merge, the partial or full refined TM merge candidates may be reordered, after the TM refinement process.
   c. Alternatively, if the coding mode is TM merge, the TM merge candidates may not be reordered.
   d. Alternatively, the reordering method may be different for the TM merge mode and other merge modes.
2. In one example, if the coding mode is a subblock based merge mode, partial or full subblock based merge candidates may be reordered.
   a. Alternatively, the reordering method may be different for the subblock based merge mode and other merge modes
   b. In one example, a template may be divided into sub-templates. Each sub-template may possess an individual piece of motion information.
      i. In one example, the cost used to reorder the candidates may be derived based on the cost of each sub-template. For example, the cost used to reorder the candidates may be calculated as the sum of the costs of all sub-templates. For example, the cost for a sub-template may be calculated as SAD, SATD, SSD or any other distortion measurement between the sub-template and its corresponding reference sub-template.
   c. In one example, to derive the reference samples of a sub-template, the motion information of the subblocks in the first row and the first column of current block may be used.
      i. In one example, the motion information of a sub-template may be derived (e.g. copied) from its adjacent sub-block in the current block. An example is shown in FIG. 24.
   d. In one example, to derive the reference samples of a sub-template, the motion information of the sub-template may be derived without referring to motion information of a sub-block in the current block. An example is shown in FIG. 25.
      i. In one example, the motion information of each sub-template is calculated according to the affine model of current block.
         (i) In one example, the motion vector of the center sample of each subblock containing a sub-template calculated according to the affine model of current block is treated as the motion vector of the sub-template.
         (ii) In one example, the motion vector of the center sample of each sub-template calculated according to the affine model of current block is treated as the motion vector of the sub-template.
         (iii) For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

(iv) For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

(v) For (iii) and (iv), the coordinates of above-left, above-right, and bottom-left corner of current block are (0,0), (W,0) and (0,H), the motion vectors of above-left, above-right, and bottom-left corner of current block are (mv₀ₓ, mv_{0y}), (mv₁ₓ, mv_{1y}) and (mv₂ₓ, mv_{2y}).
(vi) In one example, the coordinate (x, y) in the above equations may be set equal to a position in the template, or a position of a sub-template. E.g., the coordinate (x, y) may be set equal to a center position of a sub-template.
e. In one example, this scheme may be applied to affine merge candidates.
f. In one example, this scheme may be applied to affine AMVP candidates.
g. In one example, this scheme may be applied to SbTMVP merge candidate.
h. In one example, this scheme may be applied to GPM merge candidates.
i. In one example, this scheme may be applied to TPM merge candidates.
j. In one example, this scheme may be applied to TM-refinement merge candidates.
k. In one example, this scheme may be applied to DMVR-refinement merge candidates.
l. In one example, this scheme may be applied to MULTI_PASS_DMVR-refinement merge candidates.
3. In one example, if the coding mode is MMVD, the merge candidates to derive the base merge candidates may be reordered.
   a. In one example, the reordering process may be applied on the merge candidates before the merge candidates is refined by the signaled or derived MVD(s).
   b. For example, the reordering method may be different for the MMVD mode and other merge modes.
4. In one example, if the coding mode is MMVD, the merge candidates after the MMVD refinement may be reordered.
   a. In one example, the reordering process may be applied on the merge candidates after the merge candidates is refined by the signaled or derived MVD(s).
   b. For example, the reordering method may be different for the MMVD mode and other merge modes.
5. In one example, if the coding mode is affine MMVD, the merge candidates to derive the base merge candidates may be reordered.
   a. In one example, the reordering process may be applied on the merge candidates before the affine merge candidates is refined by the signaled or derived MVD(s).
   b. For example, the reordering method may be different for the affine MMVD mode and other merge modes.
6. In one example, if the coding mode is affine MMVD, the merge candidates after the affine MMVD refinement may be reordered.
   a. In one example, the reordering process may be applied on the affine merge candidates after the merge candidates is refined by the signaled or derived MVD(s).
   b. For example, the reordering method may be different for the affine MMVD mode and other merge modes.
7. In one example, if the coding mode is GMVD, the merge candidates to derive the base merge candidates may be reordered.
   a. In one example, the reordering process may be applied on the merge candidates before the merge candidates is refined by the signaled or derived MVD(s).
   b. For example, the reordering method may be different for the GMVD mode and other merge modes.
8. In one example, if the coding mode is GMVD, the merge candidates after the GMVD refinement may be reordered.
   a. In one example, the reordering process may be applied on the merge candidates after the merge candidates is refined by the signaled or derived MVD(s).
   b. For example, the reordering method may be different for the GMVD mode and other merge modes.
9. In one example, if the coding mode is GPM, the merge candidates may be reordered.
   a. In one example, the reordering process may be applied on the original merge candidates before the merge candidates are used to derive the GPM candidate list for each partition (a.k.a. the uni-prediction candidate list for GPM).
   b. In one example, if the coding mode is GPM, the merge candidates in the uni-prediction candidate list may be reordered.
   c. In one example, the GPM uni-prediction candidate list may be constructed based on the reordering.
      i. In one example, a candidate with bi-prediction (a.k.a. bi-prediction candidate) may be separated into two uni-prediction candidates.
         (i) If the number of original merge candidates is M, at most 2M uni-prediction candidates may be separated from them.
      ii. In one example, uni-prediction candidates separated from a bi-prediction candidate may be put into an initial uni-prediction candidate list.
      iii. In one example, candidates in the initial uni-prediction candidate list may be reordered with the template matching costs.
      iv. In one example, the first N uni-prediction candidates with smaller template matching costs may be used as the final GPM uni-prediction candidates. As an example, N is equal to M.
   d. In one example, after deriving a GPM uni-prediction candidate list, a combined bi-prediction list for partition 0 and partition 1 is constructed, then the bi-prediction list is reordered.
      i. In one example, if the number of GPM uni-prediction candidates is M, the number of combined bi-prediction candidates is M*(M−1).
   e. Alternatively, the reordering method may be different for the GPM mode and other merge modes.

### 2.13. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, or IBC coded blocks; or other motion candidate list construction process (e.g., normal AMVP list; affine AMVP list; IBC AMVP list).

W and H are the width and height of current block (e.g., luma block).
1. The reference samples of a template or sub-template (RT) for bi-directional prediction are derived by equal weighted averaging of the reference samples of the template or sub-template in reference list0 (RT₀) and the reference samples of the template or sub-template in reference list1 (RT₁). One example is as follows:

$$RT ( x , y ) = ( {RT}_{0} ( x , y ) + {RT}_{1} ( x , y ) + 1 ) ≫ 1$$

2. The reference samples of a template or sub-template (RT) for bi-directional prediction are derived by weighted averaging of the reference samples of the template or sub-template in reference list0 (RT₀) and the reference samples of the template or sub-template in reference list1 (RT₁).
   a. One example is as follows:

$$R T ( x , y ) = ( ( {2}^{N} - w ) * R {T}_{0} ( x , y ) + w * R {T}_{1} ( x , y ) + {2}^{N - 1} ) ≫ N ,$$

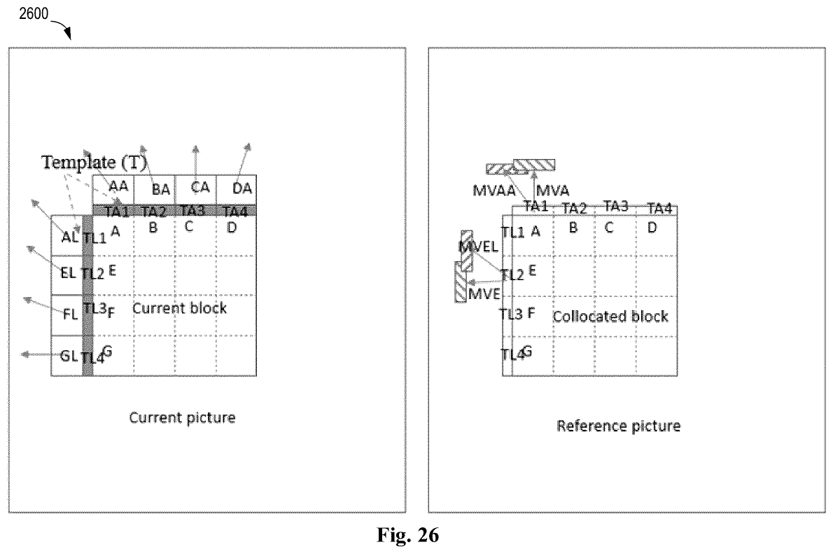

example, N=3.
b. The weights may be determined by the BCW index or derived on-the-fly or pre-defined or by the weights used in weighted prediction.
c. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.
3. It is proposed that the reference samples of the template may be derived with LIC method.
   a. In one example, the LIC parameters for both left and above templates are the same as the LIC parameters of current block.
   b. In one example, the LIC parameters for left template are derived as the LIC parameters of current block which uses its original motion vector plus a motion vector offset of (−Wt,0) as the motion vector of current block.
   c. In one example, the LIC parameters for above template are derived as the LIC parameters of current block which uses its original motion vector plus a motion vector offset of (0, −Ht) as the motion vector of current block.
   d. Alternatively, furthermore, the above bullets may be applied if the Local Illumination Compensation (LIC) flag of a merge candidate is true 4. It is proposed that the reference samples of the template or sub-template may be derived with OBMC method. In the following discussion, a “template” may refer to a template or a sub-template.
   a. In one example, to derive the reference samples of the above template, the motion information of the subblocks in the first row of current block and their above adjacent neighboring subblocks are used. And the reference samples of all the sub-templates constitute the reference samples of the above template. An example is shown in FIG. 26. FIG. 26 illustrates an example diagram 2600 showing template and reference samples of the template for block with OBMC.
   b. In one example, to derive the reference samples of the left template, the motion information of the subblocks in the first column of current block and their left adjacent neighboring subblocks are used. And the reference samples of all the sub-templates constitute the reference samples of the left template. An example is shown in FIG. 26.
   c. In one example, the subblock size is 4×4.
   d. The reference samples of a sub-template based on motion vectors of a neighbouring subblock is denoted as P_{N}, with N indicating an index for the neighbouring above and left subblocks and the reference samples of a sub-template based on motion vectors of a subblock of current block is denoted as P_{C}. For P_{N} generated based on motion vectors of vertically (horizontally) neighbouring sub-block, samples in the same row (column) of P_{N} are added to P_{C} with a same weighting factor.
      i. The reference samples of a sub-template (P) may be derived as P=W_{N}*P_{N}+W_{C}*P_{C}
      ii. In one example, the weighting factors {1/4, 1/8, 1/16, 1/32} are used for the {first, second, third, fourth} row (column) of P_{N} and the weighting factors {3/4, 7/8, 15/16, 31/32} are used for the {first, second, third, fourth} row (column) of P_{C} if the height of the above template or the width of the left template is larger than or equal to 4.
      iii. In one example, the weighting factors {1/4, 1/8} are used for the {first, second} row (column) of P_{N} and the weighting factors {3/4, 7/8} are used for the {first, second} row (column) of P_{C} if the height of the above template or the width of the left template is larger than or equal to 2.
      iv. In one example, the weighting factor {1/4} is used for the first row (column) of P_{N} and the weighting factor {3/4} is used for the first row (column) of P_{C} if the height of the above template or the width of the left template is larger than or equal to 1.
   e. The above bullets may be applied if a merge candidate is assigned with OBMC enabled.
5. In one example, if a merge candidate uses multi-hypothesis prediction, the reference samples of the template may be derived with multi-hypothesis prediction method.
6. The template may comprise samples of specific color component(s).
   a. In one example, the template only comprises samples of the luma component.
   b. Alternatively, the template only comprises samples of any component such as Cb/Cr/R/G/B.
7. Whether to and/or how to reorder the motion candidates may depend on the category of the motion candidates.
   a. In one example, only adjacent spatial and temporal motion candidates can be reordered.
   b. In one example, only adjacent spatial, STMVP, and temporal motion candidates can be reordered.
   c. In one example, only adjacent spatial, STMVP, temporal and non-adjacent spatial motion candidates can be reordered.
   d. In one example, only adjacent spatial, STMVP, temporal, non-adjacent spatial and HMVP motion candidates can be reordered.
   e. In one example, only adjacent spatial, STMVP, temporal, non-adjacent spatial, HMVP and pair-wise average motion candidates can be reordered.
   f. In one example, only adjacent spatial, temporal, HMVP and pair-wise average motion candidates can be reordered.
   g. In one example, only adjacent spatial, temporal, and HMVP motion candidates can be reordered.
   h. In one example, only adjacent spatial motion candidates can be reordered.
   i. In one example, the uni-prediction subblock based motion candidates are not reordered.
   j. In one example, the SbTMVP candidate is not reordered.
   k. In one example, the inherited affine motion candidates are not reordered.
   l. In one example, the constructed affine motion candidates are not reordered.
   m. In one example, the zero padding affine motion candidates are not reordered.
   n. In one example, only the first N motion candidates can be reordered.
      i. In one example, N is set equal to 5.
8. In one example, the motion candidates may be divided into subgroups. Whether to and/or how to reorder the motion candidates may depend on the subgroup of the motion candidates.
   a. In one example, only the first subgroup can be reordered.
   b. In one example, the last subgroup can not be reordered.
   c. In one example, the last subgroup can not be reordered. But if the last subgroup also is the first subgroup, it can be reordered.
   d. Different subgroups may be reordered separately.
   e. Two candidates in different subgroups cannot be compared and/or reordered.
   f. A first candidate in a first subgroup must be put ahead of a second candidate in a second subgroup after reordering if the first subgroup is ahead of a second subgroup.
9. In one example, the motion candidates which are not included in the reordering process may be treated in specified way.
   a. In one example, for the candidates not to be reordered, they will be arranged in the merge candidate list according to the initial order.
   b. In one example, candidates not to be reordered may be put behind the candidates to be reordered.
   c. In one example, candidates not to be reordered may be put before the candidates to be reordered.
10. Whether to apply the adaptive merge candidate list reordering may depend on a message signaled in VPS/SPS/PPS/sequence header/picture header/slice header/CTU/CU/TU/PU. It may also be a region based on signaling. For example, the picture is partitioned into groups of CTU/CUs evenly or unevenly, and one flag is coded for each group to indicate whether merge candidate list reordering is applied or not.

### 2.14. Cost Function Utilized in Coding Data Refinement in Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block)

In the following discussion, Shift(x, s) is defined as

Shift(x, s)=(x+offset)>>s, wherein offset is an integer such as offset=0 or offset=1<<(s−1) or offset=(1<<(s−1))−1.

In another example, offset depends on x. For example, offset=(x<0 ? (1<<(s−1)):((1<<(s−1)−1).
1. In addition to the error measurement, it is proposed to add a regulation item in the cost calculation process.
   a) In one example, the cost is defined as: E+W*RI wherein the E represents the output of an error function, W is the weight applied to the regulation item denoted by RI.
      i. In one example, for processing the template-based-coded block/bilateral-based-coded block, the cost function is set to: E+W*RI wherein E may be SAD/MRSAD/SATD or others, RI is the estimated bits for motion vectors/motion vector differences, W is a weight, e.g., which may rely on QP/temporal layer etc. al.
      ii. Alternatively, the cost is defined as: w0*E+W1*RI wherein the E represents the output of an error function, W1 is the weight applied to the regulation item denoted by RI, w0 is the weight applied to the output of the error function.
         (i) Alternatively, furthermore, W1 may be set to 0.
   b) In one example, the regulation item is multiplied by a weighted rate.
      i. In one example, the weight is derived on-the-fly.
      ii. In one example, the weight is set to lambda used in the full RDO process
      iii. In one example, the weight is set to a square root of the lambda used in the full RDO process.
   c) In one example, the cost is calculated as E+Shift(W*RI, s), wherein s and W are integers.
      i. Alternatively, the cost is calculated as Shift((E<<s)+W*RI, s), wherein s and W are integers.
2. It is proposed to use an error function different from SAD/MR-SAD (mean removal sum of absolute difference) for processing a template-based-coded block/bilateral-based-coded block.
   a) In one example, the error function may be
      i. SATD
      ii. MR-SATD
      iii. Gradient information
      iv. SSE/SSD
      v. MR-SSE/MR-SSD
      vi. Weighted SAD/weighted MR-SAD
      vii. Weighted SATD/weighted MR-SATD
      viii. Weighted SSD/weighted MR-SSD
      ix. Weighted SSE/weighted MR-SSE
   b) Alternatively, furthermore, it is proposed to adaptively select the error function among different cost functions such as the above mentioned error functions and SAD/MR-SAD.
      i. The selection may be determined on-the-fly.
3. When using the MR-X (e.g., X being SATD, SAD, SSE) based error function (e.g., MR-SAD/MR-SATD etc. al), the following may further apply:
   a) In one example, the mean may be calculated with all samples in a block to be compared taken into consideration.
   b) In one example, the mean may be calculated with partial samples in a block to be compared taken into consideration.
   c) In one example, the mean and the X function may depend on same samples in a block.
      i. In one example, the mean and X function may be calculated with all samples in the block.
      ii. In one example, the mean and X function may be calculated with partial samples in the block.
   d) In one example, the mean and the X function may depend on at least one different samples in a block.
      i. In one example, the mean may be calculated with all samples while the X function may depend on partial samples in the block.
      ii. In one example, the mean may be calculated with partial samples while the X function may depend on all samples in the block.
4. The template/bilateral matching cost may be calculated by applying a cost factor to the error cost function.
   a) In one example, it is proposed to favor the motion candidates ahead during the template/bilateral matching based reordering process.
      i. In one example, the motion candidate in the ith position is assigned with a smaller cost factor than the cost factor of the motion candidate in the (i+1)th position.
      ii. In one example, the motion candidates in the ith group (e.g. involve M motion candidates) are assigned with a smaller cost factor than the cost factor of the motion candidates in the (i+1)th group (e.g. involve N motion candidates).
         (i) In one example, M may be equal to N. For example, M=N=2.
         (ii) In one example, M may be not equal to N. For example, M=2, N=3.
   b) In one example, it is proposed to favor the searching MVs closer to original MV during the template/bilateral matching based refinement process
      i. In one example, each search region is assigned with a cost factor, which may be determined by the distance (e.g. delta MV in integer pixel precision) between each searching MV in the search region and the starting MV.
      ii. In one example, each search region is assigned with a cost factor, which may be determined by the distance (e.g. delta MV in integer pixel precision) between the center searching MV in the search region and the starting MV.
      iii. In one example, each searching MV is assigned with a cost factor, which may be determined by the distance (e.g. delta MV in integer pixel precision) between each searching MV and the starting MV.
5. The above methods may be applied to any coding data refinement process, e.g., for a template-based-coded block, for a bilateral-based-coded block (e.g., DMVR in VVC).
6. The template matching cost measurement may be different for different template matching refinement methods.
   a. In one example, the template matching refinement method may be template matching based motion candidate reordering.
   b. In one example, the template matching refinement method may be template matching based motion derivation.
      i. In one example, the refinement method may be TM AMVP, TM merge, and/or FRUC.
   c. In one example, the template matching refinement method may be template matching based motion refinement.
      ii. In one example, the refinement method may be TM GPM, TM CIIP, and/or TM affine.
   d. In one example, the template matching refinement method may be template matching based block vector derivation.
   e. In one example, the template matching refinement method may be template matching based intra mode derivation.
      iii. In one example, the refinement method may be DIMD and/or TIMD.
   f. In one example, the template matching cost measure may be calculated based on the sum of absolute differences (SAD) between the current and reference templates.
   g. In one example, the template matching cost measure may be calculated based on the mean-removal SAD between the current and reference templates.
   h. In one example, SAD and mean-removal SAD (MR-SAD) might be selectively utilized according to the size of the current block.
      i. In one example, mean-removal SAD is used for the block with size larger than M and SAD is used for the block with size smaller than or equal to M.
         (i) In one example, M is 64.
   i. In one example, SAD and mean-removal SAD (MR-SAD) might be selectively utilized according to the LIC flag of the current block.
      i. In one example, the template matching cost measure may be SAD if the LIC flag of the current block is false.
      ii. In one example, the template matching cost measure may be MR-SAD if the LIC flag of the current block is true.
   j. In one example, the template matching cost measure may be calculated based on the sum of absolute transformed differences (SATD) between the current and reference templates.
   k. In one example, the template matching cost measure may be calculated based on the mean-removal SATD between the current and reference templates.
   l. In one example, SATD and mean-removal SATD (MR-SATD) might be selectively utilized according to the size of the current block.
      i. In one example, mean-removal SATD is used for the block with size larger than M and SATD is used for the block with size smaller than or equal to M.
         (i) In one example, M is 64.
   m. In one example, SATD and mean-removal SATD (MR-SATD) might be selectively utilized according to the LIC flag of the current block.
      i. In one example, the template matching cost measure may be SATD if the LIC flag of the current block is false.
      ii. In one example, the template matching cost measure may be MR-SATD if the LIC flag of the current block is true.
   n. In one example, the template matching cost measure may be calculated based on the sum of squared differences (SSD) between the current and reference templates.
   o. In one example, the template matching cost measure may be calculated based on the mean-removal SSD between the current and reference templates.
   p. In one example, SSD and mean-removal SSD (MR-SSD) might be selectively utilized according to the size of the current block.
      i. In one example, mean-removal SSD is used for the block with size larger than M and SSD is used for the block with size smaller than or equal to M.
         (i) In one example, M is 64.
   q. In one example, the template matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the current and reference templates.
      i. In one example, the weighted means applying different weights to each sample based on its row and column indices in template block when calculating the distortion between the current and reference templates.
      ii. In one example, the weighted means applying different weights to each sample based on its positions in template block when calculating the distortion between the current and reference templates.
      iii. In one example, the weighted means applying different weights to each sample based on its distances to current block when calculating the distortion between the current and reference templates.
   r. In one example, the template matching cost may be calculated as a form of tplCost=w1*mvDistanceCost+w2*distortionCost.
      i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the current and reference templates.
      ii. In one example, mvDistanceCost may be the sum of absolute my differences of searching point and starting point in horizontal and vertical directions.
      iii. In one example, w1 and w2 may be pre-defined, or signaled or derived according to decoded information.
         (i) In one example, w1 is a weighting factor set to 4, w2 is a weighting factor set to 1
   s. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
      i. In one example, the cost may be calculated based on SAD and Boundary_SAD
         (i) In one example, the cost may be calculated as (SAD+w*Boundary_SAD). w may be pre-defined, or signaled or derived according to decoded information.
7. The bilateral matching cost measurement may be different for different bilateral matching refinement methods.
   a) In one example, the bilateral matching refinement method may be bilateral matching based motion candidate reordering.
   b) In one example, the bilateral matching refinement method may be bilateral matching based motion derivation.
      i. In one example, the refinement method may be BM merge and/or FRUC.
   c) In one example, the bilateral matching refinement method may be bilateral matching based motion refinement.
      i. In one example, the refinement method may be BM GPM, BM CIIP, and/or BM affine.
   d) In one example, the bilateral matching refinement method may be bilateral matching based block vector derivation.
   e) In one example, the bilateral matching refinement method may be bilateral matching based intra mode derivation.
   f) In one example, the bilateral matching cost measure may be calculated based on the sum of absolute differences (SAD) between the two reference blocks/subblocks.
   g) In one example, the bilateral matching cost measure may be calculated based on the mean-removal SAD between the two reference blocks/subblocks.
   h) In one example, SAD and mean-removal SAD (MR-SAD) might be selectively utilized according to the size of the current block/subblock.
      i. In one example, mean-removal SAD is used for the block/subblock with size larger than M and SAD is used for the block/subblock with size smaller than or equal to M.
         (i) In one example, M is 64.
   i) In one example, SAD and mean-removal SAD (MR-SAD) might be selectively utilized according to the LIC flag of the current block.
      i. In one example, the bilateral matching cost measure may be SAD if the LIC flag of the current block is false.
      ii. In one example, the bilateral matching cost measure may be MR-SAD if the LIC flag of the current block is true.
   j) In one example, the bilateral matching cost measure may be calculated based on the sum of absolute transformed differences (SATD) between the two reference blocks/subblocks.
   k) In one example, the bilateral matching cost measure may be calculated based on the mean-removal SATD between the two reference blocks/subblocks.
   l) In one example, SATD and mean-removal SATD (MR-SATD) might be selectively utilized according to the size of the current block/subblock.
      i. In one example, mean-removal SATD is used for the block/subblock with size larger than M and SATD is used for the block/subblock with size smaller than or equal to M.
         (i) In one example, M is 64.
   m) In one example, SATD and mean-removal SATD (MR-SATD) might be selectively utilized according to the LIC flag of the current block.
      i. In one example, the bilateral matching cost measure may be SATD if the LIC flag of the current block is false.
      ii. In one example, the bilateral matching cost measure may be MR-SATD if the LIC flag of the current block is true.
   n) In one example, the bilateral matching cost measure may be calculated based on the sum of squared differences (SSD) between the two reference blocks/subblocks.
   o) In one example, the bilateral matching cost measure may be calculated based on the mean-removal SSD between the two reference blocks/subblocks.
   p) In one example, SSD and mean-removal SSD (MR-SSD) might be selectively utilized according to the size of the current block/subblock.
      i. In one example, mean-removal SSD is used for the block/subblock with size larger than M and SSD is used for the block/subblock with size smaller than or equal to M.
         (i) In one example, M is 64.
   q) In one example, SSD and mean-removal SSD (MR-SSD) might be selectively utilized according to the LIC flag of the current block.
      i. In one example, the bilateral matching cost measure may be SSD if the LIC flag of the current block is false.
      ii. In one example, the bilateral matching cost measure may be MR-SSD if the LIC flag of the current block is true.
   r) In one example, the bilateral matching cost measure may be the weighted SAD/weighted MR-SAD/selectively weighted MR-SAD and SAD/weighted SATD/weighted MR-SATD/selectively weighted MR-SATD and SATD/weighted SSD/weighted MR-SSD/selectively weighted MR-SSD and SSD between the two reference blocks/subblocks.
      i. In one example, the weighted means applying different weights to each sample based on its row and column indices in reference block/subblock when calculating the distortion between the two reference blocks/subblocks.
      ii. In one example, the weighted means applying different weights to each sample based on its positions in reference block/subblock when calculating the distortion between the two reference blocks/subblocks.
      iii. In one example, the weighted means applying different weights to each sample based on its distances to center position of reference block/subblock when calculating the distortion between the two reference blocks/subblocks.
   s) In one example, if MR-SAD/MR-SATD/MR-SSD is used for the bilateral matching cost measure, LIC may be not used when deriving the reference blocks/subblocks.
   t) In one example, the bilateral matching cost may be calculated as a form of bilCost=w1*mvDistanceCost+w2*distortionCost.
      i. In one example, distortionCost may be weighted SAD/weighted MR-SAD/weighted SATD/weighted MR-SATD/weighted SSD/weighted MR-SSD/SAD/MR-SAD/SATD/MR-SATD/SSD/MR-SSD between the two reference blocks/subblocks.
      ii. In one example, mvDistanceCost may be the sum of absolute my differences of searching point and starting point in horizontal and vertical directions.
      iii. In one example, w1 and w2 may be pre-defined, or signaled or derived according to decoded information.
         (i) In one example, w1 is a weighting factor set to 4, w2 is a weighting factor set to 1.
8. The bilateral or template matching cost may be calculated based on prediction/reference samples which are modified by a function.
   a) In one example, the prediction/reference samples may be filtered before being used to calculate the bilateral or template matching cost.
   b) In one example, a prediction/reference sample S may be modified to be a*S+b before being used to calculate the bilateral or template matching cost.
   c) In one example, the modification may depend on the coding mode of the block, such as whether the block is LIC-coded or BCW-coded.

### 2.15. Usage of Multiple Cost Functions in Coding Data Refinement in Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block)
1. The cost definition may rely on outputs of multiple errors functions (e.g., distortion measurement methods) regarding the error/difference of two samples/blocks to be evaluated in one coding data refinement process of a current block.
   a) In one example, the error function may be:
      i. SAD
      ii. SATD
      iii. MR-SAD
      iv. MR-SATD
      v. Gradient information
      vi. SSE/SSD
      vii. MR-SSE/MR-SSD
      viii. Weighted SAD/weighted MR-SAD
      ix. Weighted SATD/weighted MR-SATD
      x. Weighted SSD/weighted MR-SSD
      xi. Weighted SSE/weighted MR-SSE
   b) In one example, the error function may be performed in block level or sub-block level.
      i. Alternatively, furthermore, for two sub-blocks, the error function may be different.
      ii. Alternatively, furthermore, the final output of the evaluated error of a block may be based on the outputs of sub-blocks, e.g., sum of outputs of error functions applied to each sub-block. 2. When the cost definition relies on outputs of multiple functions, the following may further apply:
   a) In one example, the cost function may rely on a linear weighted sum of multiple error functions.
   b) In one example, the cost function may rely on a non-linear weighted sum of multiple error functions.
   c) In one example, the cost function may further rely on estimated bits for side information.
   d) In one example, the cost function may be defined as:

$$C = R + {\sum }_{i = 0}^{N - 1} {W}_{i} * {E}_{i}$$

wherein R denotes the estimated bits for side information, Wᵢ and Eᵢ represent the weight applied to the i-th error function and output of the i-th error function, respectively.
3. Multiple refinement processes may be applied to one block with at least more than two different cost functions applied to at least two refinement processes.
   a) In one example, a first refinement process may be invoked with a first cost function. Based on the output of the first refinement process, a second cost function is further applied to the second refinement process.
   b) The above methods may be applied to the template-based-coded blocks.
4. Whether to use multiple refinement process, and/or how to select one or multiple error function and/or how to define the cost function and/or which samples to be involved in the error function may depend on the decoded information of a current block and/or its neighboring (adjacent or non-adjacent) blocks.
   a) In one example, how to select one or multiple error function and/or how to define the cost function may depend on the coding tool applied to current block and/or its neighboring blocks.
      i. In one example, the coding tool is the LIC.
         (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
         (ii) In one example, if MR-SAD/MR-SATD/MR-SSD is used for the template matching cost measure, the linear function used in LIC process may be not used when deriving the reference template.
         (iii) In one example, if MR-SAD/MR-SATD/MR-SSD is used for the bilateral matching cost measure, the linear function used in LIC process may be not used when deriving the reference block.
   b) In one example, it may depend on block dimension, temporal layer, low delay check flag, etc. al.
   c) In one example, it may depend on whether the motion information of current and neighboring block is similar/identical.
   d) In one example, it may depend on reference picture list and/or reference picture information.
      i. In one example, for list X, a first error function (e.g., SAD/SSE) may be used, and for list Y (Y=1−X), a second error function (e.g., MR-SAD/MR-SSE) may be used.
      ii. Alternatively, furthermore, the final cost may be based on the costs of each reference picture list.
5. The above methods may be applied to any coding data refinement process, e.g., for a template-based-coded block, for a bilateral-based-coded block (e.g., DMVR in VVC).

### 2.16. Samples Utilized in Coding Data Refinement for Image/Video Coding

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

In the disclosure, the phrase “motion candidate” may represent a merge motion candidate in a regular/extended merge list indicated by a merge candidate index, or an AMVP motion candidate in regular/extended AMVP list indicated by an AMVP candidate index, or one AMVP motion candidate, or one merge motion candidate.

In the disclosure, a motion candidate is called to be “refined” if the motion information of the candidate is modified according to information signaled from the encoder or derived at the decoder. For example, a motion vector may be refined by DMVR, FRUC, TM merge, TM AMVP, TM GPM, TM CIIP, TM affine, MMVD, GMVD, affine MMVD, BDOF and so on.

In the disclosure, the phrase “coding data refinement” may represent a refinement process in order to derive or refine the signalled/decoded/derived prediction modes, prediction directions, or signalled/decoded/derived motion information, prediction and/or reconstruction samples for a block. In one example, the refinement process may include motion candidate reordering.

In the following discussion, a “template-based-coded” block may refer to a block using a template matching based method in the coding/decoding process to derive or refine coded information, such as template-matching based motion derivation, template-matching based motion list reconstruction, LIC, sign prediction, template-matching based block vector (e.g., used in IBC mode) derivation, DIMD, template-matching based non-inter (e.g., intra) prediction, etc. The template-based-coded method may be combined with any other coding tools, such as MMVD, CIIP, GPM, FRUC, Affine, BDOF, DMVR, OBMC, etc. In yet another example, the “template-based-coded” block may also refer to a block which derives or refines its decoded information based on certain rules using neighboring reconstructed samples (adjacent or non-adjacent), e.g., the DIMD method in 2.27 and the TIMD method 2.29).

In the following discussion, a “bilateral-based-coded” block may refer to a block using a bilateral matching based method in the coding/decoding process to derive or refine coded information, such as bilateral-matching based motion derivation, bilateral-matching based motion list reconstruction, and etc. The bilateral-based-coded method may be combined with any other coding tools, such as MMVD, CIIP, GPM, FRUC, Affine, DMVR, and etc.

W and H are the width and height of current block (e.g., luma block). W*H is the size of current block (e.g., luma block)
1. The error/cost evaluation in the coding data refinement process may depend on both reference samples corresponding to current block (e.g., the reference blocks used in bilateral matching) and reference samples corresponding to a template of current block.
   a) Alternatively, it may depend on both reference samples corresponding to current block and samples in a template of current block.
   b) In one example, the template may be neighboring samples (adjacent or non-adjacent) of current block.
2. Multiple refinement processes may be applied to one block with different templates applied to at least two refinement processes.
   a) In one example, a first refinement process may be invoked with a first template. Based on the output of the first refinement process, a second template is further utilized in the second refinement process.
   b) In one example, the first template may contain more samples compared to the second template.
   c) In one example, the first and second template may contain at least one different sample.
   d) In one example, the first and second refinement process may use different cost/error functions.
3. Whether to use multiple refinement process, and/or how to select one or multiple error function and/or how to define the cost function and/or which samples to be involved in the error function may depend on the decoded information of a current block and/or neighboring (adjacent or non-adjacent) blocks.
   a) In one example, how to select one or multiple error function and/or how to define the cost function may depend on the coding tool applied to current block and/or neighboring blocks.
      i. In one example, the coding tool is the LIC.
         (i) In one example, SSD and mean-removal SSD (MR-SSD) might be selectively utilized according to the LIC flag of the current block.
         a) In one example, the template matching cost measure may be SSD if the LIC flag of the current block is false.
         b) In one example, the template matching cost measure may be MR-SSD if the LIC flag of the current block is true.
         (ii) In one example, if MR-SAD/MR-SATD/MR-SSD is used for the template matching cost measure, the linear function used in LIC process may be not used when deriving the reference template.
         (iii) In one example, if MR-SAD/MR-SATD/MR-SSD is used for the bilateral matching cost measure, the linear function used in LIC process may be not used when deriving the reference block.
   b) In one example, it may depend on block dimension (e.g., W, H), temporal layer, low delay check flag, etc. al.
   c) In one example, it may depend on whether the motion information of current and neighboring block is similar/identical.
   d) In one example, it may depend on reference picture list and/or reference picture information.
      i. In one example, for list X, a first error function (e.g., SAD/SSE) may be used, and for list Y (Y=1−X), a second error function (e.g., MR-SAD/MR-SSE) may be used.
      ii. Alternatively, furthermore, the final cost may be based on the costs of each reference picture list.
4. In one example, LIC may be enabled for reference list X and disabled for reference list Y.
   a) In one example, the final prediction of current block may be weighted average of LIC prediction from reference List X and regular prediction from reference List Y.
5. The above methods may be applied to any coding data refinement process, e.g., for a template-based-coded block, for a bilateral-based-coded block (e.g., DMVR in VVC).

### 2.17. Adaptive Motion Candidate List

It is noted that the terminologies mentioned below are not limited to the specific ones defined in existing standards. Any variance of the coding tool is also applicable. For example, the term “GPM” is used to represent any coding tool that derive two sets of motion information and use the derived information and the splitting pattern to get the final prediction, e.g., TPM is also treated as GPM.

Note that the proposed methods may be applied to merge candidate list construction process for inter coded blocks (e.g., translational motion), affine coded blocks, TM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

W and H are the width and height of current block (e.g., luma block).
1. The template/bilateral matching cost C may be calculated to be f(C) before it is used to be compared with another template matching cost.
   a. In one example, f(C)=w*C, wherein w is denoted as a cost factor.
   b. In one example, f(C)=w*C+u.
   c. In one example, f(C)=Shift((w*C), s).
   d. In one example, w and/or u and/or s are integers.
   e. In one example, a first template matching cost for a first motion candidate may be multiplied by a cost factor before it is compared with a second template matching cost for a second motion candidate.
   f. In one example, it is proposed the cost factor for a motion candidate may depend on the position of the candidate before reordering.
      i. In one example, the motion candidate at the i-th position may be assigned with a smaller cost factor than the cost factor of the motion candidate at the j-th position, wherein j>i, e.g. j=i+1.
         (i) In one example, the cost factor of the motion candidate at the i-th position is 4 and the cost factor of the motion candidate at the j-th position is 5.
         (ii) In one example, the cost factor of the motion candidate at the i-th position is 1 and the cost factor of the motion candidate at the j-th position is 5.
      ii. In one example, the motion candidate at the i-th position may be assigned with a larger cost factor than the cost factor of the motion candidate at the j-th position, wherein j>i, e.g. j=i+1.
      iii. In one example, the motion candidates in the p-th group (e.g. including M motion candidates) may be assigned with a smaller cost factor than the cost factor of the motion candidates in the q-th group (e.g. including N motion candidates), wherein q>p, e.g. q=p+1.
         (i) Alternatively, the motion candidates in the p-th group (e.g. including M motion candidates) may be assigned with a larger cost factor than the cost factor of the motion candidates in the q-th group (e.g. including N motion candidates), wherein q>p, e.g. q=p+1.
         (ii) In one example, M may be equal to N. For example, M=N=2.
         (iii) In one example, M may be not equal to N. For example, M=2, N=3.
         (iv) In one example, the cost factor of the motion candidates at the p-th group is 4 and the cost factor of the motion candidates at the q-th group is 5.
         (v) In one example, the cost factor of the motion candidates at the p-th group is 1 and the cost factor of the motion candidates at the q-th group is 5.
      iv. In one example, the cost factor may be not applied to subblock motion candidates.
      v. In one example, the cost factor may be not applied to affine motion candidates.
      vi. In one example, the cost factor may be not applied to SbTMVP motion candidates.
   g. In one example, the cost factor of the motion candidates in one group/position may be adaptive.
      i. In one example, the cost factor of the motion candidates in one group/position may be dependent on the coding mode of neighbor coded blocks.
         (i) In one example, the cost factor of SbTMVP merge candidate may be dependent on the number of neighbor affine coded blocks.
         (ii) In one example, the neighbor coded blocks may include at least one of the five spatial neighbor blocks (shown in FIG. 4) and/or the temporal neighbor block(s) (shown in FIG. 7).
         (iii) In one example, the cost factor of SbTMVP merge candidate may be 0.2 when the number of spatial neighbor affine coded blocks (shown in FIG. 4) is 0; the cost factor of SbTMVP merge candidate may be 0.5 when the number of spatial neighbor affine coded blocks (shown in FIG. 4) is 1; the cost factor of SbTMVP merge candidate may be 0.8 when the number of spatial neighbor affine coded blocks (shown in FIG. 4) is 2; otherwise, the cost factor of SbTMVP merge candidate may be 1 (which means keeping unchanged).
         (iv) In one example, the cost factor of SbTMVP merge candidate may be 0.2 when the number of spatial neighbor affine coded blocks (shown in FIG. 4) is 0; the cost factor of SbTMVP merge candidate may be 0.5 when the number of spatial neighbor affine coded blocks (shown in FIG. 4) is 1; the cost factor of SbTMVP merge candidate may be 0.8 when the number of spatial neighbor affine coded blocks (shown in FIG. 4) is larger than or equal to 2.
         (v) In one example, the cost factor of SbTMVP merge candidate may be 2 when the number of spatial neighbor affine coded blocks (shown in FIG. 4) is 0; the cost factor of SbTMVP merge candidate may be 5 when the number of spatial neighbor affine coded blocks (shown in FIG. 4) is 1; the cost factor of SbTMVP merge candidate may be 8 when the number of spatial neighbor affine coded blocks (shown in FIG. 4) is 2; otherwise, the cost factor of SbTMVP merge candidate may be 10 (wherein the cost factor of affine merge candidates is 10).
         (vi) In one example, the cost factor of SbTMVP merge candidate may be 2 when the number of spatial neighbor affine coded blocks (shown in FIG. 4) is 0; the cost factor of SbTMVP merge candidate may be 5 when the number of spatial neighbor affine coded blocks (shown in FIG. 4) is 1; the cost factor of SbTMVP merge candidate may be 8 when the number of spatial neighbor affine coded blocks (shown in FIG. 4) is larger than or equal to 2 (wherein the cost factor of affine merge candidates is 10).
2. The subgroup size may be different for different coding modes.
   a. The coding modes may include regular/subblock/TM merge modes.
      i. The subgroup size may be K1 (e.g., K1=5) for regular merge mode.
      ii. The subgroup size may be K2 (e.g., K2=3) for subblock merge mode.
      iii. The subgroup size may be K3 (e.g., K3=3) for TM merge mode.
   b. The subgroup size may be larger than or equal to the maximum number of subblock merge candidates defined in sps/picture/slice header (which means reordering whole list together) for subblock merge mode.
   c. The subgroup size may be larger than or equal to the maximum number of TM merge candidates defined in sps/picture/slice header (which means reordering whole list together) for TM merge mode.
   d. The subgroup size for a coding mode may be dependent on the maximum number of motion candidates in the coding mode.
   e. The subgroup size for subblock merge mode may be adaptive dependent on the number of neighbor affine coded blocks.
      i. In one example, the neighbor coded blocks may include at least one of the five spatial neighbor blocks (shown in FIG. 4) and/or the temporal neighbor block(s) (shown in FIG. 7).
      ii. In one example, the subgroup size for subblock merge mode may be 3 when the number of spatial neighbor affine coded blocks (shown in FIG. 4) is 0 or 1; the subgroup size for subblock merge mode may be 5 when the number of spatial neighbor affine coded blocks (shown in FIG. 4) is larger than 1;
3. The template size may be different for different coding modes.
   a. The coding modes may include regular/subblock/TM merge modes.
      i. The template size may be K1 (e.g., K1=1) for regular merge mode.
      ii. The template size may be K2 (e.g., K2=1, 2, or 4) for subblock merge mode.
      iii. The template size may be K3 (e.g., K3=1) for TM merge mode.
4. Whether to and/or how to reorder the motion candidates may depend on the coding modes of neighbor coded blocks.
   a. In one example, the neighbor coded blocks may include at least one of the five spatial neighbor blocks (shown in FIG. 4) and/or the temporal neighbor block(s) (shown in FIG. 7).
   b. The regular merge candidates may be reordered when the number of spatial neighbor coded blocks with regular merge mode (shown in FIG. 4) is larger than or equal to K (e.g., K=1).
   c. The subblock merge candidates may be reordered when the number of spatial neighbor coded blocks with subblock merge mode (shown in FIG. 4) is larger than or equal to K (e.g., K=1).
   d. The affine merge candidates may be reordered when the number of spatial neighbor coded blocks with affine merge mode (shown in FIG. 4) is larger than or equal to K (e.g., K=1).
   e. The SbTMVP merge candidates may be reordered when the number of spatial neighbor coded blocks with affine merge mode (shown in FIG. 4) is larger than or equal to K (e.g., K=1, 2, or 3).
   f. The TM merge candidates may be reordered when the number of spatial neighbor coded blocks with TM merge mode (shown in FIG. 4) is larger than or equal to K (e.g., K=1).
5. The HMVP motion candidates in the HMVP table may be reordered based on template/bilateral matching etc. al.
   a. In one example, a HMVP motion candidate is assigned with a cost, the HMVP candidates are adaptively reordered in a descending order of costs of HMVP candidates.
      i. In one example, the cost of a HMVP candidate may be a template matching cost.
   b. In one example, HMVP motion candidates may be reordered before coding a block.
      i. In one example, HMVP motion candidates may be reordered before coding an inter-coded block.
   c. In one example, HMVP motion candidates may be reordered in different ways depending on coding information of the current block and/or neighbouring blocks.

### General Claims

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
7. Whether to and/or how to apply the disclosed methods above may be signalled at PB/TB/CB/PU/TU/CU/VPDU/CTU/CTU row/slice/tile/sub-picture/other kinds of region contains more than one sample or pixel.
8. Whether to and/or how to apply the disclosed methods above may be dependent on coded information, such as coding mode, block size, colour format, single/dual tree partitioning, colour component, slice/picture type.

### 2.18. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList.

W and H are the width and height of current block (e.g., luma block).
1. It is proposed that for a GPM coded block, the coded candidate index may be corresponding to a candidate with a different candidate index in the candidate list for GPM coded blocks.
   a. Alternatively, furthermore, the candidate list constructed for the GPM coded block may be reordered before being used and the coded index is corresponding to the reordered candidate list.
   b. Alternatively, furthermore, for a first type of GPM coded block, the candidate list may be reordered, and for a second type of GPM coded block, the candidate list may not be reordered.
      i. In one example, the first type is template-based GPM coded block.
      ii. In one example, the second type is the MMVD-based GPM coded block (e.g., GMVD)
   c. Alternatively, furthermore, for a first type of GPM coded block, the candidate list may be reordered with a first rule, and for a second type of GPM coded block, the candidate list may be reordered with a second rule.
   d. The reordering method for a GPM coded block may be the same as that for a non-GPM coded block.
      i. The reordering method for a GPM coded block may be different from that for a non-GPM coded block.
2. It is proposed that for a GPM coded block, the coded candidate index may be corresponding to a candidate from a refined candidate list for GPM coded blocks.
   a. Alternatively, furthermore, the candidate list constructed for the GPM coded block may be refined firstly before being used and the coded index is corresponding to the refined candidate list.
   b. Alternatively, furthermore, for a first type of GPM coded block, the candidate list may be refined, and for a second type of GPM coded block, the candidate list may not be refined.
      i. In one example, the first type is template-based GPM coded block.
      ii. In one example, the second type is the MMVD-based GPM coded block (e.g., GMVD)
   c. Alternatively, furthermore, for a first type of GPM coded block, the candidate list may be refined with a first rule, and for a second type of GPM coded block, the candidate list may be refined with a second rule.
   d. The refined method for a GPM coded block may be the same as that for a non-GPM coded block
      i. The refined method for a GPM coded block may be different from that for a non-GPM coded block
3. In one example, the GPM candidates may be divided into subgroups. Whether to and/or how to reorder the GPM candidates may depend on the subgroup of the GPM candidates.
   a. In one example, only the first subgroup can be reordered.
   b. In one example, the last subgroup can not be reordered.
   c. In one example, the last subgroup can not be reordered. But if the last subgroup also is the first subgroup, it can be reordered.
   d. Different subgroups may be reordered separately.
   e. Two candidates in different subgroups cannot be compared and/or reordered.
   f. A first candidate in a first subgroup must be put ahead of a second candidate in a second subgroup after reordering if the first subgroup is ahead of a second subgroup.
4. In one example, the GPM candidates which are not included in the reordering process may be treated in specified way.
   a. In one example, for the candidates not to be reordered, they will be arranged in the merge candidate list according to the initial order.
   b. In one example, candidates not to be reordered may be put behind the candidates to be reordered.
   c. In one example, candidates not to be reordered may be put before the candidates to be reordered.
5. A GPM candidate list to be reordered may refer to
   Case 1: a first candidate list which is prepared for the two GPM partitions and is used to derive the individual GPM candidate lists for each GPM partitions.
   Case 2: a second GPM candidate list which is used for each GPM partition. Usually the second GPM candidate is derived from the first candidate list.
   a. In one example, in case 1, the reordering method may be the same to that used for a regular merge candidate list.
   b. In one example, in case 1, the template matching approach in the reordering method may be conducted in a bi-prediction way if the corresponding candidate is bi-predicted.
   c. In one example, in case 2, the template matching approach in the reordering method cannot be conducted in a bi-prediction way.
   d. In one example, in case 2, the reordering method may be the same for all GPM partitions.
   e. In one example, in case 2, the reordering method may be different for different GPM partitions.
6. In above examples, the GPM coded block may be a GPM coded block with merge mode, a GPM coded block with AMVP mode.
   a. Alternatively, furthermore, the merge candidate mentioned above may be replaced by an AMVP candidate

### General Claims

7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
8. Whether to and/or how to apply the disclosed methods above may be signalled at PB/TB/CB/PU/TU/CU/VPDU/CTU/CTU row/slice/tile/sub-picture/other kinds of region contains more than one sample or pixel.
9. Whether to and/or how to apply the disclosed methods above may be dependent on coded information, such as coding mode, block size, colour format, single/dual tree partitioning, colour component, slice/picture type.

### 2.19. Adaptive GPM Candidate List

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM is also treated as GPM.

Note that the proposed methods may be applied to merge candidate list construction process for inter coded blocks (e.g., translational motion), affine coded blocks, TM coded blocks, GPM coded blocks, or IBC coded blocks; or other motion candidate list construction process (e.g., normal AMVP list; affine AMVP list; IBC AMVP list; HMVP table).

The cost function excepting the template matching cost is also applicable for motion candidate reordering.

Hereinafter, template is a set of reconstructed/prediction samples adjacently or non-adjacently neighboring to the current block. Reference samples of a template (i.e. reference template) are mapping of the template in a reference picture depend on a motion information of the current block. “above template” indicates a template constructed from a set of reconstructed/prediction samples above adjacently or non-adjacently neighboring to the current block and its reference template. “left template” indicates a template constructed from a set of reconstructed/prediction samples left adjacently or non-adjacently neighboring to the current block and its reference template. “above and left template” includes both above template and left template.

In the following, in one example, a GPM candidate list where GPM candidates are directly derived from regular merge list (before or without template matching based motion refinement) is called OGPMList; a refined GPM candidate list where GPM candidates are refined by a first refining method such as template matching using the above template is called AGPMList; a refined GPM candidate list where GPM candidates are refined by a second refining method such as template matching using the left template is called LGPMList; a refined GPM candidate list where GPM candidates are refined by a third refining method such as template matching using the left and above template is called LAGPMList;

Regarding the type of GPM candidates in the original GPM candidate list, the GPM candidates derived in the first step of GPM candidate list construction process in section 2.29 are called GPM-parity-based candidates; The GPM candidates derived in the second step of GPM candidate list construction process in section 2.29 are called GPM-anti-parity-based candidates; The GPM candidates derived in the third step of GPM candidate list construction process in section 2.29 are called GPM-filled candidates.

W and H are the width and height of current block (e.g., luma block).
1. In one example, if the coding mode is GPM, the merge candidates may be reordered.
   a. In one example, the merge candidates in the OGPMList may be reordered.
      i. In one example, at least two merge candidates in OGPMList may be reordered.
      ii. In one example, at least one type of template may be used for OGPMList reordering.
      iii. Alternatively, the merge candidates in the OGPMList may NOT be reordered.
      iv. In one example, a first type of template may only comprise neighboring samples left to the current block.
      v. In one example, a second type of template may only comprise neighboring samples above to the current block.
      vi. In one example, a third type of template may comprise neighboring samples left and above to the current block.
      vii. The reordering process may be invoked after the parsing process but before the MV reconstruction process.
   b. In one example, the merge candidates in the AGPMList may be reordered.
      i. In one example, at least two merge candidates in AGPMList may be reordered.
      ii. In one example, at least one type of template may be used for AGPMList reordering.
      iii. In one example, a first type of template may only comprise neighboring samples above to the current block.
      iv. In one example, a second type of template may comprise neighboring samples left and above to the current block.
   c. In one example, the merge candidates in the LGPMList may be reordered.
      i. In one example, at least two merge candidates in LGPMList may be reordered.
      ii. In one example, at least one type of template may be used for LGPMList reordering.
      iii. In one example, a first type of template may only comprise neighboring samples left to the current block.
      iv. In one example, a second type of template may comprise neighboring samples left and above to the current block.
   d. In one example, the merge candidates in the LAGPMList may be reordered.
      i. In one example, at least two merge candidates in LAGPMList may be reordered.
      ii. In one example, at least one type of template may be used for LAGPMList reordering.
      iii. In one example, a first type of the template may only comprise neighboring samples left to the current block.
      iv. In one example, a second type of the template may only comprise neighboring samples above to the current block.
      v. In one example, a third type of the template may comprise neighboring samples left and above to the current block.
   e. In one example, whether to and/or how to reorder merge candidates in a GPM list may be dependent on the coding information.
      i. In one example, whether to reorder merge candidates in a GPM list may be dependent on whether a template matching based motion refinement is applied to a GPM partition or two GPM partitions (i.e. a GPM coded CU).
         (i) For example, if the motion of a GPM partition or two GPM partitions (i.e. a GPM coded CU) is NOT refined based on template matching (e.g., the template matching flag is equal to false), the corresponding GPM list may NOT be reordered.
         a) For example, if a GPM partition is coded using a merge candidate in OGPMList (e.g., no motion refinement is applied), then merge candidates in OGPMList may NOT be reordered.
         (ii) For example, if the motion of a GPM partition or two GPM partitions (i.e. a GPM coded CU) is refined based on template matching (e.g., the template matching flag is equal to true), the corresponding GPM list may be reordered.
         a) For example, if a GPM partition is coded using a merge candidate in AGPMList (e.g., template matching motion refinement method using above template is applied), then merge candidates in AGPMList may be reordered.
         b) For example, if a GPM partition is coded using a merge candidate in LGPMList (e.g., template matching motion refinement method using left template is applied), then merge candidates in LGPMList may be reordered.
         c) For example, if a GPM partition is coded using a merge candidate in LAGPMList (e.g., template matching motion refinement method using left and above template is applied), then merge candidates in LAGPMList may be reordered.
      ii. In one example, how to reorder merge candidates in a GPM list may be dependent on the GPM partition information (e.g., partition mode, partition angle, partition distance, etc.).
         (i) For example, above template may be used for the merge candidates reordering in case that the current GPM partition is split by a first partition angle (or partition mode, or partition distance, etc.).
         (ii) For example, left template may be used for the merge candidates reordering in case that the current GPM partition is split by a second partition angle (or partition mode, or partition distance, etc.).
         (iii) For example, left and above template may be used for the merge candidates reordering in case that the current GPM partition is split by a third partition angle (or partition mode, or partition distance, etc.).
         (iv) For example, a type of template may be specified corresponding to the first/second/third partition angle (or partition mode, or partition distance, etc.).
         (v) For example, at least one look-up table (i.e., mapping table) is used to map what specified partition angles (or partition modes, or partition distances, etc.) corresponding to what type of template (e.g., above template, left template, or above and left template.)
   f. In one example, the merge candidates in the OGPMList may be not reordered and the merge candidates in the AGPMList and/or LGPMList and/or LAGPMList may be reordered.
2. The merge candidates can be adaptively rearranged in the final GPM candidate list according to one or some criterions.
   a. In one example, the GPM candidate list may be
      i. OGPMList
      ii. AGPMList
      iii. LGPMLIst
      iv. LAGPMList
   b. The GPM candidates may be divided into several subgroups.
      i. For example, the number of GPM candidates (such as X=3 or 5 or any other integer values) in a subgroup may be pre-defined.
   c. In one example, partial or full process of current GPM candidate list construction process is firstly invoked, followed by the reordering of candidates in the GPM list.
      i. Alternatively, candidates in a first subgroup may be reordered and they should be added before those candidates in a second subgroup wherein the first subgroup is added before the second subgroup.
      ii. The construction process may include a pruning method.
   d. In one example, the merge candidates may be adaptively rearranged before retrieving the merge candidates.
      i. In one example, the procedure of arranging merge candidates adaptively may be processed before obtaining the merge candidate to be used in the motion compensation process.
   e. The criterion may be based on template matching cost.
      i. In one example, the cost function between current template and reference template may be
         (i) SAD/MR-SAD
         (ii) SATD/MR-SATD
         (iii) SSD/MR-SSD
         (iv) SSE/MR-SSE
         (v) Weighted SAD/weighted MR-SAD
         (vi) Weighted SATD/weighted MR-SATD
         (vii) Weighted SSD/weighted MR-SSD
         (viii) Weighted SSE/weighted MR-SSE
         (ix) Gradient information
3. When deriving the two motions for two geometric partitions, the process may be
   a. In one example, if TM is not applied to one partition, the motion can be derived according to the signalled merge index from the OGPMList/reordered OGPMList.
   b. In one example, if TM is applied to one partition, the motion can be derived according to the signalled merge index from the AGPMList/reordered AGPMList or LGPMList/reordered LGPMLIst or LAGPMList/reordered LAGPMLIst dependent on partition angle and partition index.
      i. In one example, if partition angle is X (e.g., 0), for the first partition, AGPMList/reordered AGPMList will be used; for the second partition, LAGPMList/reordered LAGPMLIst will be used.
   c. In one example, if TM is applied to one partition, the motion can be derived according to the signalled merge index from the AGPMList/reordered AGPMList.
   d. In one example, if TM is applied to one partition, the motion can be derived according to the signalled merge index from the LGPMList/reordered LGPMLIst.
   e. In one example, if TM is applied to one partition, the motion can be derived according to the signalled merge index from the LAGPMList/reordered LAGPMLIst
4. Whether to and/or how to reorder the GPM candidates may depend on the category of the GPM candidates.
   a. In one example, only GPM-parity-based candidates can be reordered.
   b. In one example, only GPM-parity-based and GPM-anti-parity-based candidates can be reordered.
   c. In one example, the GPM-filled candidates may not be reordered.
   d. In one example, two candidates in different GPM lists cannot be compared and/or reordered.
   e. In one example, only the first N GPM candidates can be reordered.
      i. In one example, N is set equal to 5.
5. In above examples, the GPM coded block may be a GPM coded block with merge mode, a GPM coded block with AMVP mode.
   a. Alternatively, furthermore, the merge candidate mentioned above may be replaced by an AMVP candidate.

### General Claims

6. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
7. Whether to and/or how to apply the disclosed methods above may be signalled at PB/TB/CB/PU/TU/CU/VPDU/CTU/CTU row/slice/tile/sub-picture/other kinds of region containing more than one samples or pixels.
8. Whether to and/or how to apply the disclosed methods above may be dependent on coded information, such as coding mode, block size, GPM partition information, colour format, single/dual tree partitioning, colour component, slice/picture type.

### 2.20. Hash Based Motion Estimation for Screen Content Coding

The VTM reference software uses hash-based motion estimation to handle the sometimes large and irregular motion in screen content. For each reference picture, hash tables corresponding to 4×4 to 64×64 block sizes are generated using a bottom-up approach as follows:
For each 2×2 block, the block hash value is calculated directly from the original sample values (luma samples are used if 4:2:0 chroma format and both luma and chroma sample values are used if 4:4:4 chroma format). The cyclic redundancy check (CRC) value is used as the hash value.
For 4×4, 8×8, 16×16, 32×32 and 64×64 blocks, the hash value of the current block is the CRC value calculated from the CRC values of its four subblocks.

To enable efficient search for matched blocks, the structure of inverted index is used, where hash values are used as to index into a table, and the table entries contain all the blocks with the same hash value as the corresponding table index. The blocks corresponding a given table index are stored as a linked list. Two CRC values, one 16-bit hash and the other 24-bit hash, are calculated for each block. The two hash values are calculated in a similar way but using different CRC truncated polynomials. The first 16-bit CRC value is used as the inverted index. The second 24-bit hash value is stored together with the blocks to resolve hash conflicts in the case more than one matching blocks are found. To reduce the length of the hash table, the hash values of all “simple” blocks (defined as a block with only one sample value in each row or column) are excluded from the hash table.

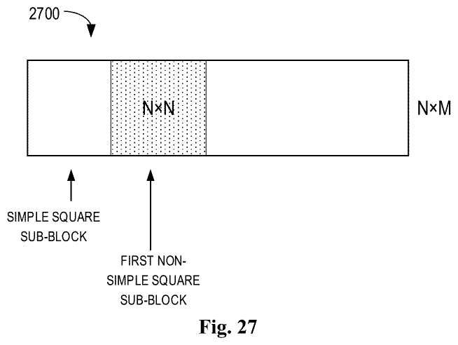

In motion estimation, if the current block is a square block (except for 128×128 blocks), its hash values are calculated. Then, the encoder queries the corresponding hash table. If hash match is found, the matched block is used as the reference. If the current block is a rectangle block of size N×M (and without loss of generality assume M>N), it will be divided into several non-overlapping square subblocks of size N×N. FIG. 27 illustrates an example diagram 2700 showing motion estimation for rectangular block with hash values for square subblocks. The encoder will find the first non-simple square subblock and calculate its hash values. Encoder queries the hash values of this N×N square subblock on the hash table corresponding to N×N block size. The one or more matched reference blocks are considered reference block candidates. For each matched reference block candidate, encoder will continue to check whether the hash values of the remaining square subblocks (namely the white region that follows the first non-simple square subblock depicted in FIG. 27) are equal to those of the square subblocks adjacent to that reference block candidate. If the hash values of all square subblocks are matched, the reference block candidate will be regarded as a valid reference block.

For inter coding, the hash-based motion search is performed before testing all coding modes. In addition, encoder will reuse the MVs of the hash mode as the starting point candidates in the normal motion estimation process. If the hash-based motion vector exists, which indicates that the block most likely contains screen content, fractional motion estimation is skipped.

To accelerate the encoder, coding modes other than the skip and merge part of ETM_MERGE_SKIP, ETM_AFFINE, and ETM_MERGE_GPM modes and finer-granularity block splitting are skipped if all of the following conditions are satisfied:
Current block size is 64×64, 128×64 or 64×128.
An identical reference block is found in a reference picture.
The QP of reference picture is not larger than that of current picture.
   2.21. Luma Mapping with Chroma Scaling (LMCS)

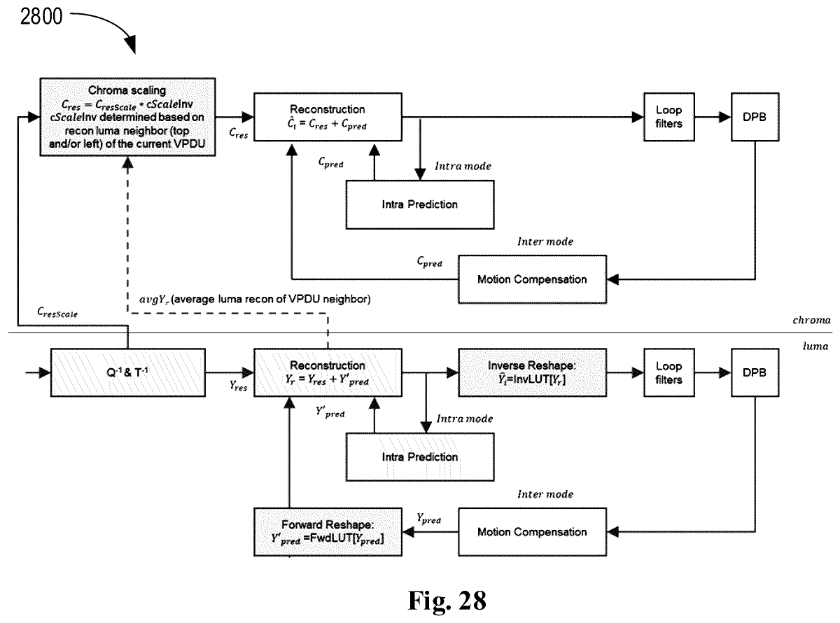

In VVC, a coding tool called the luma mapping with chroma scaling (LMCS) is added as a new processing block before the loop filters. LMCS has two main components: 1) in-loop mapping of the luma component based on adaptive piecewise linear models; 2) for the chroma components, luma-dependent chroma residual scaling is applied. FIG. 28 illustrates example luma mapping with chroma scaling architecture 2800. FIG. 28 shows the LMCS architecture from decoder's perspective. The light-blue shaded blocks in FIG. 28 indicate where the processing is applied in the mapped domain; and these include the inverse quantization, inverse transform, luma intra prediction and adding of the luma prediction together with the luma residual. The unshaded blocks in FIG. 28 indicate where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. The light-yellow shaded blocks in FIG. 28 are the new LMCS functional blocks, including forward and inverse mapping of the luma signal and a luma-dependent chroma scaling process. Like most other tools in VVC, LMCS can be enabled/disabled at the sequence level using an SPS flag.

2.21.1 Luma Mapping with Piecewise Linear Model

The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signalled using a piecewise linear model with 16 equal pieces. InvMap function does not need to be signalled and is instead derived from the FwdMap function.

The luma mapping model is signalled in the adaptation parameter set (APS) syntax structure with aps_params_type set equal to 1 (LMCS_APS). Up to 4 LMCS APS's can be used in a coded video sequence. Only 1 LMCS APS can be used for a picture. The luma mapping model is signalled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signalled number of codewords is used to calculate the scaling factor and adjust the mapping function accordingly for that piece. At the slice level, an LMCS enable flag is signalled to indicate if the LMCS process as depicted in FIG. 28 is applied to the current slice. If LMCS is enabled for the current slice, an aps_id is signalled in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ].

The InputPivot[ ] and MappedPivot[ ] are computed as follows (assuming 10-bit video):
1) OrgCW=64
2) For i=0:16, InputPivot[i]=i*OrgCW
3) For i=0:16, MappedPivot[i] is calculated as follows:
   MappedPivot[0]=0;
   for(i=0; i<16; i++)
      MappedPivot[i+1]=MappedPivot[i]+SignalledCW[i]
         where SignalledCW[i] is the signalled number of codewords for the i-th piece.

As shown in FIG. 28, for an inter-coded block, motion compensated prediction is performed in the mapped domain. In other words, after the motion-compensated prediction block Y_{pred} is calculated based on the reference signals in the DPB, the FwdMap function is applied to map the luma prediction block in the original domain to the mapped domain, Y′_{pred}=FwdMap(Y_{Pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Ŷᵣ=InvMap(Yᵣ)). The InvMap function is applied to both intra- and inter-coded luma blocks.

The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT [Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces). Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$FwdMap ( {Y}_{p r e d} ) = ( ( b 2 - b 1 ) / ( a 2 - a 1 ) ) * ( {Y}_{p r e d} - a 1 ) + b 1$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, VVC imposes a bistream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e. MappedPivot[i+1]>>(BitDepth_{Y}−5) shall not be equal to MappedPivot[i]>>(BitDepth_{Y}−5). Thanks to such bitstream constraint, the InvMap function can also be carried out using a simple right bit-shift by 5 bits (which corresponds 32 equal-sized pieces) in order to figure out the piece to which the sample value belongs.

### 2.21.2 Luma-Dependent Chroma Residual Scaling

Chroma residual scaling is designed to compensate for the interaction between the luma signal and its corresponding chroma signals. Whether chroma residual scaling is enabled or not is also signalled at the slice level. If luma mapping is enabled, an additional flag is signalled to indicate if luma-dependent chroma residual scaling is enabled or not. When luma mapping is not used, luma-dependent chroma residual scaling is disabled. Further, luma-dependent chroma residual scaling is always disabled for the chroma blocks whose area is less than or equal to 4.

Chroma residual scaling depends on the average value of top and/or left reconstructed neighbouring luma samples of the current VPDU. If the current CU is inter 128×128, inter 128×64 and inter 64×128, then the chroma residual scaling factor derived for the CU associated with the first VPDU is used for all chroma transform blocks in that CU. Denote avgYr as the average of the reconstructed neighbouring luma samples (see FIG. 28). The value of C_{scaleInv} is computed in the following steps:
1) Find the index Y_{Idx} of the piecewise linear model to which avgYr belongs based on the InvMap function.
2) C_{scaleInv}=cScaleInv[Y_{Idx}], where cScaleInv[ ] is a 16-piece LUT pre-computed based on the value of SignalledCW[i] and a offset value signalled in APS for chroma residual scaling process.

Unlike luma mapping, which is performed on the sample basis, C_{scaleInv} is a constant value for the entire chroma block. With C_{scaleInv}, chroma residual scaling is applied as follows:

$$\begin{matrix}Encoder side : {C}_{Res S c a l e} = {C}_{Res} * {C}_{S c a l e} = {C}_{Res} / {C}_{Scale Inv} \\ Decoder side : {C}_{Res} = {C}_{Res S c a l e} / {C}_{S c a l e} = {C}_{Res S c a l e} * {C}_{Scale Inv}\end{matrix}$$

### 2.21.3 Encoder-Side LMCS Parameter Estimation

A non-normative reference implementation is provided in the VTM encoder to estimate the LMCS model parameters. Because VTM anchors handle SDR, HDR PQ and HDR HLG differently, the reference algorithm in VTM13 is designed differently for SDR, HDR PQ and HDR HLG sequences. For SDR and HDR HLG sequences, the encoder algorithm is based on local luma variance and optimized for PSNR metrics. For HDR PQ sequences, the encoder algorithm is based on luma values and optimized for wPSNR (weighted PSNR) metrics.

2.22. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicate the pre-defined offset from the starting point. FIG. 29 illustrates a diagram 2900 of an example of MMVD search point. As shown in FIG. 29, an offset is added to either horizontal component or vertical component of a starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 3 specifies the sign of MV offset added to the list0 MV component of starting MV and the sign for the list1 MV has opposite value. Otherwise, if the difference of POC in list 1 is greater than list 0, the sign in Table 3 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 6. If the POC difference of L1 is greater than L0, the MVD for list 0 is scaled in the same way. If the starting MV is uni-predicted, the MVD is added to the available MV.

MMVD is also known as Ultimate Motion Vector Expression (UMVE).

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.23. Triangle Partition for Inter Prediction

In VVC, a triangle partition mode (TPM) is supported for inter prediction. The triangle partition mode is only applied to CUs that are 8×8 or larger. The triangle partition mode is signalled using a CU-level flag as one kind of merge mode, with other merge modes including the regular merge mode, the MMVD mode, the CIIP mode and the subblock merge mode.

When this mode is used, a CU is split evenly into two triangle-shaped partitions, using either the diagonal split or the anti-diagonal split (FIG. 30). In the example of triangle partition based inter prediction shown in FIG. 30, a CU 3010 is split using the diagonal split with triangleDir set to be equal to 0, and a CU 3020 is split using the anti-diagonal split with triangleDir set to be equal to 1. Each triangle partition in the CU is inter-predicted using its own motion; only uni-prediction is allowed for each partition, that is, each partition has one motion vector and one reference index. The uni-prediction motion constraint is applied to ensure that same as the conventional bi-prediction, only two motion compensated prediction are needed for each CU. The uni-prediction motion for each partition is derived using the process described in section 2.23.1.

If triangle partition mode is used for the current CU, then a flag indicating the direction of the triangle partition (diagonal or anti-diagonal), and two merge indices (one for each partition) are further signalled. The number of maximum TPM candidate size is signalled explicitly at slice level and specifies syntax binarization for TMP merge indices. After predicting each of the triangle partitions, the sample values along the diagonal or anti-diagonal edge are adjusted using a blending processing with adaptive weights. This is the prediction signal for the whole CU, and transform and quantization process will be applied to the whole CU as in other prediction modes. Finally, the motion field of a CU predicted using the triangle partition mode is stored as in 2.23.3.

The triangle partition mode is not used in combination with SBT, that is, when the signalled triangle mode is equal to 1, the cu_sbt_flag is inferred to be 0 without signalling.

### 2.23.1 Uni-Prediction Candidate List Construction

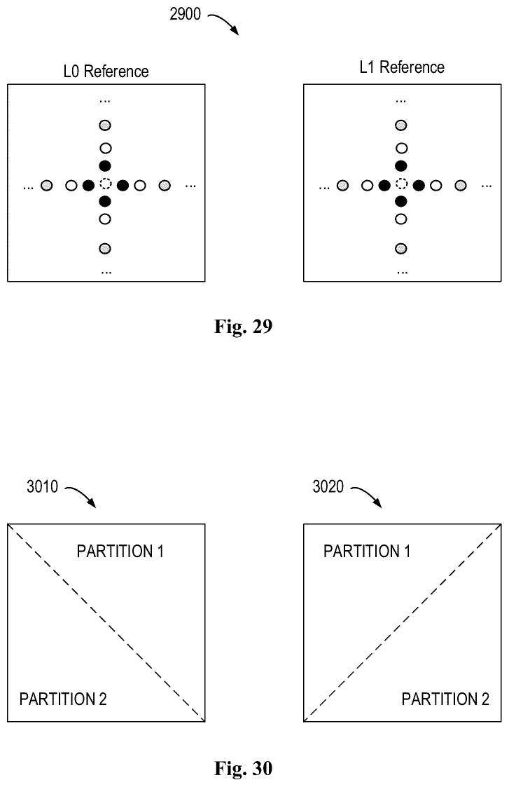

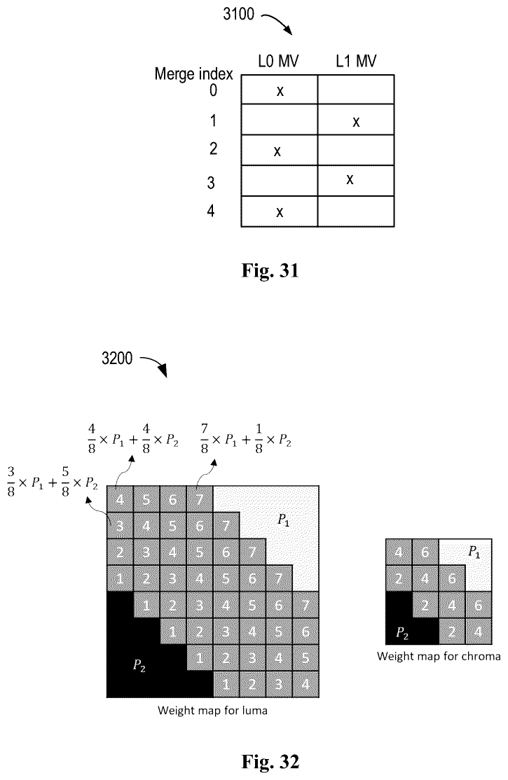

The uni-prediction candidate list is derived directly from the merge candidate list constructed according to the extended merge prediction process in section 2.1. Denote n as the index of the uni-prediction motion in the triangle uni-prediction candidate list. The LX motion vector of the n-th extended merge candidate, with X equal to the parity of n, is used as the n-th uni-prediction motion vector for triangle partition mode. FIG. 31 illustrates a diagram 3100 of uni-prediction MV selection for triangle partition mode. These motion vectors are marked with “x” in FIG. 31. In case a corresponding LX motion vector of the n-the extended merge candidate does not exist, the L(1−X) motion vector of the same candidate is used instead as the uni-prediction motion vector for triangle partition mode.

### 2.23.2 Blending Along the Triangle Partition Edge

After predicting each triangle partition using its own motion, blending is applied to the two prediction signals to derive samples around the diagonal or anti-diagonal edge. FIG. 32 illustrates a diagram 3200 of weights used in the blending process. The following weights are used in the blending process:
7/8, 6/8, 5/8, 4/8, 3/8, 2/8, 1/8} for luma and {6/8, 4/8, 2/8} for chroma, as shown in FIG. 32.
   2.23.3 Motion field storage

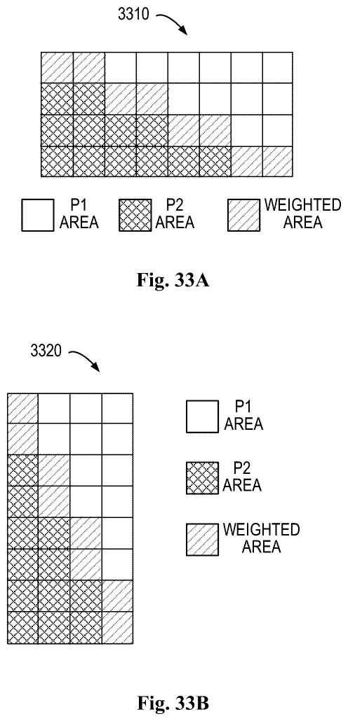

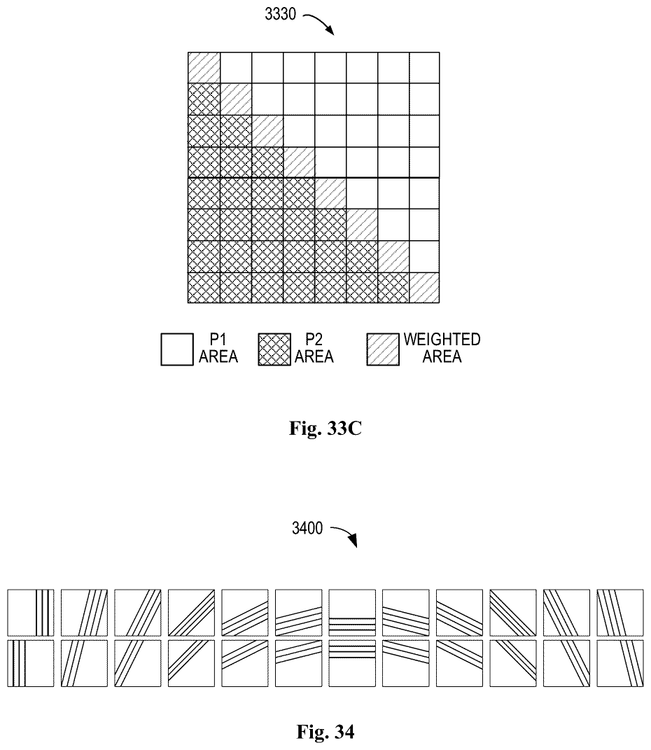

FIGS. 33A-33C illustrate three example MV storage areas for triangleDir equal to 0, where FIG. 33A shows a 32×16 block 3310, FIG. 33B shows a 16×32 block 3320, and FIG. 33C shows a 32×32 block 3330. The motion vectors (Mv1 and Mv2 in FIGS. 33A-33C) of the triangular prediction units are stored in 4×4 grids. For each 4×4 grid, either uni-prediction or bi-prediction motion vector is stored depending on the position of the 4×4 grid in the CU. As shown in FIGS. 33A-33C, uni-prediction motion vector, either Mv1 or Mv2, is stored for the 4×4 grid located in the non-weighted area (that is, not located at the diagonal edge). On the other hand, a bi-prediction motion vector is stored for the 4×4 grid located in the weighted area. The bi-prediction motion vector is derived from Mv1 and Mv2 according to the following rules:
1) If Mv1 and Mv2 are from different reference picture lists (one from L0 and the other from L1), then Mv1 and Mv2 are simply combined to form the bi-prediction motion vector.
2) Otherwise, if Mv1 and Mv2 are from the same list, only uni-prediction motion Mv2 is stored.
   2.23.4 Motion Vector Storing Process for Triangle Merge Mode (Alternative description)

The variables numSbX and numSbY specifying the number of 4×4 blocks in the current coding block in horizontal and vertical direction are set equal to numSbX=cbWidth>>2 and numSbY=cbHeight>>2.

Where cbWidth and cbHeight specifying the width and the height of the current coding block in luma samples,

The variable minSb is set equal to min(numSbX, numSbY)−1.

The variable cbRatio is derived as follows:

$$cb Ratio = ( cb Width > cb Height ) ? ( cb Width / cb Height ) : ( cb Height / cb Width )$$

For each 4×4 subblock at subblock index (xSbIdx, ySbIdx) with xSbIdx=0 . . . numSbX−1, and ySbIdx=0 . . . numSbY−1, the following applies:
The variables xIdx and yIdx are derived as follows:

$$xIdx = ( cb Width > cb Height ) ? ( xSbIdx / cb Ratio ) : xSbIdx$$

$$yIdx = ( cb Width > cb Height ) ? ySbIdx : ( ySbIdx / cb Ratio )$$

The variable sType is derived as follows:
   If triangleDir is equal to 0, the following applies:

$$s Type = ( xIdx == yIdx ) ? 2 : ( ( xIdx > yIdx ) ? 0 : 1 )$$

Otherwise (triangleDir is equal to 1), the following applies:

$$s Type = ( xIdx + yIdx == min Sb ) ? 2 : ( ( xIdx > yIdx ) ? 0 : 1 )$$

where triangleDir specifies the partition direction.

As shown in FIGS. 33A-33C, sType equal to 0 corresponds to P1 area; sType equal to 1 corresponds to P2 area; sType equal to 2 corresponds to the weighted area.

The motion information of P1 area is denoted as (Mv1,refIdx1); the motion information of P2 area is denoted as (Mv2,refIdx2).
Depending on the value of sType, the following assignments are made:
   If sType is equal to 0, the motion information of the 4×4 subblock is (Mv1,refIdx1).
   If sType is equal to 1, the motion information of the 4×4 subblock is (Mv2,refIdx2).
   Otherwise (sType is equal to 2), the following applies:
   1) If Mv1 and Mv2 are from different reference picture lists (one from L0 and the other from L1), then Mv1 and Mv2 are simply combined to form the bi-prediction motion vector.
   2) Otherwise, if Mv1 and Mv2 are from the same list, only uni-prediction motion Mv2 is stored.

### 2.24. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

FIG. 34 illustrates a diagram 3400 of examples of the GPM splits grouped by identical angles. When this mode is used, a CU is split into two parts by a geometrically located straight line (FIG. 34). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in section 2.24.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.24.2. This is the prediction signal for the whole CU, and transform and quantization process will be applied to the whole CU as in other prediction modes. Finally, the motion field of a CU predicted using the geometric partition modes is stored as in section 2.24.3.

### 2.24.1 Uni-Prediction Candidate List Construction

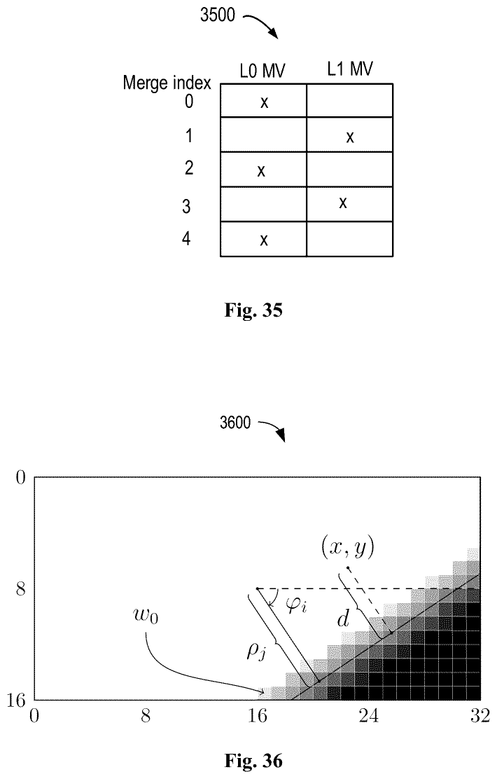

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. FIG. 35 illustrates a diagram 3500 of uni-prediction MV selection for geometric partitioning mode. These motion vectors are marked with “x” in FIG. 35. In case a corresponding LX motion vector of the n-the extended merge candidate does not exist, the L(1−X) motion vector of the same candidate is used instead as the uni-prediction motion vector for geometric partitioning mode.

### 2.24.2 Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 1 )$$

$${ρ}_{j} = {ρ}_{x , j} cos ( {φ}_{i} ) + {ρ}_{y , j} sin ( {φ}_{i} ) \qquad ( 2 - 2 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 3 )$$

$${ρ}_{y , j} = \{ \begin{matrix}\pm ( j \times w ) ≫ 2 & i \% 16 = 8 or ( i \% 16 \neq 0 and h \geq w ) \\ 0 & otherwise\end{matrix} \qquad ( 2 - 4 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = part Idx ? 32 + d ( x , y ) : 32 - d ( x , y ) \qquad ( 2 - 5 )$$

$${w}_{0} ( x , y ) = \frac{Clip 3 ( 0 , 8 , ( wIdxL ( x , y ) + 4 ) ≫ 3 )}{8} \qquad ( 2 - 6 )$$

$${w}_{1} ( x , y ) = 1 - {w}_{0} ( x , y ) \qquad ( 2 - 7 )$$

The partIdx depends on the angle index i. FIG. 36 illustrates a diagram 3600 of exemplified generation of a bending weight w_0 using geometric partitioning mode. One example of weigh w₀ is illustrated in FIG. 36.

### 2.24.3 Motion Field Storage for Geometric Partitioning Mode

Mv1 from the first part of the geometric partition, Mv2 from the second part of the geometric partition and a combined My of Mv1 and Mv2 are stored in the motion filed of a geometric partitioning mode coded CU.

The stored motion vector type for each individual position in the motion filed are determined as:

$$s Type = abs ( motionIdx ) < 32 ? 2 : ( motionIdx \leq 0 ? ( 1 - part Idx ) : part Idx ) \qquad ( 2 - 8 )$$

where motionIdx is equal to d(4x+2, 4y+2), which is recalculated from equation (2-1). The partIdx depends on the angle index i.

If sType is equal to 0 or 1, Mv1 or Mv2 are stored in the corresponding motion field, otherwise if sType is equal to 2, a combined My from Mv1 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.25. Combined Inter and Intra Prediction (CIIP)

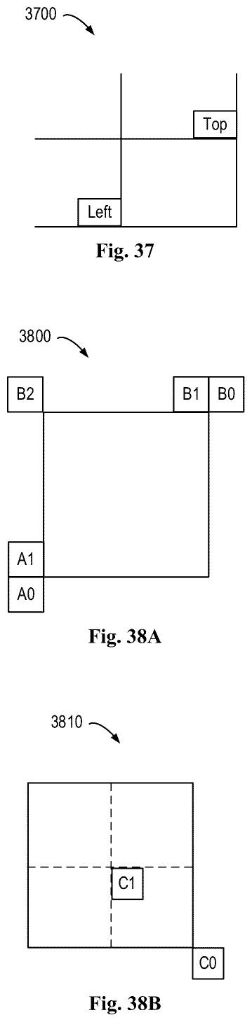

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in a diagram 3700 in FIG. 37) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{i n t e r} + wt * {P}_{i n t r a} + 2 ) ≫ 2$$

### 2.26. Decoder Side Intra Mode Derivation (DIMD)

When DIMD is applied, two intra modes are derived from the reconstructed neighbor samples, and those two predictors are combined with the planar mode predictor with the weights derived from the gradients.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.27. IBC Motion Candidates

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

The non-adjacent spatial candidates of current coding block are adjacent spatial candidates of a virtual block in the ith search round (as shown in FIG. 9). The width and height of the virtual block for the ith search round are calculated by: newWidth=i×2×gridX+W, newHeight=i×2×gridY+H. Obviously, the virtual block is the current block if the search round i is 0.

In the following, a BV predictor also is a BV candidate. The skip mode also is the merge mode.

The BV candidates can be divided into several groups according to some criterions. Each group is called a subgroup. For example, we can take adjacent spatial and temporal BV candidates as a first subgroup and take the remaining BV candidates as a second subgroup; In another example, we can also take the first N (N>2) BV candidates as a first subgroup, take the following M (M>2) BV candidates as a second subgroup, and take the remaining BV candidates as a third subgroup.

### On Usage of a BV Candidate

1. A BV candidate (e.g. BV searching point or BV predictor) is disallowed to be used in the coding/decoding process of a block if it is invalid.
   a. In one example, only if a BV candidate is valid, it may be used in the coding/decoding process of a block.
      i. For example, only if a BV candidate is valid, it may be used for BV search or BV prediction.
   b. In one example, whether to use a BV candidate in the coding/decoding process of a block may be dependent on a validation check of the BV candidate.
      i. In one example, before inserting a new BV candidate into a BV candidate list, a validation check of the BV candidate needs to be performed.
   c. Only if a BV candidate is valid, it may be inserted into an IBC candidate list.
      i. In one example, the IBC candidate list may be the IBC merge candidate list.
      ii. In one example, the IBC candidate list may be the IBC AMVP candidate list.
      iii. In one example, the IBC candidate list may be the IBC template matching candidate list.
      iv. In one example, the IBC candidate list may be the intra template matching candidate list.
   d. Only if a BV candidate is valid, it may be used for hash-based search for IBC.
   e. Only if a BV candidate is valid, it may be used for block matching based local search for IBC.
   f. Only if a BV candidate is valid, it may be used for intra template matching.
   g. Alternatively, furthermore, the above mentioned BV candidates may be those from specific neighboring blocks (e.g., adjacent or non-adjacent) or HMVP tables or some virtual candidates generated from these BV candidates.
   h. Alternatively, furthermore, the above mentioned BV candidates may exclude some default candidates (e.g., the default zero vectors).
      i. Alternatively, furthermore, when a BV candidate is marked as invalid, a virtual candidate derived from the invalid BV candidate may be used instead.
      i. In one example, the virtual candidate may be derived by adding an offset to the invalid BV candidate.
      ii. In one example, the virtual candidate may be derived by applying a clipping function to the invalid BV candidate.

### On Validation Check of a BV Candidate

2. In one example, a BV candidate may be determined to be valid when it meets one of or a combination of at least one of the following conditions.
   a. The corresponding reference block is already reconstructed inside the current picture.
   b. The corresponding reference block is located in the same CTU row as current block.
   c. The corresponding reference block is located in the same tile/subpicture as current block.
   d. The corresponding reference block is located in the same slice as current block.
   e. The BV candidate satisfies the block vector constraints (e.g. which is described in 2.4.2 and 2.4.3)
   f. The BV candidate satisfies the IBC virtual buffer conditions (e.g. which is described in 2.4.4).
3. In one example, a BV candidate may be determined to be invalid when it violates one of or a combination of at least one of the conditions in bullet 2.

### On BV Candidate List

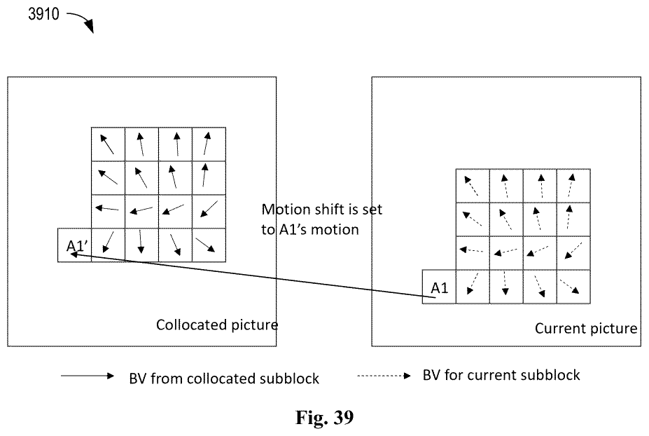

4. A BV candidate may be derived/obtained from a non-adjacent block.
   a. In one example, the distances between non-adjacent spatial candidates and current coding block may be based on the width and height of current coding block (e.g. FIG. 9 or FIG. 10, gridX=W, gridY=H).
      i. Alternatively, the distances between non-adjacent spatial candidates and current coding block may be multiple of a constant value.
         (i) For example, the multiplication factor is dependent on the search round index (e.g. the multiplication factor is i for the ith search round) and gridX=M, gridY=N (M and N are constant values).
   b. In one example, the non-adjacent spatial candidates may be inserted after the TMVP candidate.
      i. Alternatively, the non-adjacent spatial candidates may be inserted after the adjacent spatial candidates and before TMVP candidate.
5. A BV candidate may come from a spatial neighboring block, a temporal neighboring block, HMVP, pairwise, and/or STMVP candidates. FIGS. 38A-38B illustrates example candidate positions for spatial candidate and temporal candidate.
   a. In one example, the spatial candidates may consist of adjacent and/or non-adjacent spatial candidates.
      i. In one example, the adjacent spatial candidates may consist of left and/or above and/or above-right and/or bottom-left and/or above-left spatial candidates (an example of candidate positions for spatial candidate is shown in a diagram 3800 of FIG. 38A).
   b. In one example, for the TMVP candidate, the position for the temporal candidate is selected between candidates C0 and C1, as depicted in a diagram 3810 of FIG. 38B. If CU at position C0 is not available, is intra coded, is outside of the current row of CTUs or its BV is invalid for current block, position C₁ is used. Otherwise, position C0 is used in the derivation of the TMVP candidate.
      i. Alternatively, for the TMVP candidate, both candidates C0 and C1, as depicted in FIG. 38B, can be used.
         (i) For example, the order is C0->C1.
         (ii) Alternatively, the order is C1->C0.
   c. In one example, for the pairwise candidate, pairwise average candidates are generated by averaging predefined pairs of candidates in the existing BV candidate list, and the predefined pairs are defined as {(0, 1), (0, 2), (1, 2), (0, 3), (1, 3), (2, 3)}, where the numbers denote the BV candidate indices to the BV candidate list.
      i. In one example, the number of pairwise candidates is P. P is an integer from 0 to 6.
      ii. In one example, the pairwise candidates may be inserted after HMVP.
   d. In one example, for the STMVP candidate, it is generated by averaging predefined E spatial BV candidates and predefined G temporal BV candidates.
      i. In one example, E is less than or equal to the number of spatial candidates (F) inserted into the current BV candidate list before STMVP.
      ii. In one example, the predefined E spatial BV candidates may be the first E spatial BV candidates among the F spatial candidates inserted into the current BV candidate list before STMVP.
         (i) Alternatively, the predefined E spatial BV candidates may be the selected E spatial BV candidates among the F spatial candidates inserted into the current BV candidate list before STMVP.
      iii. In one example, E is 2, G is 1.
      iv. In one example, STMVP may be inserted before the above-left spatial BV candidate.
      v. In one example, STMVP may be inserted after the pairwise candidate.
   e. In one example, the BV candidate inserting order is adjacent spatial->HMVP->pairwise.
   f. In one example, the BV candidate inserting order is adjacent spatial->temporal->HMVP->pairwise.
   g. In one example, the BV candidate inserting order is adjacent spatial->temporal->non-adjacent spatial->HMVP->pairwise.
   h. In one example, the BV candidate inserting order is adjacent spatial->non-adjacent spatial->HMVP->pairwise.
   i. In one example, the BV candidate inserting order is adjacent spatial (STMVP is inserted before the above-left spatial BV candidate)->temporal->non-adjacent spatial->HMVP->pairwise.
6. A BV candidate list may also consist of clipped BV candidates.
   a. In one example, if a BV candidate is invalid from the sense of the 3^{rd} bullet, it may be converted to a valid BV following a given rule and then inserted into the BV candidate list.
      i. In one example, a BV candidate may be converted to the nearest valid BV candidate.
      ii. In one example, a BV candidate may be converted to the nearest valid BV candidate from a predefined BV candidate set.
   b. In one example, if a non-zero BV candidate is invalid, it may be clipped to the nearest valid BV and then inserted into the BV candidate list.
   c. In one example, if a non-zero BV candidate is invalid, it may be clipped to the nearest valid BV from a predefined BV candidate set and then inserted into the BV candidate list.
      i. In one example, the predefined BV candidate set may consist of (−m*W,0), (0,−n*H), (−m*H,0), (0,−n*W). m and n are positive values.
   d. In one example, the clipped BV candidates may be inserted after the non-clipped BV candidates.
7. The BV candidate list can be used as IBC merge/AMVP candidate list.
   a. Alternatively, the BV candidate list can be used to derive IBC merge/AMVP candidate list.
      i. In one example, for IBC merge mode, the first R entries of the BV candidate list will be used to construct the IBC merge candidate list; for IBC AMVP mode, the first S entries of the BV candidate list will be used to construct the IBC AMVP candidate list.
         (i) In one example, R is 6, S is 2.
8. In one example, subblock-based temporal block vector prediction (SbTBVP) may be supported as a BV candidate or a BV prediction mode.
   a. Similar to the SbTMVP, SbTBVP uses the BV motion field in the collocated picture to improve block vector prediction and IBC merge mode for CUs in the current picture. The same collocated picture used by TMVP is used for SbTBVP.
   b. In one example, SbTBVP applies a motion shift before fetching the temporal BV information from the collocated picture, where the motion shift is obtained from the motion vector from one of the spatial neighboring blocks of the current CU (an example is shown in FIG. 39). FIG. 39 illustrates a diagram 391400 of deriving sub-CU by motion field from the corresponding collocated sub-CUs by applying a motion shift from spatial neighbor.
      i. In one example, if A1 has a motion vector that uses the collocated picture as its reference picture, this motion vector is selected to be the motion shift to be applied. If no such motion is identified, then the motion shift is set to (0, 0).
      ii. In one example, other spatial candidate positions (e.g. A0, B0, B1, B2) can be used to derive the motion shift.
         (i) In one example, the checking order may be A1->B₁->B0->A0->B2.
         (ii) In one example, the checking order may be B1->A1->B0->A0->B2.
         (iii) In one example, the checking order may be A0->A1->B0->B1->B2.
   c. In one example, after deriving the motion shift, for each sub-CU, the BV information of its corresponding block (the smallest motion grid that covers the center sample) in the collocated picture is used to derive the BV information for the sub-CU (The example in FIG. 39) assumes the motion shift set to block A1's motion).

### On Reordering of BV Candidate List

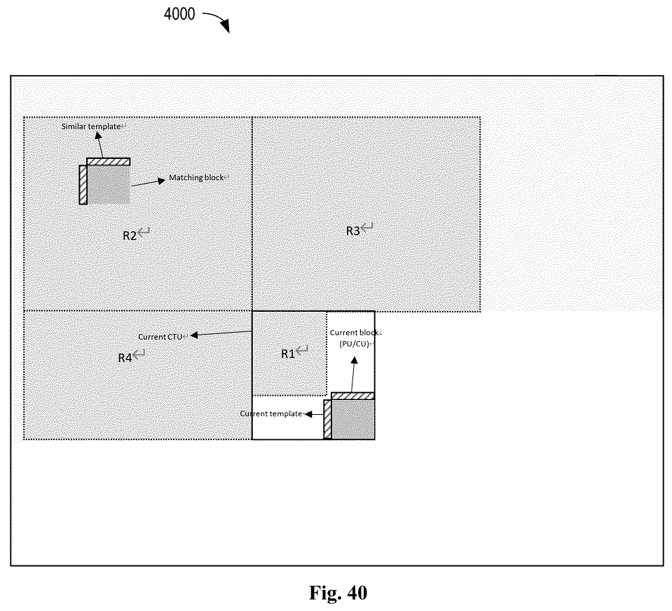

9. An initial BV candidate list may be firstly derived, followed by a reordering/refined process. And the reordered/refined list is utilized in the coding/decoding process of a block.
10. The BV candidates can be adaptively rearranged in the final BV candidate list according to one or some criterions.
   a. In one example, partial or full process of current BV candidate list construction process is firstly invoked, followed by the reordering of candidates in the list.
      i. Alternatively, candidates in a first subgroup may be reordered and they should be added before those candidates in a second subgroup wherein the first subgroup is added before the second subgroup.
   b. In one example, the criterion may be based on template matching cost.
      i. In one example, the cost function between current template and reference template may be
         (i) SAD/MR-SAD
         (ii) SATD/MR-SATD
         (iii) SSD/MR-SSD
         (iv) SSE/MR-SSE
         (v) Weighted SAD/weighted MR-SAD
         (vi) Weighted SATD/weighted MR-SATD
         (vii) Weighted SSD/weighted MR-SSD
         (viii) Weighted SSE/weighted MR-SSE
         (ix) Gradient information
      ii. In one example, the current template and reference template may consist of samples in the mapped domain if LMCS is enabled.
         (i) Alternatively, the current template and reference template may consist of samples in the original domain.
      iii. In one example, BV candidates in each subgroup may be reordered ascendingly according to cost values based on template matching.
      iv. In one example, if only above template is available for current block, the template matching reorder can only use the above template.
      v. In one example, if only left template is available for current block, the template matching reorder can only use the left template.
      vi. In one example, if both above and left templates are available for current block, the template matching reorder can use the left template, the above template, or both above and left templates.
      vii. In one example, if the reference template is outside the current picture, the corresponding BV candidate can still be reordered.
         (i) In one example, if the reference template is outside the current picture, it can be padded from the nearest samples inside the current picture.
      viii. In one example, the reference template should be already reconstructed inside the current picture.
         (i) In one example, if the reference template is not reconstructed or outside the current picture, the corresponding BV candidate may be not reordered.
   c. In one example, whether to and/or how to reorder the BV candidates may depend on the category of the BV candidates.
   d. In one example, the BV candidates to be reordered can be the BV candidates in the final BV candidate list.
      i. Alternatively, the BV candidates to be reordered can be partial/all the adjacent spatial BV candidates even it may not be included in the final BV candidate list.
      ii. Alternatively, the BV candidates to be reordered can be partial/all the non-adjacent spatial BV candidates even it may not be included in the final BV candidate list.
      iii. Alternatively, the BV candidates to be reordered can be partial/all the HMVP BV candidates even it may not be included in the final BV candidate list.
      iv. Alternatively, the BV candidates to be reordered can be partial/all the pairwise average BV candidates even it may not be included in the final BV candidate list.
      v. Alternatively, the BV candidates to be reordered can be partial/all the STMVP BV candidates even it may not be included in the final BV candidate list.
11. In one example, the cost disclosed in bullet 10 may be derived for a first BV candidate, which may be or may not be put into a BV candidate list.
   a. In one example, whether to put the first BV candidate into the BV candidate list may depend on the cost derived for the first BV candidate.
   b. In one example, whether to put the first BV candidate into the BV candidate list may depend on a comparison between a first cost derived for the first BV candidate and a second cost derived for a second BV candidate, which may be or may not be put into a BV candidate list.
12. In one example, for the intra TMP, the L-shaped template can be replaced with the above and left templates which excluding the above-left part (an example is shown in FIG. 40). FIG. 40 illustrates a diagram 4000 for intra template matching.
   a. In one example, if only above template is available for current block, the intra TMP can only use the above template.
   b. In one example, if only left template is available for current block, the intra TMP can only use the left template.
   c. In one example, if both above and left templates are available for current block, the intra TMP can use the left template, the above template, or both above and left templates.

### 3. PROBLEMS

The current design of IBC mode can be further improved.

More IBC based modes can be supported to improve the coding efficiency of IBC mode.

### 4. DETAILED DESCRIPTION

The detailed description below should be considered as examples to explain general concepts. These embodiments should not be interpreted in a narrow way. Furthermore, these embodiments can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

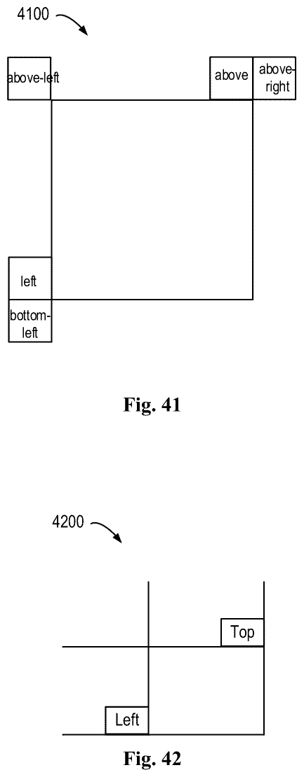

In the following, Mv1 and Mv2 are the motion vectors from the first part and the second part of the triangle or geometric partition.
1. In one example, the IBC merge mode with block vector differences (MBVD) may be used.
   a. In MBVD, a BV may be derived based on an IBC merge candidate which may be further refined by the signaled BVDs information.
   b. In one example, the BVDs information may include one or multiple IBC merge candidate indices, one or multiple indications (such as indices) to specify motion magnitude(s), and one or multiple indications (such as indices) for indication of motion direction(s).
      i. In MBVD mode, at least one from the candidates in the IBC merge list is selected to be used as BV basis. At least one MBVD candidate index is signaled to specify which candidate(s) is (are) used among the IBC merge candidates.
         (i) In one example, a MBVD candidate index is signaled to specify which one is used among the first N IBC merge candidates.
         a) In one example, N is set to 2.
         b) In one example, the candidate index may be binarized as a truncated code, with the maximum value equal to N−1.
         (ii) In one example, the IBC merge candidates may be reordered before being used.
      ii. In one example, a distance index specifies motion magnitude information and indicates the pre-defined offset from the starting point.
         (i) An offset may be added to either horizontal component or vertical component of a starting BV.
         (ii) An offset may be added to both horizontal component and vertical component of a starting BV.
         (iii) In one example, the distance set may be {1-pel, 2-pel, 4-pel, 8-pel, 16-pel, 32-pel}.
         (iv) In one example, the distance set may be {1-pel, 2-pel, 4-pel, 8-pel, 16-pel, 32-pel, 64-pel, 128-pel}.
         (v) In one example, the distance set may be {1-pel, 2-pel, 3-pel, 4-pel, 6-pel, 8-pel, 16-pel}.
         (vi) In one example, the distance set may be {1-pel, 2-pel, 3-pel, 4-pel, 6-pel, 8-pel, 16-pel, 32-pel, 64-pel}.
         (vii) In one example, the relation of distance index and pre-defined offset is specified in Table 4.
         (viii) In one example, the relation of distance index and pre-defined offset is specified in Table 5.
         (ix) In one example, the relation of distance index and pre-defined offset is specified in Table 6.
         (x) In one example, the relation of distance index and pre-defined offset is specified in Table 7.
         (xi) In one example, the relation of distance index and pre-defined offset may be signaled from encoder to decoder at sequence/picture/slice/CTU/CU level.
         (xii) The index may be binarized with unary coding, truncated unary coding, exponential-Golomb code, truncated exponential-Golomb code, fixed length code or any other binarization method.
      iii. In one example, a direction index represents the direction of the BVD relative to the starting point. The direction index can represent of the M BVD directions.
         (i) In one example, M is set to 4.
         a) In one example, 4 horizontal/vertical directions may be used.
         b) In one example, 4 diagonal directions may be used.
         c) In one example, the relation of direction index and pre-defined direction is specified in Table 8. For direction index of 0, (offset, 0) is the BVD; for direction index of 1, (−offset, 0) is the BVD; for direction index of 2, (0, offset) is the BVD; for direction index of 3, (0, −offset) is the BVD.
         d) In one example, the relation of direction index and pre-defined direction is specified in Table 9. For direction index of 0, (offset, offset) is the BVD; for direction index of 1, (offset, −offset) is the BVD; for direction index of 2, (−offset, offset) is the BVD; for direction index of 3, (−offset, −offset) is the BVD.
         (ii) In one example, M is set to 8.
         a) In one example, 4 horizontal/vertical directions plus 4 diagonal directions may be used.
         b) In one example, the relation of direction index and pre-defined direction is specified in Table 10.
         (iii) The index may be binarized with unary coding, truncated unary coding, exponential-Golomb code, truncated exponential-Golomb code, fixed length code or any other binarization method.
      iv. In one example, the number of distances and/or directions for MBVD of a block may be decided by
         (i) The resolution of a picture.
         (ii) The configuration of the coding process.
         (iii) The BVDs of the neighboring blocks of the block.
         a) In one example, the above and left neighboring blocks (depicted in FIG. 41 which shows a diagram 4100 of the adjacent spatial neighboring blocks used) may be used.
         b) In one example, the adjacent spatial neighboring blocks including left and/or above and/or above-right and/or bottom-left and/or above-left spatial neighboring blocks (an example is shown in FIG. 41) may be used.
         (iv) Alternatively, the number of distances and/or directions for MBVD may be signaled from encoder to decoder at sequence/picture/slice/CTU/CU level.
   c. In one example, the candidates/directions/magnitudes in MBVD which may produce a BV out of the valid range of BV may be excluded from the candidate/directions/magnitudes set to be selected or signaled.
      i. Alternatively, a BV generated in MBVD may be clipped to be in the valid range.
      ii. Alternatively, a BV generated in MBVD must be in the valid range in a conformance bitstream.

TABLE 4
The relation of distance index and pre-defined offset

| Distance IDX | 0 | 1 | 2 | 3 | 4 | 5 |
|---|---|---|---|---|---|---|
| Offset (in unit of | 1 | 2 | 4 | 8 | 16 | 32 |
| luma sample) | | | | | | |

TABLE 5
The relation of distance index and pre-defined offset

| Distance IDX | 0 | 1 | 2 | 3 | 4 | 5 | 6 | 7 |
|---|---|---|---|---|---|---|---|---|
| Offset (in unit of | 1 | 2 | 4 | 8 | 16 | 32 | 64 | 128 |
| luma sample) | | | | | | | | |

TABLE 6
The relation of distance index and pre-defined offset

| Distance IDX | 0 | 1 | 2 | 3 | 4 | 5 | 6 |
|---|---|---|---|---|---|---|---|
| Offset (in unit of | 1 | 2 | 3 | 4 | 6 | 8 | 16 |
| luma sample) | | | | | | | |

TABLE 7
The relation of distance index and pre-defined offset

| Distance IDX | 0 | 1 | 2 | 3 | 4 | 5 | 6 | 7 | 8 |
|---|---|---|---|---|---|---|---|---|---|
| Offset (in unit of | 1 | 2 | 3 | 4 | 6 | 8 | 16 | 32 | 64 |
| luma sample) | | | | | | | | | |

TABLE 8
Sign of BV offset specified by direction index

| Direction IDX | 00 | 01 | 10 | 11 |
|---|---|---|---|---|
| x-axis | + | − | N/A | N/A |
| y-axis | N/A | N/A | + | − |

TABLE 9
Sign of BV offset specified by direction index

| Direction IDX | 00 | 01 | 10 | 11 |
|---|---|---|---|---|
| x-axis | + | + | − | − |
| y-axis | + | − | + | − |

TABLE 10
Sign of BV offset specified by direction index

| Direction | | | | | | | | |
|---|---|---|---|---|---|---|---|---|
| IDX | 000 | 001 | 010 | 011 | 100 | 101 | 110 | 111 |
| x-axis | + | − | N/A | N/A | + | + | − | − |
| y-axis | N/A | N/A | + | − | + | − | + | − |

2. In one example, a new CIIP prediction mode (called CIIP_N) combines at least one IBC prediction signal and at least one prediction signal, generated by a second prediction method.
   a. The second prediction method may be intra-prediction or inter-prediction.
   b. The second prediction signal and IBC prediction signal may be combined by weighted averaging.
      i. The CIIP_N prediction is formed as

$${P}_{CIIP\_N} = ( ( {2}^{N} - wt ) * {P}_{IBC} + wt * {P}_{s e c} + offset ) ≫ N$$

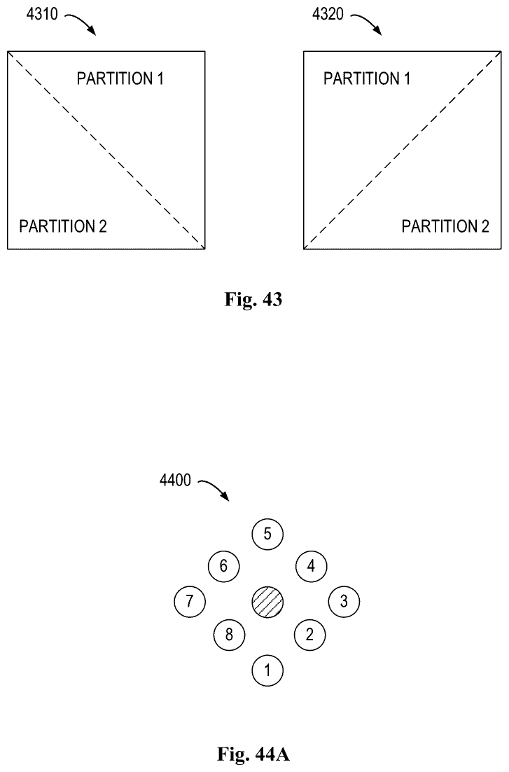

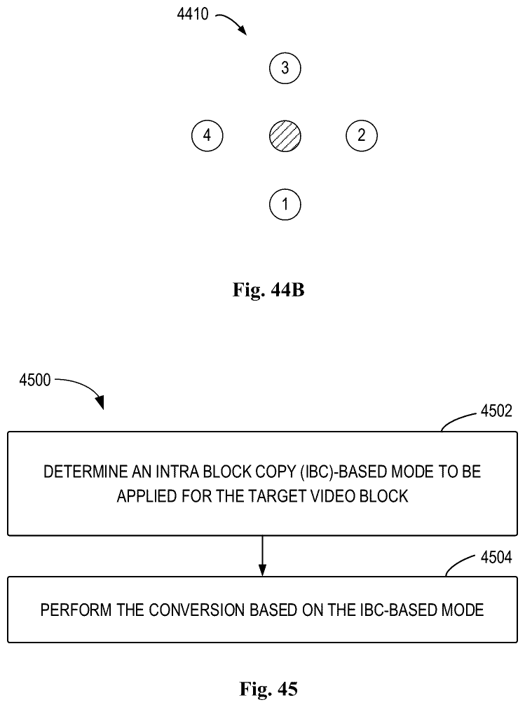

ii. In one example, offset is an integer such as 2^{N}>>1.
iii. In one example, N=2.
iv. In one example, the weight value may be predefined.
   (i) In one example, wt is set to 2.
v. In one example, the weight value may be position-dependent for each sample.
   (i) For example, for some positions wt=2^{N}.
   (ii) For example, for some positions, wt=0.
vi. In one example, the weight value may be signaled from encoder to decoder.
c. The IBC prediction signal in the CIIP_N mode P_{IBC} may be derived using the same IBC prediction process applied to regular IBC merge mode.
d. The second prediction signal P_{Sec} may be derived following the regular intra prediction process, and the combined mode is named as CIIP_N1.
   i. In one example, the intra prediction mode may be the planar mode.
   ii. In one example, the intra prediction mode may be the intra prediction mode which is implicitly derived by DIMD method.
   iii. In one example, the intra prediction mode may be the intra prediction mode which is implicitly derived by TIMD method.
   iv. In one example, the weight value may be calculated depending on the coding modes of the neighbouring blocks.
      (i) In one example, the weight value may be calculated depending on the coding modes of the top and left neighbouring blocks (depicted in FIG. 42 which shows a diagram 4200 of top and left neighboring blocks used in CIIP_N1 and CIIP_N2 weight derivation) as follows:
      If the top neighbor is available and intra coded, then set isIntraTop to 1, otherwise set isIntraTop to 0;
      If the left neighbor is available and intra coded, then set isIntraLeft to 1, otherwise set isIntraLeft to 0;
      If (isIntraLeft+isIntraTop) is equal to 2, then wt is set to 3;
      Otherwise, if (isIntraLeft+isIntraTop) is equal to 1, then wt is set to 2;
      Otherwise, set wt to 1.
e. The second prediction signal P_{Sec} may be derived using the same inter prediction process applied to regular merge mode, and the combined mode is named as CIIP_N2.
   i. In one example, the weight value may be calculated depending on the coding modes of the neighbouring blocks.
      (i) In one example, the weight value may be calculated depending on the coding modes of the top and left neighbouring blocks (depicted in FIG. 42) as follows:
      If the top neighbor is available and IBC coded, then set isIBCTop to 1, otherwise set isIBCTop to 0;
      If the left neighbor is available and IBC coded, then set isIBCLeft to 1, otherwise set isIBCLeft to 0;
      If (isIBCLeft+isIBCTop) is equal to 2, then wt is set to 1;
      Otherwise, if (isIBCLeft+isIBCTop) is equal to 1, then wt is set to 2;
      Otherwise, set wt to 3.
f. In CIIP_N mode, one from the candidates in the IBC merge list is selected to be used for IBC prediction. An IBC candidate index may be signaled to specify which one is used among the IBC merge candidates.
   i. In one example, an IBC candidate index is signaled to specify which one is used among the first N IBC merge candidates.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before being used.
   ii. In one example, an IBC candidate index is signaled to specify which one is used among the first N IBC merge candidates in the ascending order of SATD-cost values.
      (i) In one example, N is set to 4.
      (ii) In one example, N is set to the valid number of IBC merge candidates in the IBC merge list.
      (iii) In one example, N may be signaled from encoder to decoder.
      (iv) In one example, N is set to number of full RD for IBC merge.
      (v) In one example, N is set to number of full RD for IBC merge plus an integer.
      (vi) In one example, the IBC merge candidates may be reordered before calculating the SATD-cost.
g. In CIIP_N2 mode, one from the candidates in the regular merge list is selected to be used for inter prediction. A merge candidate index may be signaled to specify which one is used among the regular merge candidates.
   i. In one example, a merge candidate index is signaled to specify which one is used among the first N regular merge candidates.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before being used.
   ii. In one example, a merge candidate index is signaled to specify which one is used among the first N regular merge candidates in the ascending order of SATD-cost values.
      (i) In one example, N is set to 4.
      (ii) In one example, N is set to the valid number of regular merge candidates in the regular merge list.
      (iii) In one example, N may be signaled from encoder to decoder.
      (iv) In one example, N is set to number of full RD for inter merge.
      (v) In one example, N is set to number of full RD for inter merge plus an integer.
      (vi) In one example, the regular merge candidates may be reordered before calculating the SATD-cost.
h. In one example, whether to and/or how to use the CIIP_N mode may be dependent on the coding information such as block dimensions/QP/neighboring block mode, etc.
   i. In one example, when a block is coded in IBC merge mode, if the block contains at least P luma samples (that is, block width times block height is equal to or larger than P), an additional flag is signaled to indicate if the CIIP_N mode is applied to the current block.
      (i) In one example, P is set to 64.
   ii. In one example, when a block is coded in IBC merge mode, if both block width and block height are less than Q luma samples, an additional flag is signaled to indicate if the CIIP_N mode is applied to the current block.
      (i) In one example, Q is set to 128.
      (ii) In one example, Q is set to 64.
   iii. In one example, the above two conditions may be used together.
   i. In one example, whether to and/or how to use the CIIP_N2 mode may be dependent on the coding information such as block dimensions/QP/neighboring block mode, etc.
   i. In one example, when a block is coded in regular merge mode, if the block contains at least P luma samples (that is, block width times block height is equal to or larger than P), an additional flag is signaled to indicate if the CIIP_N2 mode is applied to the current block.
      (i) In one example, P is set to 64.
   ii. In one example, when a block is coded in regular merge mode, if both block width and block height are less than Q luma samples, an additional flag is signaled to indicate if the CIIP_N2 mode is applied to the current block.
      (i) In one example, Q is set to 128.
      (ii) In one example, Q is set to 64.
   i. In one example, the above two conditions may be used together.
3. In one example, a triangle partition mode may be supported for IBC prediction (called TPM_IBC).
   a. When this mode is used, a block is split evenly into two triangle-shaped partitions, using either the diagonal split or the anti-diagonal split (for example, FIG. 43 illustrates an example of triangle partition based IBC prediction). In FIG. 43, a block 4310 is split using the diagonal split, and a block 4320 is split using anti-diagonal split.
   b. Each triangle partition in the block is IBC-predicted using its own motion.
   c. The uni-prediction motion for each partition is derived from a uni-prediction IBC candidate list.
      i. In one example, the uni-prediction IBC candidate list is derived directly from partial or full of an IBC merge candidate list.
      ii. In one example, the uni-prediction IBC candidate list may be reordered before being used.
   d. After predicting each of the triangle partitions, the sample values along the diagonal or anti-diagonal edge may be adjusted using a blending processing with adaptive weights.
      i. In one example, the weights may be adaptively decided by the distances between a sample and the splitting line.
         (i) An example is shown in section 2.23.2.
      ii. Alternatively, the sample values along the diagonal or anti-diagonal edge may not be adjusted using a blending processing. Instead, a sample along the diagonal or anti-diagonal edge can only be predicted by one of the two predictions.
   e. For motion field storage of TPM_IBC, if sType is equal to 0 or 1, Mv1 or Mv2 are stored in the corresponding motion field, otherwise if sType is equal to 2, Mv2 is stored.
      i. In one example, the sType calculation is the same as that for inter TPM.
   f. For signaling of TPM_IBC, the following applies:
      i. The TPM_IBC mode is signaled using a CU-level flag as one kind of IBC merge mode.
      ii. If TPM_IBC mode is used for the current CU, then a flag indicating the direction of the triangle partition (diagonal or anti-diagonal), and two merge indices (one for each partition) are further signaled.
      iii. If TPM_IBC mode is used for the current CU, then a triangle partition index indicating the partition mode of the triangle partition, and two merge indices (one for each partition) are further signalled.
4. In one example, a geometric partitioning mode may be supported for IBC prediction (called GPM_IBC).
   a. When this mode is used, a block is split into two parts by a geometrically located straight line (e.g. FIG. 34). The location of the splitting line is mathematically derived from the angle and offset parameters of a specific partition.
   b. Each part of a geometric partition in the block is IBC-predicted using its own motion.
   c. The uni-prediction motion for each partition is derived from a uni-prediction IBC candidate list.
      i. In one example, the uni-prediction IBC candidate list is derived directly from partial or full of an IBC merge candidate list.
      ii. In one example, the uni-prediction IBC candidate list may be reordered before being used.
   d. After predicting each of part of the geometric partition, the sample values along the geometric partition edge may be adjusted using a blending processing with adaptive weights.
      i. In one example, the weights may be adaptively decided by the distances between a sample and the splitting line.
         (i) An example is shown in section 2.24.2.
      ii. Alternatively, the sample values along geometric partition edge may not be adjusted using a blending processing. Instead, a sample along the geometric partition edge can only be predicted by one of the two predictions.
   e. For motion field storage of GPM_IBC, if sType is equal to 0 or 1, Mv1 or Mv2 are stored in the corresponding motion field, otherwise if sType is equal to 2, Mv2 is stored.
      i. In one example, the sType calculation is the same as that for inter GPM.
   f. For signaling of GPM_IBC, the following applies:
      i. The GPM_IBC mode is signaled using a CU-level flag as one kind of IBC merge mode.
      ii. If GPM_IBC mode is used for the current CU, then a geometric partition index indicating the partition mode of the geometric partition (angle and offset), and two merge indices (one for each partition) are further signalled.
5. In one example, TM_AMVP for IBC (called TM_AMVP_IBC) is supported.
   a. In TM_AMVP_IBC mode, K IBC MVP candidates are determined based on template matching to pick up the one which reaches the first K minimum difference between current block template and reference block template from the IBC AMVP list.
      i. A selected set of start-point candidates consists of the K IBC MVP candidates.
   b. TM may perform only for the selected set of start-point candidates for MV refinement.
      i. TM refines a start-point candidate, starting from full-pel MVD precision (or 4-pel for 4-pel AMVR mode) within a search range.
         (i) In one example, refine it within a [−8, +8]-pel search range by using iterative diamond search. M search rounds will be used until the center searching point has the minimum matching cost for a diamond search pattern as shown in FIG. 44A. FIG. 44A illustrates an example 4400 of search pattern.
         a) In one example, M is MAX_UINT.
         b) In one example, M is 375.
      ii. The selected start-point candidate may be further refined by using cross search with full-pel MVD precision (or 4-pel for 4-pel AMVR mode).
         (i) In one example, one search round is used for cross search pattern as shown in FIG. 44B. FIG. 44B illustrates an example 4410 of search pattern.
   c. In one example, TM_AMVP_IBC may generate K refined IBC AMVP candidates, and one of them may be selected and the selection may be signaled from encoder to decoder.
      i. In one example, K=1, and no selection information is signaled.
      ii. In one example, if at least one refined IBC AMVP candidates by template matching are available, they are used as the TM_AMVP_IBC candidates. Otherwise, the first K existing IBC AMVP candidates without refinement are used.
      iii. In one example, the selected refined IBC AMVP candidate is used as the starting point for block matching based local search of IBC mode.
   d. Alternatively, the derived BV by TM_IBC is used as the starting point for block matching based local search of IBC mode.
   e. For example, when IBC AMVR is enabled, the refined IBC AMVP candidate in one MVD precision may be reused in another MVD precisions.
      i. In one example, the refined IBC AMVP candidate in full-pel MVD precision may be reused in 4-pel MVD precisions.
6. In one example, TM_merge for IBC (called TM_merge_IBC) is supported.
   a. In TM_merge_IBC mode, K IBC merge candidates are determined based on template matching to pick up the one which reaches the first K minimum difference between current block template and reference block template from the IBC merge list.
      i. A selected set of start-point candidates consists of the K IBC merge candidates.
   b. TM may perform only for the selected set of start-point candidates for MV refinement.
      i. TM refines a start-point candidate, starting from full-pel MVD precision (or 4-pel for 4-pel AMVR mode) within a search range.
         (i) In one example, refine it within a [−8, +8]-pel search range by using iterative diamond search. M search rounds will be used until the center searching point has the minimum matching cost for a diamond search pattern as shown in FIG. 44A.
         a) In one example, M is MAX_UINT.
         b) In one example, M is 375.
      ii. The selected start-point candidate may be further refined by using cross search with full-pel MVD precision (or 4-pel for 4-pel AMVR mode).
         (i) In one example, one search round is used for cross search pattern as shown in FIG. 44B.
   c. In one example, TM_merge_IBC may generate K refined IBC merge candidates, and one of them may be selected and the selection may be signaled from encoder to decoder.
      i. In one example, K=1, and no selection information is signaled.
      ii. In one example, if at least one refined IBC merge candidates by template matching are available, they are used as the TM_merge_IBC candidates. Otherwise, TM_merge_IBC mode is invalid.
      iii. In one example, the best TM refined IBC merge candidate is selected by a criterion.
         (i) In one example, the criterion is RD decision.
   d. Alternatively, TM performs for each IBC merge candidate for MV refinement. And then the best TM refined IBC merge candidate is selected by a criterion.
      i. In one example, the criterion is RD decision.

The embodiments of the present disclosure are related to IBC mode extension. As used herein, the term “block” may represent a coding tree block (CTB), a coding tree unit (CTU), a coding block (CB), a coding unit (CU), a prediction unit (PU), a transform unit (TU), a prediction block (PB), a transform block (TB), or a video processing unit comprising a plurality of samples or pixels. A block may be rectangular or non-rectangular.

For an intra block copy (IBC) coded block, a block vector (BV) may be used to indicate a displacement from the current block and a reference block, which is reconstructed inside the current picture.

W and H are the width and height of current block (e.g., luma block).

It is noted that the terminologies mentioned below are not limited to the specific ones defined in existing standards. Any variance of the coding tool is also applicable. For example, the term “GPM” is used to represent any coding tool that derive two or more sets of motion information and use the derived motion information and the splitting pattern/weighting masks to get the final prediction, e.g., TPM may be also treated as GPM.

In the following, Mv1 and Mv2 are the motion vectors from the first part and the second part of the triangle or geometric partition.

FIG. 45 illustrates a flowchart of a method 4500 for video processing in accordance with some embodiments of the present disclosure. The method 4500 may be implemented during a conversion between a target video block of a video and a bitstream of the video.

As shown in FIG. 45, at block 4502, during a conversion between a target video block of a video and a bitstream of the video, an intra block copy (IBC)-based mode is determined to be applied for the target video block. A target video block may be comprised in a target picture of the video. A target video block may sometimes be referred to a current block or a current video block, which may be of various sizes. As used herein, “motion information” may also be referred to as motion data. In embodiments of the present disclosure, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM.

At block 4504, the conversion is performed based on the IBC-based mode.

In the IBC-based mode, at least IBC related operations may be performed. In some embodiments, in the IBC-based mode, prediction samples may be at least derived from blocks of sample values of a same video region as determined by block vectors. Additionally, other principles, operations, and/or implementations may be further applied in each of the IBC-based modes proposed in the present disclosure. Some implementations related to respective IBC-based modes will be further discussed in the following.

In some embodiments, the conversion includes encoding the target video block into the bitstream. In such embodiments, the method of the present disclosure may be implemented at an encoder. In some embodiments, the conversion includes decoding the target video block from the bitstream. In such embodiments, the method of the present disclosure may be implemented at a decoder. In some embodiments, a bitstream of the video is generated based on a result of the multi-hypothesis prediction process. The bitstream may be stored in a non-transitory computer-readable recording medium.

According to embodiments of the present disclosure, it is proposed that more IBC-based modes are supported and corresponding implementations in respective IBC-based modes are provided. In this way, IBC coding may be further improved, and thus, the coding efficiency of IBC mode may be improved.

Implementations of the present disclosure can be described in view of the following clauses, the features of which can be combined in any reasonable manner.

In some embodiments, if the IBC MBVD mode is determined to be applied, in the IBC MBVD mode, a BV may be generated based on at least one IBC merge candidate, which may be further refined based on block vector difference (BVD) information. In some embodiments, the BVD information comprises signaled BVD information.

In some embodiments, the BVD information comprises at least one IBC merge candidate index, at least one indication (such as index) for at least one motion magnitude, at least one indication (such as index) for at least one motion direction, or any other suitable BVD information.

In some embodiments, in the IBC MBVD mode, at least one from the candidates in the IBC merge list may be selected to be used as BV basis. At least one MBVD candidate index may be signaled to specify which candidate(s) is (are) used among the IBC merge candidates.

In some embodiments, the at least one IBC merge candidate may be selected from an IBC merge candidate list to be used as BV basis. The at least one MBVD candidate index may be included in the bitstream to specify which at least one IBC merge candidate(is) is selected among the IBC merge candidates.

In some embodiments, a MBVD candidate index may be included in the bitstream to specify a selected IBC merge candidate among a first predetermined number (e.g., N) of IBC merge candidates in the IBC merge candidate list. For example, the MBVD candidate index is signaled to specify which one is used among the first N IBC merge candidates. In some embodiments, N is set to two. In some embodiments, the MBVD candidate index may be binarized as a truncated code, with a maximum value equal to N−1.

In some embodiments, the IBC merge candidate list may be reordered before being used. The at least one IBC merge candidate may be selected from the reordered IBC merge candidate list.

In some embodiments, in the BVD information, the at least one indication for at least one motion magnitude may comprise a distance index to specify motion magnitude information. The distance index may indicate a predefined offset from a starting point.

In some embodiments, the predefined offset may comprise an offset added to either a horizontal component or a vertical component of a starting BV. In some embodiments, the predefined offset may comprise an offset added to both a horizontal component and a vertical component of a starting BV.

In some embodiments, the predefined offset may be one of 1 pixel, 2 pixels, 4 pixels, 8 pixels, 16 pixels, 32 or pixels. In some embodiments, the predefined offset may be selected from a first offset group (or a first distance set) of {1-pel, 2-pel, 4-pel, 8-pel, 16-pel, 32-pel}, where “-pel” means “pixel” or “pixels”. In some embodiments, the distance index indicating the predefined offset may be selected from a first index group comprising respective distance indices corresponding to offsets within the first offset group. An example relation of distance indices and predefined offsets is specified in above Table 4.

In some embodiments, the predefined offset may be one of 1 pixel, 2 pixels, 4 pixels, 8 pixels, 16 pixels, 32 pixels, 64 pixels, or 128 pixels. In some embodiments, the predefined offset may be selected from a second offset group of {1-pel, 2-pel, 4-pel, 8-pel, 16-pel, 32-pel, 64-pel, 128-pel}. In some embodiments, the distance index indicating the predefined offset may be selected from a second index group comprising respective distance indices corresponding to offsets within the second offset group. An example relation of distance indices and predefined offsets is specified in above Table 5.

In some embodiments, the predefined offset may be one of 1 pixel, 2 pixels, 3 pixels, 4 pixels, 6 pixels, 8 pixels, or 16 pixels. In some embodiments, the predefined offset may be selected from a third offset group of {1-pel, 2-pel, 3-pel, 4-pel, 6-pel, 8-pel, 16-pel}. In some embodiments, the distance index may be selected from a third index group comprising respective distance indices corresponding to offsets within the third offset group. An example relation of distance indices and predefined offsets is specified in above Table 6.

In some embodiments, the predefined offset may be one of 1 pixel, 2 pixels, 3 pixels, 4 pixels, 6 pixels, 8 pixels, 16 pixels, 32 pixels, or 64 pixels. In some embodiments, the predefined offset may be selected from a fourth offset group of {1-pel, 2-pel, 3-pel, 4-pel, 6-pel, 8-pel, 16-pel, 32-pel, 64-pel}. In some embodiments, the distance index may be selected from a fourth index group comprising respective distance indices corresponding to offsets within the fourth offset group. An example relation of distance indices and predefined offsets is specified in above Table 7.

In some embodiments, a relation between respective distance indices and offsets (e.g., any of the relations in Tables 4 to 7) may be indicated from an encoder for the video to a decoder for the video. In some embodiments, the relation may be signaled at a sequence level, a picture level, a slice level, a coding tree unit (CTU) level, a coding unit (CU) level, or any other suitable level.

In some embodiments, the distance index may be binarized based on at least one of the following: unary coding, truncated unary coding, exponential-Golomb code, truncated exponential-Golomb code, fixed length code, or any other binarization method.

In some embodiments, in the MVD information, the at least one indication for at least one motion direction may comprise a direction index indicating a predefined direction of BVD relative to a starting point. In some embodiments, the direction index represents an BVD direction among a second predetermined number (e.g., M) of BVD directions.

In some embodiments, the second predetermined number M may be set to four. In some embodiments, four BVD directions may comprise four horizontal/vertical directions. In some embodiments, the four BVD directions may comprise four diagonal directions.

In some embodiments, if four BVD directions may comprise four horizontal/vertical directions, the direction index may be one of a first direction index (e.g., index 0), a second direction index (e.g., index 1), a third direction index (e.g., index 2), or a fourth direction index (e.g., index 4). In an example, the above-mentioned four direction indices may form a first direction index group. Index 0 may indicate a positive sign of a BV offset in a horizontal component, and a vertical component may be a default value, such as zero. For example, index 0 may indicate (offset, 0) as BVD. Index 1 may indicate a negative sign of the BV offset in the horizontal component, and the vertical component may be a default value, such as zero. For example, index 1 may indicate (−offset, 0) as BVD. Index 2 may indicate a positive sign of the BV offset in a vertical component, and the horizontal component may be a default value, such as zero. For example, index 2 may indicate (0, offset) as BVD. Index 3 may indicate a negative sign of the BV offset in the vertical component, and the horizontal component may be a default value, such as zero. For example, index 3 may indicate (0, −offset) as BVD. An example relation of direction indices and directions may be specified in Table 8.

In some embodiments, the direction index may be one of a first direction index (e.g., index 0), a second direction index (e.g., index 1), a third direction index (e.g., index 2), or a fourth direction index (e.g., index 4). In an example, the above-mentioned four direction indices may form a second direction index group. Index 0 may indicate a positive sign of a BV offset in a horizontal component and a positive sign of the BV offset in a vertical component. For example, index 0 may indicate (offset, offset) as the BVD. Index 1 may indicate a positive sign of the BV offset in the horizontal component and a negative sign of the BV offset in the vertical component. For example, index 1 may indicate (offset, −offset) as the BVD. Index 2 may indicate a negative sign of the BV offset in the horizontal component and a positive sign of the BV offset in the vertical component. For example, index 2 may indicate (−offset, offset) as the BVD. Index 3 may indicate a negative sign of the BV offset in the horizontal component and a negative sign of the BV offset in the vertical component. For example, index 3 may indicate (−offset, −offset) as the BVD. An example relation of direction indices and directions may be specified in Table 9.

In some embodiments, the second predetermined number of M may be eight, and the second predetermined number of BVD directions comprise four horizontal/vertical directions, and four diagonal directions. In some embodiments, the direction index may be one of the four indices in the above first direction index group and second direction index group. Specifically, the direction index may be one of index 0, index 1, index 2, index 3, index, 4, index 5, index 6, or index 7, which may form a third direction index group.

Index 0 may indicate a positive sign of a BV offset in a horizontal component, and zero in the vertical component, for example, (offset, 0) as BVD. Index 1 may indicate a negative sign of the BV offset in the horizontal component, and zero in the vertical component, for example, (−offset, 0) as BVD. Index 2 may indicate a positive sign of the BV offset in a vertical component, and zero in the horizontal component, for example, (0, offset) as BVD. Index 3 may indicate a negative sign of the BV offset in the vertical component, and zero in the horizontal component, for example, (0, −offset) as BVD. Index 4 may indicate a positive sign of a BV offset in a horizontal component and a positive sign of the BV offset in a vertical component, for example, (offset, offset) as BVD. Index 5 may indicate a positive sign of the BV offset in the horizontal component and a negative sign of the BV offset in the vertical component, for example, (offset, −offset) as BVD. Index 6 may indicate a negative sign of the BV offset in the horizontal component and a positive sign of the BV offset in the vertical component, for example, (−offset, offset) as BVD. Index 7 may indicate a negative sign of the BV offset in the horizontal component and a negative sign of the BV offset in the vertical component, for example, (−offset, −offset). An example relation of direction indices and directions may be specified in Table 10.

In some embodiments, the direction index may be binarized based on unary coding, truncated unary coding, exponential-Golomb code, truncated exponential-Golomb code, fixed length code, or any other binarization method.

In some embodiments, in the IBC MBVD mode, the number of motion magnitudes (or distances) and/or the number of motion direction(s) may be determined based on at least one of the following: a resolution of a picture, a configuration of a coding process, or BVD information of at least one neighbouring block of the target video block.

In some embodiments, the at least one neighbouring block of which BVDs are used may comprise an above neighbouring block and a left neighbouring block (see FIG. 41).

In some embodiments, the at least one neighbouring block may comprise at least one adjacent spatial neighbouring block. The at least one adjacent spatial neighbouring block may include at least one of the following: a left spatial neighbouring block, an above spatial neighbouring block, an above-right spatial neighbouring block, a bottom-left spatial neighbouring block, or an above-left spatial neighbouring block (see FIG. 41).

In some embodiments, alternatively, in the IBC MBVD mode, the number of the at least one motion magnitude and/or the number of the at least one motion direction may be indicated from an encoder for the video to a decoder for the video. In some embodiments, the number may be signaled at one of a sequence level, a picture level, a slice level, a coding tree unit (CTU) level, a coding unit (CU) level, or any other suitable level.

In some embodiments, in the IBC MBVD mode, the generated BV may be a valid BV within a valid range of BV. In some cases, the candidates, motion directions, and/or motion magnitudes used in the IBC MBVD mode which may produce a BV out of the valid range may be excluded from BVD information set to be selected or signaled. As such, it may ensure that the generated BV is valid. In some embodiments, as an alternative, if a BV derived from the BVD information is out of a valid range of BV, a clipping process may be performed on the BV out of the valid range, to clip the BV to be within the valid range. In some embodiments, as an alternative, the BV may be generated according to a bitstream conformance constraint, the bitstream conformance constraint specifying the BV to be within a valid range of BV.

In some embodiments, the IBC-based mode may comprise the combined prediction mode based on an IBC mode and at least one further prediction mode. This mode may be considered as a new CIIP mode which combines at least one IBC prediction and at least one further prediction (referred to as “CIIP_N”). In some embodiments, the at least one further prediction mode may comprise an intra-prediction mode or an inter-prediction mode.

In some embodiments, if the CIIP_N mode is determined to be applied to the target video block, at least one first prediction block for the target video block may be generated based on the IBC mode, and at least one second prediction block for the target video block may be generated based on the at least one further prediction mode. The at least one first prediction block may also be referred to as a first prediction signal, or an IBC prediction signal or block. The at least one second prediction block may also be referred to as a second prediction signal.

Then a target prediction block for the target video block may be determined at least based on a weighted combination of the at least one first prediction block and the at least one second prediction block. In some embodiments, the target prediction signal may be determined further based on an offset, the offset being an integer. In some examples, the at least one first prediction block and the at least one second prediction block may be combined by weighted averaging as follows:

$${P}_{CIIP\_N} = ( ( {2}^{N} - wt ) * {P}_{IBC} + wt * {P}_{s e c} + offset ) ≫ N$$

where P_{CIIP_N} represents the target prediction block,
P_{IBC} represents a first prediction block generated based on the IBC mode,
P_{Sec} represents a second prediction block generated based on a further prediction mode,
offset represents the offset,
wt represents the weight parameter, and
N represents the predetermined value.

In the above equation, a value of the weighted parameter wt is used to weight the second prediction block P_{sec}, and (2^{N}−wt) is used to weight the first prediction block P_{IBC}. In some embodiments, the offset may be an integer such as 2^{N}>>1.

In some embodiments, the predetermined value N may be 2 although other value may also be configured.

In some embodiments, a value of the weight parameter wt may be predefined. In some embodiments, the value of the weight parameter may be set to 2 although other value may also be predefined.

In some embodiments, a value of the weight parameter wt may be determined based on a position for a sample. That is, the value of the weight parameter wt may be position-dependent for each sample. In some embodiments, for some positions, a value of the weight parameter wt may be determined as a value calculated from the predetermined value N. For example, wt may be determined as the predetermined value N power of 2, i.e., wt=2^{N}, In some embodiments, for some positions, wt=0.

In some embodiments, a value of the weight parameter wt may be indicated or signaled from an encoder for the video to a decoder for the video.

In some embodiments, the at least one first prediction block may be generated using an IBC prediction process applied in an IBC merge mode. That is, the at least one first prediction block (or IBC prediction signal) in the CIIP_N mode P_{IBC} may be derived using the same IBC prediction process applied to regular IBC merge mode.

In some embodiments, if the CIIP_N mode combines the IBC mode and the intra-prediction mode, the at least one further prediction block P_{Sec} may be derived following a regular intra prediction process, and the combined prediction mode may be called CIIP_N1. In some embodiments, the intra-prediction mode may comprise a planar prediction mode. In some embodiments, the intra-prediction mode may comprise an intra-prediction mode which may be implicitly derived by decoder side intra mode derivation (DIMD). In some embodiments, the intra-prediction mode may comprise an intra-prediction mode which is implicitly derived by template-based intra mode derivation (TIMD).

In some embodiments, in the CIIP_N1 mode, a value of the weight parameter may be determined based on at least one coding mode of at least one neighbouring block of the target video block. Alternatively, or in addition, in the CIIP_N1 mode, a value of the weight parameter may be determined based on availability of at least one neighbouring block of the target video block. In some embodiments, a value of the weight parameter may be calculated depending on coding modes of the top and left neighbouring blocks of the target video block (e.g., shown in FIG. 42).

In some embodiments, in the CIIP_N1 mode, a value of the weight parameter may be calculated as follows. Specifically, the weight parameter may be set to a first value (e.g., 3) if both the top neighbouring block and the left neighbouring block are available and are intra coded. The weight parameter may be set to a second value (e.g., 2) if one of the top neighbouring block and the left neighbouring block is available and is intra coded. The weight parameter may be set to a third value (e.g., 1) if none of the top neighbouring block and the left neighbouring block is available and is intra coded. As an example, if the top neighbouring block is available and is intra coded, then a first parameter related to the top neighbouring block (isIntraTop) may be set to 1, otherwise, isIntraTop may be set to 0. Further, if the left neighbouring block is available and intra coded, then a second parameter related to the left neighbouring block (isIntraLeft) may be set to 1, otherwise, isIntraLeft may be set to 0. Then if (isIntraLeft+isIntraTop) is equal to 2, the weight parameter wt may be set to 3. Otherwise, if (isIntraLeft+isIntraTop) is equal to 1, the weight parameter wt may be set to 2. For other value of (isIntraLeft+isIntraTop), the weight parameter wt may be set to 1.

In some embodiments, if the CIIP_N mode combines the IBC mode and the inter-prediction mode, the at least one further prediction block P_{sec} may be derived using the same inter prediction process applied to a regular merge mode, and the combined prediction mode may be called CIIP_N2. In some embodiments, in the CIIP_N2 mode, a value of the weight parameter may be determined based on at least one coding mode of at least one neighbouring block of the target video block. Alternatively, or in addition, a value of the weight parameter may be determined based on availability of at least one neighbouring block of the target video block. In some embodiments, a value of the weight parameter may be calculated depending on coding modes of the top and left neighbouring blocks of the target video block (e.g., as shown in FIG. 42).

In some embodiments, in the CIIP_N2 mode, a value of the weight parameter may be calculated as follows. Specifically, the weight parameter may be set to a first value (e.g., 1) if both the top neighbouring block and the left neighbouring block are available and are IBC coded. The weight parameter may be set to a second value (e.g., 2) if one of the top neighbouring block and the left neighbouring block is available and is IBC coded. The weight parameter may be set to a third value (e.g., 3) if none of the top neighbouring block and the left neighbouring block is available and is IBC coded. As an example, if the top neighbouring block is available and IBC coded, then a first parameter related to the top neighbouring block (isIBCTop) may be set to 1, otherwise, isIBCTop may be set 0. If the left neighbouring block is available and IBC coded, then a second parameter related to the left neighbouring block (isIBCLeft) may be to 1, otherwise, isIBCLeft may be set 0. Then if (isIBCLeft+isIBCTop) is equal to 2, the weight parameter wt may be set to 1. Otherwise, if (isIBCLeft+isIBCTop) is equal to 1, the weight parameter wt may be set to 2. For other value of (isIBCLeft+isIBCTop), the weight parameter wt may be set to 3.

In some embodiments, in the CIIP_N mode, an IBC merge candidate may be selected from an IBC merge candidate list; and a first prediction block may be determined based on the IBC merge candidate. In some embodiments, an IBC merge candidate index is included in the bitstream to specify which one is selected for use among the IBC merge candidates.

In some embodiments, the IBC merge candidate index may be included in the bitstream to specify the selected IBC merge candidate among a third predetermined number (e.g., N) of IBC merge candidates in the IBC merge candidate list. For example, an IBC candidate index may be signaled to specify which one is used among the first N IBC merge candidates.

In some embodiments, the third predetermined number N may be a predefined value, for example, N may be set to 4. In some embodiments, the third predetermined number N may be set to a valid number of IBC merge candidates in the IBC merge candidate list. In some embodiments, the third predetermined number N may set to the number of full rate distortion (RD) for IBC merge. In some embodiments, the third predetermined number N may set to the number of full RD for IBC merge plus an integer.

In some embodiments, the third predetermined number N may be indicated (or signaled) from an encoder for the video to a decoder for the video. In some embodiments, the IBC merge candidate list may be reordered before being used. An IBC merge candidate may be selected from the reordered IBC merge candidate list.

In some embodiments, the third predetermined number N of IBC merge candidates may be determined from the IBC merge candidate list according to an ascending order of sum of absolute transformed differences (SATD) costs of IBC merge candidates. An IBC candidate index may be signaled to specify which one is used among the first N IBC merge candidates in an ascending order of SATD costs of IBC merge candidates. In some embodiments, the IBC merge candidates may be reordered before calculating the SATD costs.

In some embodiments, if the combined mode combines an IBC mode and an inter-prediction mode, a regular merge candidate may be selected from a regular merge candidate list to be selected for inter prediction, to generate a second prediction block for the target video block. In some embodiments, a merge candidate index may be included in the bitstream to specify the selected regular merge candidate. This merge candidate index may be signaled to specify which one is used among the regular merge candidates.

In some embodiments, a merge candidate index may be included in the bitstream to specify the selected regular merge candidate among a fourth predetermined number (e.g., N) of regular merge candidates in the regular merge candidate list. This merge candidate index may be signaled to specify which one is used among the first N regular merge candidates. In one example, the regular merge candidates may be reordered before being used. A regular merge candidate may be selected from the reordered regular merge candidate list to generate a second prediction block in the CIIP_N mode.

In some embodiments, the fourth predetermined number N may be set to a predefined value, for example, four, or any other suitable value. In some embodiments, the fourth predetermined number N may be set to a valid number of regular merge candidates in the regular merge candidate list. In some embodiments, the fourth predetermined number N may be set to the number of full RD for inter merge. In some embodiments, the fourth predetermined number N may be set to the number of full RD for inter merge plus an integer. In some embodiments, the fourth predetermined number N may be indicated from an encoder for the video to a decoder for the video.

In some embodiments, the fourth predetermined number of regular merge candidates may be determined from the regular merge candidate list according to an ascending order of SATD costs of regular merge candidates. A merge candidate index may be signaled to specify which one is used among the first N regular merge candidates in the ascending order of SATD costs. In some embodiments, the regular merge candidate list may be reordered before calculating the SATD costs. In one example, N may be set to 4. In one example, N may be set to the valid number of regular merge candidates in the regular merge list. In one example, N may be set to the number of full RD for inter merge. In one example, N may be set to the number of full RD for inter merge plus an integer.

In some embodiments, whether the combined prediction mode (e.g., CIIP_N mode or CIIP_N2 mode) is applied and/or an applying scheme of this mode may be determined based on coding information related to the target video block. The applying scheme may indicate how the CIIP_N mode or CIIP_N2 mode is applied.

In some embodiments, the coding information related to the target video block may include block dimensions, a quantization parameter (QP), a coding mode(s) of at least one neighboring block of the target video block, and/or other coding information. In some embodiments, if the target video block is coded in a merge mode, a flag may be included in the bitstream to indicate if the combined prediction mode is applied to the target video block based on some conditions being satisfied. The merge mode considered here may include an IBC merge mode or a regular merger mode.

In some embodiments, the conditions for including the flag may be based on the block dimension. In some embodiments, when the target video block is coded in an IBC merge mode, if a size of the target video block is larger than or equal to a first threshold, then a flag may be signaled to indicate if the CIIP_N mode is applied to the target video block. In some examples, the first threshold may comprise a threshold total number of luma samples contained in the target video block. For example, if the target video block contains at least P luma samples (that is, block width times block height is equal to or larger than P), a flag may be signaled to indicate if the CIIP_N mode is applied to the target video block. In one example, P may be set to 64. In other examples, P may be set to any other suitable values.

In some embodiments related to the block dimension, when the target video block is coded in an IBC merge mode, if both a block width and a block height of the target video block is less than or equal to a second threshold, then a flag may be signaled to indicate if the CIIP_N mode is applied to the target video block. In some examples, the second threshold may comprise a threshold number of luma samples in block width or block height. For example, if both block width and block height are less than Q luma samples, a flag may be signaled to indicate if the CIIP_N mode is applied to the target video block. In one example, Q may be set to 128. In one example, Q may be set to 64. In other examples, Q may be set to any other suitable values.

In some embodiments, the above two conditions (the first threshold for the block size and the second threshold for the block width and height) may be used together.

In some embodiments, when the target video block is coded in a regular merge mode, if a size of the target video block is larger than or equal to a first threshold, then a flag may be signaled to indicate if the CIIP_N2 mode is applied to the target video block. In some examples, the first threshold may comprise a threshold total number of luma samples contained in the target video block. For example, if the target video block contains at least P luma samples (that is, block width times block height is equal to or larger than P), a flag may be signaled to indicate if the CIIP_N2 mode is applied to the target video block. In one example, P may be set to 64. In other examples, P may be set to any other suitable values.

In some embodiments related to the block dimension, when the target video block is coded in a regular merge mode, if both a block width and a block height of the target video block is less than or equal to a second threshold, then a flag may be signaled to indicate if the CIIP_N2 mode is applied to the target video block. In some examples, the second threshold may comprise a threshold number of luma samples in block width or block height. For example, if both block width and block height are less than Q luma samples, a flag may be signaled to indicate if the CIIP_N2 mode is applied to the target video block. In one example, Q may be set to 128. In one example, Q may be set to 64. In other examples, Q may be set to any other suitable values.

In some embodiments, the above two conditions (the first threshold for the block size and the second threshold for the block width and height) may be used together.

In some embodiments, in the IBC mode based on triangle partitioning, a triangle partition mode (TPM) may be supported for IBC prediction. The IBC mode based on triangle partitioning may be called TPM_IBC mode. In some embodiments, in the IBC mode based on geometric partitioning, a geometric partitioning mode (GPM) may be supported for IBC prediction. The IBC mode based on geometric partitioning may be called GPM_IBC mode.

In either of the TPM_IBC mode or the GPM_IBC mode, the target video block may be split into a first partition and a second partition along a splitting line. In the TPM_IBC mode, the splitting line for splitting the target video block may comprise a diagonal line or an anti-diagonal line.

In some embodiments, in the TPM_IBC mode, the target video block may be split evenly into two triangle-shaped partitions, using either the diagonal split or the anti-diagonal split (as shown in FIG. 43).

In some embodiments, in the TPM_IBC mode, each partition in the target video block may be IBC-predicted using its own motion. Specifically, a first prediction partition for the first partition may be determined using IBC prediction based on first motion information for the first partition; and a second prediction partition for the second partition may be determined using IBC prediction based on second motion information for the second partition.

In some embodiments, in the TPM_IBC mode, uni-prediction motion information for each partition may be derived from a uni-prediction IBC candidate list, to be determined as the first motion information and/or the second motion information. In some embodiments, the uni-prediction IBC candidate list may be derived directly from at least a part or all of an IBC merge candidate list. In some embodiments, the uni-prediction IBC candidate list may be reordered before being used. The uni-prediction motion information may be derived from the reordered uni-prediction IBC candidate list.

In some embodiments, in the TPM_IBC mode, after the first and the second prediction partitions are determined, prediction values of samples along the splitting line (e.g., the diagonal line or anti-diagonal line) may be adjusted using a blending processing with respective weights for the samples. In some embodiments, the weights may be adaptively decided by the distances between the samples and the splitting line. An example for determining the weights may refer to section 2.23.2.

In some embodiments, as an alternative, in the TPM_IBC mode, prediction values of samples along the splitting line may not be adjusted using the blending processing. Instead, a sample along the splitting line may only be predicted based on one of the first and second prediction partitions.

In some embodiments, for motion field storage in the TPM_IBC mode, if a stored motion vector type (represented as “sType”) in an area is set to a first value, the first motion information is stored in a corresponding motion field, and if the stored motion vector type in an area is set to a second value or a third value, the second motion information is stored in the corresponding motion field. In some embodiments, the first value is equal to 0, the second value is equal to 1, and the third value is equal to 2. In an example, if sType is equal to 0, Mv1 may be stored in the corresponding motion field; otherwise, if sType is equal to 1 or 2, Mv2 may be stored. In an example, the calculation of sType is the same as that for inter TPM.

In some embodiments, for signaling of the TPM_IBC mode, an indication of the TPM_IBC mode may be indicated in the bitstream using a CU-level flag as a type of an IBC merge mode.

In some embodiments, for signaling of the TPM_IBC mode, if the TPM_IBC mode is determined to be applied to the target video block (or the current CU), a flag indicating a direction of triangle partitioning (e.g., diagonal or anti-diagonal) may be indicated in the bitstream. Alternatively, or in addition, a first merge index for the first partition and a second merge index for the second partition split from the target video block may also be indicated in the bitstream.

In some embodiments, for signaling of the TPM_IBC mode, if the TPM_IBC mode is determined to be applied to the target video block (or the current CU), a triangle partition index indicating a partition mode of triangle partitioning may be indicated in the bitstream. Alternatively, or in addition, a first merge index for the first partition and a second merge index for the second partition split from the target video block may also be indicated in the bitstream.

In some embodiments, in the GPM_IBC mode, the target video block may be split into the first and second partitions by a geometrically located straight line (e.g. as shown in FIG. 34). In some embodiments, the location of the splitting line nay be mathematically derived from the angle and offset parameters of a specific partition.

In some embodiments, each of the two partitions derived by the geometrical partitioning may be IBC-predicted using its own motion. Specifically, a first prediction partition for the first partition may be determined using IBC prediction based on first motion information for the first partition; and a second prediction partition for the second partition may be determined using IBC prediction based on second motion information for the second partition.

In some embodiments, in the GPM_IBC mode, uni-prediction motion information for each partition may be derived from a uni-prediction IBC candidate list, to be determined as the first motion information and/or the second motion information. In some embodiments, the uni-prediction IBC candidate list may be derived directly from at least a part or all of an IBC merge candidate list. In some embodiments, the uni-prediction IBC candidate list may be reordered before being used. The uni-prediction motion information may be derived from the reordered uni-prediction IBC candidate list.

In some embodiments, in the GPM_IBC mode, after the first and the second prediction partitions are determined, prediction values of samples along the splitting line (e.g., the geometrically located straight line) may be adjusted using a blending processing with respective weights for the samples. In some embodiments, the weights may be adaptively decided by the distances between the samples and the splitting line. An example for determining the weights may refer to section 2.24.2.

In some embodiments, as an alternative, in the GPM_IBC mode, prediction values of samples along the splitting line may not be adjusted using the blending processing. Instead, a sample along the splitting line may only be predicted based on one of the first and second prediction partitions.

In some embodiments, for motion field storage in the GPM_IBC mode, if a stored motion vector type (represented as “sType”) in a motion field is set to a first value, the first motion information or the second motion information is stored in the motion field, and wherein if the stored motion vector type is set to a second value, the second motion information is stored in the motion field. In an example, if sType is equal to 0 or 1, Mv1 or Mv2 may be stored in the corresponding motion field; otherwise, if sType is equal to 2, Mv2 may be stored. In an example, In one example, the calculation of sType is the same as that for inter GPM.

In some embodiments, for signaling of the GPM_IBC mode, an indication of the GPM_IBC mode may be indicated in the bitstream using a CU-level flag as a type of an IBC merge mode.

In some embodiments, for signaling of the GPM_IBC mode, if the GPM_IBC mode is determined to be applied to the target video block (or the current CU), a geometric partition index indicating the partition mode of the geometric partition (angle and offset) may be indicated in the bitstream. Alternatively, or in addition, a first merge index for the first partition and a second merge index for the second partition split from the target video block may also be indicated in the bitstream.

In some embodiments, an IBC AMVP mode based on TM (called TM_AMVP_IBC) may be determined to be applied to the target video block. In some embodiments, in the TM_AMVP_IBC mode, a fifth predetermined number (K) of IBC MVP candidates may be determined by performing template matching. In some examples, the template matching is to select the fifth predetermined number of IBC MVP candidates having the first fifth predetermined number of minimum differences between a current block template and a reference block template from an IBC AMVP list. In some embodiments, K IBC MVP candidates reaching the first K minimum differences between current block template and reference block template may be selected from the IBC AMVP list. In some embodiments, K IBC MVP candidates may comprise a selected set of start-point candidates.

In some embodiments, the template matching (TM) may be performed for the selected set of start-point candidates for MV refinement. In some embodiments, TM may refine a start-point candidate by starting from a full-pel MVD precision within a search range. As an example, the full-pel MVD precision may comprise 4-pel for 4-pel AMVR mode.

In some embodiments, a start-point candidate may be fined within the search range by using iterative diamond search. In some embodiments, the search range may be a [−8, +8]-pel search range. In some embodiments, during the iterative diamond search, a sixth predetermined number (e.g., M) of search rounds may be performed until a center searching point has a minimum matching cost for a diamond search pattern, as shown in FIG. 44A. In some examples, M may be a maximum value of unsigned int (represented as MAX_UNIT). In some examples, M may be 375. In other examples, M may be set in other ways.

In some embodiments, a selected start-point candidate may be further refined by using cross search with a full-pel MVD precision. As an example, the full-pel MVD precision may be 4-pel for a 4-pel AMVR mode. In some embodiments, one search round is used for cross search pattern as shown in FIG. 44B.

In some embodiments, in the TM_AMVP_IBC mode, the fifth predetermined number K of refined IBC MVP candidates may be generated, and one of them may be selected.

In some embodiments, the selecting of the refined IBC MVP candidate may be indicated or signaled from an encoder of the video to a decoder of the video. In some embodiments, if K is one, information about the selecting may not be indicated from the encoder to the decoder. In some embodiments, if at least one refined IBC MVP candidates by template matching is available, the K refined IBC MVP candidates may be used as candidates for the TM_AMVP_IBC mode. Otherwise, if no refined IBC MVP candidates by template matching is available, the first K existing IBC AMVP candidates without refinement may be used.

In some embodiments, a starting point for a block matching based local search or hash-based search of IBC mode may be determined as the selected refined IBC MVP candidate.

In some embodiments, a BV derived by intra template matching for IBC (TM_IBC) may be used as the starting point for a block matching based local search or hash-based search of IBC mode.

In some embodiments, if IBC adaptive motion vector resolution (AMVR) is enabled, a refined IBC AMVP candidate in a MVD precision is reused in at least one further MVD precision. In some embodiments, the refined IBC AMVP candidate in a full-pel MVD precision is reused in a 4-pel MVD precision.

In some embodiments, the IBC merge mode based on TM (called TM_merge_IBC) may be supported and to be applied for the target video block. In some embodiments, in the TM_merge_IBC mode, a seventh predetermined number (e.g., K) of IBC merge candidates may be determined by performing template matching. In some examples, the template matching is to select the seventh predetermined number of IBC merge candidates having the first seventh predetermined number of minimum differences between a current block template and a reference block template from an IBC merge list. In some embodiments, K IBC merge candidates reaching the first K minimum difference between current block template and reference block template may be selected from the IBC merge list. In some embodiments, K IBC merge candidates may comprise a selected set of start-point candidates.

In some embodiments, the template matching (TM) may be performed for the selected set of start-point candidates for MV refinement. In some embodiments, TM may refine a start-point candidate by starting from a full-pel MVD precision within a search range. In some embodiments, TM may refine a start-point candidate by starting from a 4-pel MVD precision within a search range for a 4-pel AMVR mode.

In some embodiments, a selected start-point candidate may be refined within the search range by using iterative diamond search. In some embodiments, the search range may be a [−8, +8]-pel search range. In some embodiments, during the iterative diamond search, a sixth predetermined number (e.g., M) of search rounds may be performed until a center searching point has a minimum matching cost for a diamond search pattern, as shown in FIG. 44A. In some examples, M may be a maximum value of unsigned int (represented as MAX_UNIT). In some examples, M may be 375. In other examples, M may be set in other ways.

In some embodiments, a selected start-point candidate may be further refined by using cross search with a full-pel MVD precision. In some embodiments, a selected start-point candidate may be further refined by using cross search with a 4-pel MVD precision for a 4-pel AMVR mode. In some embodiments, one search round is used for cross search pattern as shown in FIG. 44B.

In some embodiments, in the TM_merge_IBC mode, the fifth predetermined number K of refined IBC merge candidates may be generated, and one of them may be selected.

In some embodiments, the selecting of the refined IBC merge candidate may be indicated or signaled from an encoder of the video to a decoder of the video. In some embodiments, if K is one, information about the selecting may not be indicated from the encoder to the decoder. In some embodiments, if at least one refined IBC merge candidates by template matching is available, the K refined IBC merge candidates may be used as candidates for the TM_merge_IBC mode. Otherwise, if no refined IBC merge candidates by template matching is available, the TM_merge_IBC mode may be invalid. In some embodiments, the best TM refined IBC merge candidate may be selected by a criterion. In some examples, the criterion may be based on a RD decision.

In some embodiments, the template matching may be performed for IBC merge candidates for MV refinement, to obtain TM refined IBC merge candidates. Then, the best TM refined IBC merge candidate may be selected by a criterion. In some examples, the criterion may be based on a RD decision.

According to embodiments of the present disclosure, it is proposed that more IBC-based modes are supported and corresponding implementations in respective IBC-based modes are provided. In this way, IBC coding may be further improved, and thus, the coding efficiency of IBC mode may be improved.

Implementations of the present disclosure can be described in view of the following clauses, the features of which can be combined in any reasonable manner.

Clause 1. A method for video processing, comprising: determining, during a conversion between a target video block of a video and a bitstream of the video, an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; and performing the conversion based on the IBC-based mode.

Clause 2. The method of clause 1, wherein the IBC MBVD mode is to be applied, the method further comprising: generating, in the IBC MBVD mode, a block vector (BV) based on at least one IBC merge candidate; and refining the BV based on block vector difference (BVD) information.

Clause 3. The method of clause 2, wherein the BVD information comprises at least one of the following: at least one IBC merge candidate index, at least one indication for at least one motion magnitude, at least one indication for at least one motion direction.

Clause 4. The method of clause 2 or 3, wherein the BV is within a valid range of BV, and wherein BVD information for driving a BV out of the valid range of BV is excluded from BVD information set to be selected or signaled.

Clause 5. The method of any of clauses 2-4, wherein generating the BV comprises: in accordance with a determination that a BV derived from the BVD information is out of a valid range of BV, applying a clipping process to the BV out of the valid range, to obtain a BV within the valid range.

Clause 6. The method of any of clauses 2-4, wherein generating the BV comprises: generating the BV according to a bitstream conformance constraint, the bitstream conformance constraint specifying the BV to be within a valid range of BV.

Clause 7. The method of any of clauses 2-6, further comprising: selecting the at least one IBC merge candidate from an IBC merge candidate list, and wherein at least one MBVD candidate index is included in the bitstream to specify the at least one selected IBC merge candidate.

Clause 8. The method of clause 7, wherein a MBVD candidate index is included in the bitstream to specify a selected IBC merge candidate among a first predetermined number of IBC merge candidates in the IBC merge candidate list.

Clause 9. The method of clause 8, wherein the first predetermined number is two.

Clause 10. The method of clause 8 or 9, wherein the MBVD candidate index is binarized as a truncated code, with a maximum value equal to the first predetermined number minus one.

Clause 11. The method of any of clauses 7-10, wherein selecting the at least one IBC merge candidate comprises: reordering the IBC merge candidate list; and selecting at least one IBC merge candidate from the reordered IBC merge candidate list.

Clause 12. The method of clause 3, wherein the at least one indication for at least one motion magnitude comprises a distance index indicating a predefined offset from a starting point.

Clause 13. The method of clause 12, wherein the predefined offset comprises an offset added to a horizontal component or a vertical component of a starting block vector (BV).

Clause 14. The method of clause 12, wherein the predefined offset comprises an offset added to both a horizontal component and a vertical component of a starting BV.

Clause 15. The method of clause 12, wherein the predefined offset is one of 1 pixel, 2 pixels, 4 pixels, 8 pixels, 16 pixels, or 32 pixels.

Clause 16. The method of clause 12, wherein the predefined offset is one of 1 pixel, 2 pixels, 4 pixels, 8 pixels, 16 pixels, 32 pixels, 64 pixels, or 128 pixels.

Clause 17. The method of clause 12, wherein the predefined offset is one of 1 pixel, 2 pixels, 3 pixels, 4 pixels, 6 pixels, 8 pixels, or 16 pixels.

Clause 18. The method of clause 12, wherein the predefined offset is one of 1 pixel, 2 pixels, 3 pixels, 4 pixels, 6 pixels, 8 pixels, 16 pixels, 32 pixels, or 64 pixels.

Clause 19. The method of any of clauses 12-18, wherein a relation between respective distance indices and predefined offsets is indicated from an encoder for the video to a decoder for the video at one of a sequence level, a picture level, a slice level, a coding tree unit (CTU) level, or a coding unit (CU) level.

Clause 20. The method of clause 3, wherein the at least one indication for at least one motion direction comprises a direction index indicating a predefined direction of BVD relative to a starting point, and wherein the direction index represents an BVD direction among a second predetermined number of BVD directions.

Clause 21. The method of clause 20, wherein the second predetermined number is four or eight.

Clause 22. The method of clause 21, wherein the second predetermined number is four, and the second predetermined number of BVD directions comprise four horizontal/vertical directions, or four diagonal directions.

Clause 23. The method of clause 22, wherein the direction index is one of the following: a first direction index indicating a positive sign of a block vector (BV) offset in a horizontal component, a second direction index indicating a negative sign of the BV offset in the horizontal component, a third direction index indicating a positive sign of the BV offset in a vertical component, or a fourth direction index indicating a negative sign of the BV offset in the vertical component.

Clause 24. The method of clause 22, wherein the second predetermined number is four, and the direction index is one of the following: a first direction index indicating a positive sign of a block vector (BV) offset in a horizontal component and a positive sign of the BV offset in a vertical component, a second direction index indicating a positive sign of the BV offset in the horizontal component and a negative sign of the BV offset in the vertical component, a third direction index indicating a negative sign of the BV offset in the horizontal component and a positive sign of the BV offset in the vertical component, or a fourth direction index indicating a negative sign of the BV offset in the horizontal component and a negative sign of the BV offset in the vertical component.

Clause 25. The method of clause 21, wherein the second predetermined number is eight, and the second predetermined number of BVD directions comprise four horizontal/vertical directions, and four diagonal directions.

Clause 26. The method of clause 25, wherein the direction index is one of the following: a first direction index indicating a positive sign of a block vector (BV) offset in a horizontal component, a second direction index indicating a negative sign of the BV offset in the horizontal component, a third direction index indicating a positive sign of the BV offset in a vertical component, a fourth direction index indicating a negative sign of the BV offset in the vertical component, a fifth direction index indicating a positive sign of a motion vector (BV) offset in a horizontal component and a positive sign of the BV offset in a vertical component, a sixth direction index indicating a positive sign of the BV offset in the horizontal component and a negative sign of the BV offset in the vertical component, a seventh direction index indicating a negative sign of the BV offset in the horizontal component and a positive sign of the BV offset in the vertical component, or an eighth direction index indicating a negative sign of the BV offset in the horizontal component and a negative sign of the BV offset in the vertical component.

Clause 27. The method of clause 12 or clause 20, wherein at least one of the distance index or the direction index is binarized based on at least one of the following: unary coding, truncated unary coding, exponential-Golomb code, truncated exponential-Golomb code, or fixed length code.

Clause 28. The method of clause 3, wherein the number of the at least one motion magnitude and/or the number of the at least one motion direction is determined based on at least one of the following: a resolution of a picture, a configuration of a coding process, or BVD information of at least one neighbouring block of the target video block.

Clause 29. The method of clause 28, wherein the at least one neighbouring block comprises an above neighbouring block and a left neighbouring block.

Clause 30. The method of clause 28, wherein the at least one neighbouring block comprises at least one adjacent spatial neighbouring block, the at least one adjacent spatial neighbouring block comprising at least one of the following: a left spatial neighbouring block, an above spatial neighbouring block, an above-right spatial neighbouring block, a bottom-left spatial neighbouring block, or an above-left spatial neighbouring block.

Clause 31. The method of any of clauses 28-30, wherein the number of the at least one motion magnitude and/or the number of the at least one motion direction is indicated from an encoder for the video to a decoder for the video at one of a sequence level, a picture level, a slice level, a coding tree unit (CTU) level, or a coding unit (CU) level.

Clause 32. The method of clause 1, wherein the combined prediction mode based on an IBC mode and at least one further prediction mode is to be applied, and the at least one further prediction mode comprises an intra-prediction mode or an inter-prediction mode.

Clause 33. The method of clause 32, wherein the intra-prediction mode comprises one of the following: a planar prediction mode, an intra-prediction mode derived by decoder side intra mode derivation (DIMD), or an intra-prediction mode derived by template-based intra mode derivation (TIMD).

Clause 34. The method of clause 1, wherein the combined prediction mode based on an IBC mode and at least one further prediction mode is to be applied, and the method further comprising: generating at least one first prediction block for the target video block based on the IBC mode; generating at least one second prediction block for the target video block based on the at least one further prediction mode; determining a target prediction block for the target video block at least based on a weighted combination of the at least one first prediction block and the at least one second prediction block.

Clause 35. The method of clause 34, wherein the target prediction signal is determined further based on an offset, the offset being an integer.

Clause 36. The method of clause 34, wherein at least one first weight of the at least one first prediction block and at least one second weight of the at least one second prediction block are determined based on a weight parameter and a predetermined value.

Clause 37. The method of any of clauses 34-36, wherein the target prediction block is determined by: P_{CIIP_N} ((2^{N}−wt)*P_{IBC}+wt*P_{sec}+offset)>>N, where P_{CIIP_N} represents the target prediction block, P_{IBC} represents a first prediction block, P_{sec} represents a second prediction block, offset represents the offset, wt represents the weight parameter, and N represents the predetermined value.

Clause 38. The method of clause 36 or 37, wherein the predetermined value is 2.

Clause 39. The method of any of clauses 36-38, wherein a value of the weight parameter is predefined or is determined based on a position for a sample.

Clause 40. The method of clause 39, wherein the value of the weight parameter is predefined to 2.

Clause 41. The method of clause 39, wherein a value of the weight parameter for a first position is determined as the predetermined value power of 2, and a value of the weight parameter for a second position is determined as zero.

Clause 42. The method of any of clauses 35-41, wherein a value of the weight parameter is indicated from an encoder for the video to a decoder for the video.

Clause 43. The method of clause 34, wherein generating the at least one first prediction block based on the IBC mode comprises: generating the at least one first prediction block using an IBC prediction process applied in an IBC merge mode.

Clause 44. The method of any of clauses 36-38, wherein a value of the weight parameter is determined based on at least one of the following: availability of at least one neighbouring block of the target video block, and at least one coding mode of at least one neighbouring block of the target video block.

Clause 45. The method of clause 44, wherein the at least one neighbouring block comprises a top neighbouring block and a left neighbouring block.

Clause 46. The method of cl Clause 45, wherein the value of the weight parameter is determined based on the following: setting the weight parameter to a first value if both the top neighbouring block and the left neighbouring block are available and are intra coded or IBC coded; setting the weight parameter to a second value if one of the top neighbouring block and the left neighbouring block is available and is intra coded or IBC coded; and setting the weight parameter to a third value if none of the top neighbouring block and the left neighbouring block is available and is intra coded or IBC coded.

Clause 47. The method of clause 34, wherein generating the at least one first prediction block for the target video block based on the IBC mode comprises: selecting an IBC merge candidate from an IBC merge candidate list; and generating a first prediction block based on the IBC merge candidate, and wherein an IBC merge candidate index is included in the bitstream to specify the selected IBC merge candidate.

Clause 48. The method of clause 47, wherein the IBC merge candidate index is included in the bitstream to specify the selected IBC merge candidate among a third predetermined number of IBC merge candidates in the IBC merge candidate list.

Clause 49. The method of clause 48, wherein the third predetermined number is set to one of the following: a predefined value of four, a valid number of IBC merge candidates in the IBC merge candidate list, the number of full rate distortion (RD) for IBC merge, or the number of full RD for IBC merge plus an integer.

Clause 50. The method of clause 48 or 49, wherein the third predetermined number is indicated from an encoder for the video to a decoder for the video.

Clause 51. The method of any of clauses 48-50, wherein the third predetermined number of IBC merge candidates are determined from the IBC merge candidate list according to an ascending order of sum of absolute transformed differences (SATD) costs of IBC merge candidates.

Clause 52. The method of any of clauses 47-50, wherein selecting an IBC merge candidate from an IBC merge candidate list comprises: reordering the IBC merge candidate list; and selecting the IBC merge candidate from the reordered IBC merge candidate list.

Clause 53. The method of clause 52, wherein the SATD costs are determined after the IBC merge candidate list is reordered.

Clause 54. The method of clause 34, wherein the at least one further prediction mode comprises an inter-prediction mode, and wherein generating the at least one second prediction block for the target video block comprises: selecting a regular merge candidate from a regular merge candidate list; and generating a second prediction block based on the regular merge candidate, and wherein a merge candidate index is included in the bitstream to specify the selected regular merge candidate.

Clause 55. The method of clause 54, wherein the merge candidate index is included in the bitstream to specify the selected regular merge candidate among a fourth predetermined number of regular merge candidates in the regular merge candidate list.

Clause 56. The method of clause 55, wherein the fourth predetermined number is set to one of the following: a predefined value of four, a valid number of regular merge candidates in the regular merge candidate list, the number of full RD for inter merge, or the number of full RD for inter merge plus an integer.

Clause 57. The method of clause 55 or 56, wherein the fourth predetermined number is indicated from an encoder for the video to a decoder for the video.

Clause 58. The method of any of clauses 55-57, wherein the fourth predetermined number of regular merge candidates are determined from the regular merge candidate list according to an ascending order of SATD costs of regular merge candidates.

Clause 59. The method of any of clauses 55-58, wherein selecting a regular merge candidate from a regular merge candidate list comprises: reordering the regular merge candidate list; and selecting the regular merge candidate from the reordered regular merge candidate list.

Clause 60. The method of clause 58, wherein the SATD costs are determined after the regular merge candidate list is reordered.

Clause 61. The method of clause 1, wherein determining the IBC-based mode to be applied comprises: determining, based on coding information related to the target video block, whether the combined prediction mode is to be applied and/or an applying scheme of the combined prediction mode.

Clause 62. The method of clause 61, wherein the coding information comprises at least one of the following: a block dimension, a quantization parameter (QP), or a coding mode of at least one neighboring block of the target video block.

Clause 63. The method of clause 62, wherein if the target video block is coded in a merge mode, a flag is included in the bitstream to indicate if the combined prediction mode is applied to the target video block based on at least one of the following: a size of the target video block is larger than or equal to a first threshold, or a block width and a block height of the target video block is less than or equal to a second threshold.

Clause 64. The method of clause 63, wherein the merge mode comprises an IBC merge mode or a regular merge mode.

Clause 65. The method of clause 63 or 64, wherein the first threshold comprises 64 luma samples.

Clause 66. The method of any of clauses 63-65, wherein the second threshold comprises 128 luma samples or 64 luma samples.

Clause 67. The method of clause 1, further comprising: in the IBC mode based on triangle partitioning or the IBC mode based on geometric partitioning, splitting the target video block into a first partition and a second partition along a splitting line.

Clause 68. The method of clause 67, wherein in the IBC mode based on triangle partitioning, the splitting line comprises a diagonal line or an anti-diagonal line.

Clause 69. The method of clause 67, wherein in the IBC mode based on geometric partitioning, the splitting line comprises a geometrically located straight line.

Clause 70. The method of any of clauses 67-69, further comprising: determining, using IBC prediction, a first prediction partition for the first partition based on first motion information for the first partition; and determining, using IBC prediction, a second prediction partition for the second partition based on second motion information for the second partition.

Clause 71. The method of clause 70, further comprising: deriving uni-prediction motion information from a uni-prediction IBC candidate list to obtain the first motion information and the second motion information.

Clause 72. The method of clause 70, wherein the uni-prediction IBC candidate list is derived from at least a part of an IBC merge candidate list.

Clause 73. The method of clause 71 or 72, wherein deriving the uni-prediction motion information comprises: reordering the uni-prediction IBC candidate list; and deriving the uni-prediction motion information from the reordered uni-prediction IBC candidate list.

Clause 74. The method of any of clauses 70-73, further comprising: after the first and the second prediction partitions are determined, adjusting prediction values of samples along the splitting line using a blending processing with respective weights for the samples.

Clause 75. The method of clause 74, wherein a weight for a sample is determined based on a distance between the sample and the splitting line.

Clause 76. The method of any of clauses 70-73, further comprising: determining a prediction value of a sample along the splitting line based on one of the first and the second prediction partitions.

Clause 77. The method of any of clauses 70-76, wherein if a stored motion vector type in an area is set to a first value, the first motion information is stored in a corresponding motion field, and wherein if the stored motion vector type in an area is set to a second value or a third value, the second motion information is stored in the corresponding motion field, and wherein the first value is equal to 0, the second value is equal to 1, and the third value is equal to 2.

Clause 78. The method of any of clauses 69-77, wherein an indication of the IBC mode based on triangle partitioning or geometric partitioning is indicated in the bitstream using a CU-level flag as a type of an IBC merge mode.

Clause 79. The method of any of clauses 67-78, wherein if the IBC mode based on triangle partitioning is determined to be applied to the target video block, at least one of the following is indicated in the bitstream: a flag indicating a direction of triangle partitioning, a triangle partition index indicating a partition mode of triangle partitioning, a first merge index for the first partition, or a second merge index for the second partition.

Clause 80. The method of any of clauses 67-78, wherein if the IBC mode based on geometric partitioning is applied to the target video block, at least one of the following is indicated in the bitstream: a geometric partition index indicating a partition mode for geometric partitioning, a first merge index for the first partition, or a second merge index for the second partition.

Clause 81. The method of clause 1, further comprising: determining, in an IBC AMVP mode based on TM, a fifth predetermined number of IBC MVP candidates by performing template matching, the fifth predetermined number of IBC MVP candidates having the first fifth predetermined number of minimum differences between a current block template and a reference block template from an IBC AMVP list.

Clause 82. The method of clause 81, wherein the fifth predetermined number of IBC MVP candidates comprises a selected set of start-point candidates.

Clause 83. The method of clause 82, further comprising: performing the template matching for the selected set of start-point candidates for MV refinement.

Clause 84. The method of clause 83, wherein performing the template matching comprises: refining a start-point candidate by starting from a full-pel MVD precision within a search range.

Clause 85. The method of Clause 83, wherein performing the template matching comprises: refining a start-point candidate by starting from a 4-pel MVD precision within a search range for a 4-pel adaptive motion vector resolution (AMVR) mode.

Clause 86. The method of clause 84 or 85, wherein refining the start-point candidate comprises: refining the start-point candidate within the search range by using iterative diamond search.

Clause 87. The method of clause 86, wherein during the iterative diamond search, a sixth predetermined number of search rounds are performed until a center searching point has a minimum matching cost for a diamond search pattern.

Clause 88. The method of clause 87, wherein the sixth predetermined number comprises a maximum value of unsigned int or 375.

Clause 89. The method of clause 84, further comprising: further refining the start-point candidate by using cross search with a full-pel MVD precision.

Clause 90. The method of Clause 85, wherein performing the template matching comprises: further refining the start-point candidate by using cross search with a 4-pel MVD precision for a 4-pel AMVR mode.

Clause 91. The method of clause 89 or 90, wherein one search round is used for a cross search pattern.

Clause 92. The method of any of clauses 81-91, further comprising: generating the fifth predetermined number of refined IBC MVP candidates, and selecting one of the fifth predetermined number of refined IBC MVP candidates.

Clause 93. The method of clause 92, wherein information about the selecting is indicated from an encoder of the video to a decoder of the video.

Clause 94. The method of clause 93, wherein if the fifth predetermined number is one, the information about the selecting is not indicated.

Clause 95. The method of any of clauses 92-94, further comprising: if at least one refined IBC MVP candidates by template matching is available, determining the fifth predetermined number of refined IBC MVP candidates as candidates for the IBC AMVP mode based on TM; and if no refined IBC MVP candidates by template matching is unavailable, determining the fifth predetermined number of existing IBC MVP candidates without refinement as candidates for the AMVP IBC mode based on TM.

Clause 96. The method of clause 92, wherein a starting point for a block matching based local search or hash-based search is determined as the selected refined IBC MVP candidate, or a BV derived by intra template matching for IBC (TM_IBC).

Clause 97. The method of clause 92, wherein if IBC adaptive motion vector resolution (AMVR) is enabled, a refined IBC AMVP candidate in a MVD precision is reused in at least one further MVD precision.

Clause 98. The method of clause 97, wherein the refined IBC AMVP candidate in a full-pel MVD precision is reused in a 4-pel MVD precision.

Clause 99. The method of clause 1, further comprising: determining, in the IBC merge mode based on TM, a seventh predetermined number of IBC merge candidates by performing template matching, the seventh predetermined number of IBC merge candidates having the first seventh predetermined number of minimum differences between a current block template and a reference block template from an IBC merge list.

Clause 100. The method of clause 99, wherein the seventh predetermined number of IBC merge candidates comprises a selected set of start-point candidates.

Clause 101. The method of clause 100, further comprising: performing the template matching for the selected set of start-point candidates for MV refinement.

Clause 102. The method of clause 101, wherein performing the template matching comprises: refining a start-point candidate by starting from a full-pel MVD precision within a search range.

Clause 103. The method of clause 102, wherein refining the start-point candidate comprises: refining the start-point candidate within the search range by using iterative diamond search.

Clause 104. The method of clause 103, wherein during the iterative diamond search, an eighth predetermined number of search rounds are performed until a center searching point has a minimum matching cost for a diamond search pattern.

Clause 105. The method of clause 104, wherein the eighth predetermined number comprises a maximum value of unsigned int or 375.

Clause 106. The method of any of clauses 102-105, further comprising: further refining the start-point candidate by using cross search with a full-pel MVD precision.

Clause 107. The method of clause 106, wherein one search round is used for a cross search pattern.

Clause 108. The method of any of clauses 99-107, further comprising: generating the seventh predetermined number of refined IBC merge candidates, and selecting one of the seventh predetermined number of refined IBC merge candidates.

Clause 109. The method of clause 108, wherein information about the selecting is indicated from an encoder of the video to a decoder of the video.

Clause 110. The method of clause 109, wherein if the seventh predetermined number is one, the information about the selecting is not indicated.

Clause 111. The method of any of clauses 108-110, further comprising: if at least one refined IBC merge candidates by template matching is available, determining the seventh predetermined number of refined IBC merge candidates as candidates for the IBC merge mode based on TM; and if no refined IBC merge candidates by template matching is available, determining that the IBC merge mode based on TM is invalid.

Clause 112. The method of any of clauses 108-111, wherein selecting the refined IBC merge candidate comprises: selecting the refined IBC merge candidate based on a RD decision.

Clause 113. The method of clause 99, further comprising: performing the template matching for all IBC merge candidates for MV refinement, to obtain TM refined IBC merge candidates.

Clause 114. The method of clause 113, further comprising: selecting one of the TM refined IBC merge candidates based on a RD decision.

Clause 115. The method of any of clauses 1-114, wherein in the IBC-based mode, prediction samples are at least derived from blocks of sample values of a same video region as determined by block vectors.

Clause 116. The method of any of clauses 1-115, wherein the conversion includes encoding the target video block into the bitstream.

Clause 117. The method of any of clauses 1-115, wherein the conversion includes decoding the target video block from the bitstream.

Clause 118. An apparatus for processing video data comprising a processor and a non-transitory memory with instructions thereon, wherein the instructions upon execution by the processor, cause the processor to perform a method in accordance with any of clauses 1-117.

Clause 119. A non-transitory computer-readable storage medium storing instructions that cause a processor to perform a method in accordance with any of clauses 1-117.

Clause 120. A non-transitory computer-readable recording medium storing a bitstream of a video which is generated by a method performed by a video processing apparatus, wherein the method comprises: determining an intra block copy (IBC)-based mode to be applied for the target video block, the IBC-based mode being based on at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; and generating the bitstream based on the IBC-based mode.

Clause 121. A method for storing a bitstream of a video, comprising: determining an intra block copy (IBC)-based mode to be applied for the target video block, the IBC-based mode being at least one of the following: an IBC merge mode with block vector difference (MBVD), a combined prediction mode based on an IBC mode and at least one further prediction mode, an IBC mode based on triangle partitioning, an IBC mode based on geometric partitioning, an IBC advanced motion vector prediction (AMVP) mode based on template matching (TM), or an IBC merge mode based on TM; generating the bitstream based on the IBC-based mode; and storing the bitstream in a non-transitory computer-readable recording medium.

### Example Device

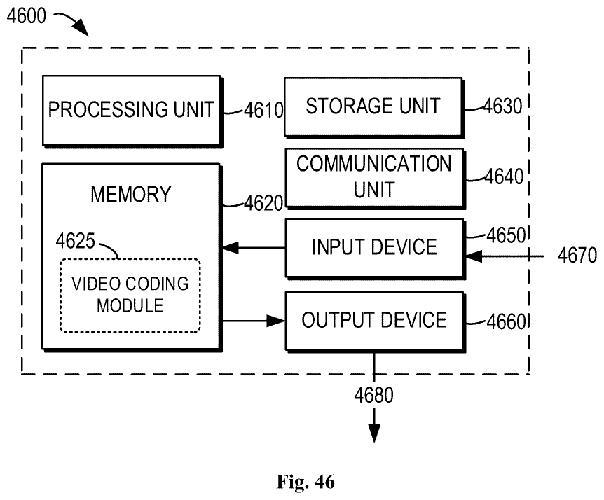

FIG. 46 illustrates a block diagram of a computing device 4600 in which various embodiments of the present disclosure can be implemented. The computing device 4600 may be implemented as or included in the source device 110 (or the video encoder 114 or 200) or the destination device 120 (or the video decoder 124 or 300).

It would be appreciated that the computing device 4600 shown in FIG. 46 is merely for purpose of illustration, without suggesting any limitation to the functions and scopes of the embodiments of the present disclosure in any manner.

As shown in FIG. 46, the computing device 4600 includes a general-purpose computing device 4600. The computing device 4600 may at least comprise one or more processors or processing units 4610, a memory 4620, a storage unit 4630, one or more communication units 4640, one or more input devices 4650, and one or more output devices 4660.

In some embodiments, the computing device 4600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 4600 can support any type of interface to a user (such as “wearable” circuitry and the like).

The processing unit 4610 may be a physical or virtual processor and can implement various processes based on programs stored in the memory 4620. In a multi-processor system, multiple processing units execute computer executable instructions in parallel so as to improve the parallel processing capability of the computing device 4600. The processing unit 4610 may also be referred to as a central processing unit (CPU), a microprocessor, a controller or a microcontroller.

The computing device 4600 typically includes various computer storage medium. Such medium can be any medium accessible by the computing device 4600, including, but not limited to, volatile and non-volatile medium, or detachable and non-detachable medium. The memory 4620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 4630 may be any detachable or non-detachable medium and may include a machine-readable medium such as a memory, flash memory drive, magnetic disk or another other media, which can be used for storing information and/or data and can be accessed in the computing device 4600.

The computing device 4600 may further include additional detachable/non-detachable, volatile/non-volatile memory medium. Although not shown in FIG. 46, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 4640 communicates with a further computing device via the communication medium. In addition, the functions of the components in the computing device 4600 can be implemented by a single computing cluster or multiple computing machines that can communicate via communication connections. Therefore, the computing device 4600 can operate in a networked environment using a logical connection with one or more other servers, networked personal computers (PCs) or further general network nodes.

The input device 4650 may be one or more of a variety of input devices, such as a mouse, keyboard, tracking ball, voice-input device, and the like. The output device 4660 may be one or more of a variety of output devices, such as a display, loudspeaker, printer, and the like. By means of the communication unit 4640, the computing device 4600 can further communicate with one or more external devices (not shown) such as the storage devices and display device, with one or more devices enabling the user to interact with the computing device 4600, or any devices (such as a network card, a modem and the like) enabling the computing device 4600 to communicate with one or more other computing devices, if required. Such communication can be performed via input/output (I/O) interfaces (not shown).

In some embodiments, instead of being integrated in a single device, some or all components of the computing device 4600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 4600 may be used to implement video encoding/decoding in embodiments of the present disclosure. The memory 4620 may include one or more video coding modules 4625 having one or more program instructions. These modules are accessible and executable by the processing unit 4610 to perform the functionalities of the various embodiments described herein.

In the example embodiments of performing video encoding, the input device 4650 may receive video data as an input 4670 to be encoded. The video data may be processed, for example, by the video coding module 4625, to generate an encoded bitstream. The encoded bitstream may be provided via the output device 4660 as an output 4680.

In the example embodiments of performing video decoding, the input device 4650 may receive an encoded bitstream as the input 4670. The encoded bitstream may be processed, for example, by the video coding module 4625, to generate decoded video data. The decoded video data may be provided via the output device 4660 as the output 4680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, an intra block copy (IBC)-based mode to be applied for the target video block, the IBC-based mode being based on at least one of the following:
an IBC merge mode with block vector difference (MBVD),
a combined prediction mode based on an IBC mode and at least one further prediction mode,
an IBC mode based on triangle partitioning,
an IBC mode based on geometric partitioning,
an IBC advanced motion vector prediction (AMVP) mode based on template matching (TM), or
an IBC merge mode based on TM; and
performing the conversion based on the IBC-based mode.

2. The method of claim 1, wherein the IBC MBVD mode is to be applied, the method further comprising:
generating, in the IBC MBVD mode, a block vector (BV) based on at least one IBC merge candidate; and
refining the BV based on block vector difference (BVD) information,
wherein the BVD information comprises at least one of the following:
at least one IBC merge candidate index,
at least one indication for at least one motion magnitude,
at least one indication for at least one motion direction,
wherein the BV is within a valid range of BV, and wherein BVD information for driving a BV out of the valid range of BV is excluded from BVD information set to be selected or signaled.

3. The method of claim 2, wherein generating the BV comprises:
in accordance with a determination that a BV derived from the BVD information is out of a valid range of BV, applying a clipping process to the BV out of the valid range, to obtain a BV within the valid range, or
generating the BV according to a bitstream conformance constraint, the bitstream conformance constraint specifying the BV to be within a valid range of BV,
wherein the method further comprises:
selecting the at least one IBC merge candidate from an IBC merge candidate list, and
wherein at least one MBVD candidate index is included in the bitstream to specify the at least one selected IBC merge candidate,
wherein a MBVD candidate index is included in the bitstream to specify a selected IBC merge candidate among a first predetermined number of IBC merge candidates in the IBC merge candidate list.

4. The method of claim 1, wherein the combined prediction mode based on an IBC mode and at least one further prediction mode is to be applied, and the at least one further prediction mode comprises an intra-prediction mode or an inter-prediction mode,
wherein the intra-prediction mode comprises one of the following:
a planar prediction mode,
an intra-prediction mode derived by decoder side intra mode derivation (DIMD), or
an intra-prediction mode derived by template-based intra mode derivation (TIMD).

5. The method of claim 1, wherein the combined prediction mode based on an IBC mode and at least one further prediction mode is to be applied, and the method further comprising:
generating at least one first prediction block for the target video block based on the IBC mode;
generating at least one second prediction block for the target video block based on the at least one further prediction mode; and
determining a target prediction block for the target video block at least based on a weighted combination of the at least one first prediction block and the at least one second prediction block,
wherein the target prediction signal is determined further based on an offset, the offset being an integer,
wherein at least one first weight of the at least one first prediction block and at least one second weight of the at least one second prediction block are determined based on a weight parameter and a predetermined value.

6. The method of claim 5, wherein the target prediction block is determined by:
$${P}_{CIIP\_N} = ( ( {2}^{N} - wt ) * {P}_{IBC} + wt * {P}_{s e c} + offset ) ≫ N$$
where P_{CIIP_N} represents the target prediction block,
P_{IBC} represents a first prediction block,
P_{Sec} represents a second prediction block,
offset represents the offset,
wt represents the weight parameter, and
N represents the predetermined value,
wherein the predetermined value is 2,
wherein a value of the weight parameter is predefined or is determined based on a position for a sample, wherein the value of the weight parameter is predefined to 2; or wherein a value of the weight parameter for a first position is determined as the predetermined value power of 2, and a value of the weight parameter for a second position is determined as zero.

7. The method of claim 1, wherein determining the IBC-based mode to be applied comprises:
determining, based on coding information related to the target video block, whether the combined prediction mode is to be applied and/or an applying scheme of the combined prediction mode,
wherein the coding information comprises at least one of the following:
a block dimension,
a quantization parameter (QP), or
a coding mode of at least one neighboring block of the target video block;
wherein if the target video block is coded in a merge mode, a flag is included in the bitstream to indicate if the combined prediction mode is applied to the target video block based on at least one of the following:
a size of the target video block is larger than or equal to a first threshold, or
a block width and a block height of the target video block is less than or equal to a second threshold,
wherein the merge mode comprises an IBC merge mode or a regular merge mode.

8. The method of claim 1, further comprising:
in the IBC mode based on triangle partitioning or the IBC mode based on geometric partitioning, splitting the target video block into a first partition and a second partition along a splitting line,
wherein in the IBC mode based on triangle partitioning, the splitting line comprises a diagonal line or an anti-diagonal line, and/or wherein in the IBC mode based on geometric partitioning, the splitting line comprises a geometrically located straight line,
wherein an indication of the IBC mode based on triangle partitioning or geometric partitioning is indicated in the bitstream using a CU-level flag as a type of an IBC merge mode.

9. The method of claim 8, wherein if the IBC mode based on geometric partitioning is applied to the target video block, at least one of the following is indicated in the bitstream:
a geometric partition index indicating a partition mode for geometric partitioning,
a first merge index for the first partition, or
a second merge index for the second partition.

10. The method of claim 1, further comprising:
determining, in an IBC AMVP mode based on TM, a fifth predetermined number of IBC MVP candidates by performing template matching, the fifth predetermined number of IBC MVP candidates having the first fifth predetermined number of minimum differences between a current block template and a reference block template from an IBC AMVP list,
wherein the fifth predetermined number of IBC MVP candidates comprises a selected set of start-point candidates.

11. The method of claim 10, further comprising:
performing the template matching for the selected set of start-point candidates for MV refinement, and
wherein performing the template matching comprises:
refining a start-point candidate by starting from a full-pel MVD precision within a search range, or
refining a start-point candidate by starting from a 4-pel MVD precision within a search range for a 4-pel adaptive motion vector resolution (AMVR) mode.

12. The method of claim 11, wherein refining the start-point candidate comprises:
refining the start-point candidate within the search range by using iterative diamond search,
wherein during the iterative diamond search, a sixth predetermined number of search rounds are performed until a center searching point has a minimum matching cost for a diamond search pattern.

13. The method of claim 1, further comprising:
determining, in the IBC merge mode based on TM, a seventh predetermined number of IBC merge candidates by performing template matching, the seventh predetermined number of IBC merge candidates having the first seventh predetermined number of minimum differences between a current block template and a reference block template from an IBC merge list.

14. The method of claim 13, wherein the seventh predetermined number of IBC merge candidates comprises a selected set of start-point candidates, the method further comprising:
performing the template matching for the selected set of start-point candidates for MV refinement by:
refining a start-point candidate by starting from a full-pel MVD precision within a search range and using iterative diamond search, and
further refining the start-point candidate by using cross search with a full-pel MVD precision, wherein one search round is used for a cross search pattern; or
wherein the method further comprises:
performing the template matching for all IBC merge candidates for MV refinement, to obtain TM refined IBC merge candidates; and
selecting one of the TM refined IBC merge candidates based on a RD decision.

15. The method of claim 14, wherein during the iterative diamond search, an eighth predetermined number of search rounds are performed until a center searching point has a minimum matching cost for a diamond search pattern, and
wherein the eighth predetermined number comprises a maximum value of unsigned int or 375.

16. The method of claim 13, further comprising:
generating the seventh predetermined number of refined IBC merge candidates, and
selecting one of the seventh predetermined number of refined IBC merge candidates, wherein the selecting is based on a RD decision;
wherein information about the selecting is indicated from an encoder of the video to a decoder of the video, and
wherein if the seventh predetermined number is one, the information about the selecting is not indicated,
wherein the method further comprises:
if at least one refined IBC merge candidates by template matching is available, determining the seventh predetermined number of refined IBC merge candidates as candidates for the IBC merge mode based on TM; and
if no refined IBC merge candidates by template matching is available, determining that the IBC merge mode based on TM is invalid.

17. The method of claim 1, wherein the conversion includes encoding the target video block into the bitstream, or
wherein the conversion includes decoding the target video block from the bitstream.

18. An apparatus for processing video data comprising a processor and a non-transitory memory with instructions thereon, wherein the instructions upon execution by the processor, cause the processor to perform acts comprising:
determining, during a conversion between a target video block of a video and a bitstream of the video, an intra block copy (IBC)-based mode to be applied for the target video block, the IBC-based mode being based on at least one of the following:
an IBC merge mode with block vector difference (MBVD),
a combined prediction mode based on an IBC mode and at least one further prediction mode,
an IBC mode based on triangle partitioning,
an IBC mode based on geometric partitioning,
an IBC advanced motion vector prediction (AMVP) mode based on template matching (TM), or
an IBC merge mode based on TM; and
performing the conversion based on the IBC-based mode.

19. A non-transitory computer-readable storage medium storing instructions that cause a processor to perform acts comprising:
determining, during a conversion between a target video block of a video and a bitstream of the video, an intra block copy (IBC)-based mode to be applied for the target video block, the IBC-based mode being based on at least one of the following:
an IBC merge mode with block vector difference (MBVD),
a combined prediction mode based on an IBC mode and at least one further prediction mode,
an IBC mode based on triangle partitioning,
an IBC mode based on geometric partitioning,
an IBC advanced motion vector prediction (AMVP) mode based on template matching (TM), or
an IBC merge mode based on TM; and
performing the conversion based on the IBC-based mode.

20. A non-transitory computer-readable recording medium storing a bitstream of a video which is generated by a method performed by a video processing apparatus, wherein the method comprises:
determining an intra block copy (IBC)-based mode to be applied for the target video block, the IBC-based mode being based on at least one of the following:
an IBC merge mode with block vector difference (MBVD),
a combined prediction mode based on an IBC mode and at least one further prediction mode,
an IBC mode based on triangle partitioning,
an IBC mode based on geometric partitioning,
an IBC advanced motion vector prediction (AMVP) mode based on template matching (TM), or
an IBC merge mode based on TM; and
generating the bitstream based on the IBC-based mode.
